(19) United States
(12) Patent Application Publication
(10) Pub. No.: US 2013/0232407 A1
(43) Pub. Date: Sep. 5, 2013

(54) SYSTEMS AND METHODS FOR PRODUCING, REPRODUCING, AND MAINTAINING ELECTRONIC BOOKS

(71) Applicants: Kensuke Onuma, Tokyo (JP); Koji Fukui, Chiba (JP); Yuta Yamaguchi, Tokyo (JP); Toshiyuki Katsumoto, Tokyo (JP)

(72) Inventors: Kensuke Onuma, Tokyo (JP); Koji Fukui, Chiba (JP); Yuta Yamaguchi, Tokyo (JP); Toshiyuki Katsumoto, Tokyo (JP)

(73) Assignee: SONY CORPORATION, Tokyo (JP)

(21) Appl. No.: 13/988,234

(22) PCT Filed: Nov. 17, 2011
(86) PCT No.: PCT/JP2011/077108

§ 371 Date: May 17, 2013

(30) Foreign Application Priority Data
Nov. 25, 2010 (JP) 2010-262584

(51) Int. Cl. G06F 17/21

(52) U.S. Cl. CPC G06F 17/217
USPC 715/251

(57) ABSTRACT

Systems and methods for producing, reproducing, and maintaining electronic books are provided. In one aspect, a system (20) may include a book producing device (21) configured to create at least one page image (47) for an electronic book including reproducible content, where the page image (47) includes a selectable portion having a part of the reproducible content of the electronic book. In addition, the system (20) may also include an electronic book reproducing device (24). The electronic book reproducing device (24) may be configured to determine a target area (92) based on a selection by a user of the selectable portion of the page image (47), and, selectively reproduce, within the target area (92) and in a predetermined manner, the reproducible content and/or other data associated with the selectable portion of the page image. In addition, the system may also include a history information device (22) configured to receive and maintain information regarding the selection of the selectable portion of the book image (47) selected by a user.

### TECHNICAL FIELD

The present invention relates to an electronic book reproducing apparatus, a history obtaining apparatus, an electronic book producing apparatus, an electronic book providing system, an electronic book reproducing method, history obtaining method, an electronic book producing method, an electronic book reproducing program, a history obtaining program, and an electronic book producing program, which is preferably applied to an electronic book providing system providing an electronic book via a disc-shaped recording medium or a network, for example.

### BACKGROUND ART

According to a conventional electronic book reading system, determination is made regarding whether or not pages and a plurality of constituents within the pages have been read by a user based on display time of individual pages of an electronic book when the electronic book is displayed in response to a user operation.

In addition, the electronic book reading system stores an operation history for display showing the pages and the constituents of the electronic book displayed in response to the user operation associated with the determination result regarding whether or not the pages and the constituents have been read.

Moreover, the electronic book reading system selects and displays the pages and the constituents which have already been read and the pages and the constituents which have not yet been read based on the operation history when the electronic book is displayed again (see PTL 1, for example).

### CITATION LIST

### Patent Literature

PTL 1: Japanese Unexamined Patent Application Publication No. 2001-109769 (pages 4 to 6, FIGS. 2, 3, and 5)

### SUMMARY OF INVENTION

The electronic book reading system with such a configuration can determine the pages and the constituents, which have been read by a user, in the electronic book based on an operation history by storing the operation history including the determination result showing whether or not the pages and the constituents have been read by the user.

In addition, it is considered to be possible to specify contents of the read pages and the constituents and use the contents to manufacture an electronic book advertisement and a new electronic book and to extract user preference and the like by determining the pages and the constituents, which have been read by the user, in the electronic book, according to the electronic book reading system.

In other words, it is considered to be possible to effectively use an operation history to manufacture an electronic book advertisement and a new electronic book and to extract user preference and the like by storing the operation history from which it is possible to determine the pages and the constituents, which have been read by the user, in the electronic book, according to the electronic book reading system.

In addition, it is considered to be possible to more effectively use the operation history to manufacture an electronic book advertisement and a new electronic book and to extract user preference and the like if parts in pages, which have been actually read by the user, in the electronic book can be specifically determined based on the operation history, according to the electronic book reading system.

However, if the display time of a page of the electronic book is within a predetermined time range, the determination is simply made that the entire page and all constituents included in the page have been read regardless of which parts in the page have actually been read. Moreover, the electronic book reading system stores the operation history including the determination result.

Therefore, there is a problem in the conventional electronic book reading system in that it is not possible to specifically determine parts, which have been actually read by a user, in a page in the electronic book based on the operation history and it is not possible to effectively use the operation history.

The present invention was made in view of the above circumstances and provides an electronic book reproducing apparatus, a history obtaining apparatus, an electronic book producing apparatus, an electronic book providing system, an electronic book reproducing method, a history obtaining method, an electronic book producing method, an electronic book reproducing program, a history obtaining program, and an electronic book producing program, in which it is possible to more effectively use the display history of the displayed electronic book.

Thus, a device for reproducing an electronic book is provided. The device may include a control unit configured to determine a target area based on a selection of at least one selectable displayed portion of a page image of the electronic book, and, selectively reproduce, within the target area, content associated with the selected displayed portion of the page image of the electronic book in a predetermined manner. The control unit may be further configured to associate area position information with the selectable displayed portion of the page image of the electronic book, where the area position information may be used by the control unit to determine the content reproduced within the target area.

In a further aspect, the control unit may be further configured to display the target area such that the displayed target area overlaps a portion of the page image of the electronic book. Further, the control unit may also be configured to display a surrounding frame image including the displayed target area, where the surrounding frame image may be displayed such that the surrounding frame image overlaps the selectable displayed portion of the page image of the electronic book.

In various aspects, the determined target area may be larger than the selectable displayed portion of the page image of the electronic book. Further, the content associated with the selectable displayed portion of the page image of the electronic book may include text content, image content, movie content, and/or audio content. Yet further, the text content associated with the selectable displayed portion of the page image of the electronic book may be displayed within the target area in an enlarged format.

In another aspect, the control unit may be further configured to provide an indication that a portion of the page image of the electronic book is not selectable by a user. In yet another aspect, the control unit may also be further configured to provide the indication that the portion of the page image of the electronic book is not selectable by displaying a synthesized message overlapping a displayed portion of the page image of the electronic book.

In still another aspect, the control unit may be further configured to receive an indication to change the selection of the at least one selectable displayed portion of the page image of the electronic book to another displayed portion of the page image of the electronic book, determine that the another displayed portion of the page image of the electronic book is not selectable, and, provide an indication of such determination by displaying a synthesized message overlapping a displayed portion of the page image of the electronic book to a user.

In yet another aspect, the control unit may be further configured to receive an indication to change the selection of the at least one selectable displayed portion of the page image of the electronic book to another selectable displayed portion of the page image of the electronic book; determine another target area based on the selection of the another selectable displayed portion of the page image of the electronic book, and, selectively reproduce, within the another target area, content associated with the another selectable displayed portion of the page image of the electronic hook in a predetermined manner.

In another aspect, the page image of the electronic book may include a plurality of selectable displayed portions, and, the control unit may be further configured to selectively reproduce, within a respective target area determined for each selected displayed portion, content associated with the respective selected displayed portion of the page image of the electronic book in a predetermined manner. In yet aspect, the plurality of selectable displayed portions may be sequentially selectable.

In one aspect, the control unit may be further configured to provide history information regarding (i) the selection of each of the at least one selectable displayed portion of the page image of the electronic book by a user and (ii) the selective reproduction, within the determined target area, of the content associated with the selected displayed portion of the page image of the electronic book to the user.

A device for producing an electronic book is provided. The device may include a control unit configured to create at least one page image for the electronic book including reproducible content, create at least one selectable portion within the page image and associate a part of the reproducible content of the electronic book with the at least one selectable portion, and, associate data with one or more selectable portions of the page image, where the data associated with the one or more selectable portions may be reproduced upon selection of a respective selectable portion of the page image.

In one aspect, the data associated with at least one selectable portion of the page image may include audio data, were the audio data may be reproduced upon selection of said selectable portion of the page image of the electronic book. In another aspect, the data associated with the at least one selectable portion of the page image may include image data. In yet another aspect, the data associated with at least one selectable portion of the page image may include a combination of audio and image data. In still another aspect, the audio data may include a narration of the reproducible content of the electronic book. In still another aspect, the reproducible content of the electronic book may include textual or image content.

In one aspect, the control unit may be further configured to differentiate a display state of the part of the reproducible content of the electronic book associated with the at least one selectable portion from other parts of the reproducible content of the electronic book. In another aspect, the control unit may be configured to associate another part of the reproducible content of the electronic book with a non-selectable portion of the page image of the electronic book. In still another aspect, the control unit may be configured to differentiate a display state of the at least one page image from other page images of the electronic book.

In one aspect, the control unit may further configured to emphasize the part of the reproducible content of the electronic book associated with the at least one selectable portion from other parts of the reproducible content of the electronic book. In another aspect, the control unit may be configured to emphasize the part of the reproducible content of the electronic book associated with the at least one selectable portion by enlarging a textual content included in the part of the reproducible content of the electronic book associated with the at least one selectable portion.

A device for maintaining information regarding an electronic book including at least one page image having at least one selectable portion including a part of reproducible content of the electronic book is provided. The device may include a control unit configured to receive information regarding a selection, by a user, of each of the at least one selectable portion of each respective page image displayed to the user. In one aspect, the control unit may be configured to determine, based on the information regarding a selected respective portion of the respective page image displayed to the user, the part of the reproducible content of the electronic book included within the selected respective portion. The control unit may then analyze the part of reproducible content of the electronic book included within the selected respective portion and one or more attributes associated with the reproducible content of the electronic book to extract a user preference from the selected respective portion of the page image displayed to the user. In yet another aspect, the control unit may be configured to extract the user preference using natural language processing on the part of the reproducible content of the electronic book included within the selected respective portion.

An electronic book system is provided. The system may include an electronic book producing device. The electronic book producing device may be configured to create at least one page image for an electronic book including reproducible content; create at least one selectable portion within the page image and associate a part of the reproducible content of the electronic book with each respective selectable portion; and, associate data with each respective selectable portion of the page image, the data associated with each respective selectable portion being reproducible upon selection of the respective selectable portion of the page image.

In addition, the system may also include an electronic book reproducing device. The electronic book reproducing device may be configured to determine a target area based on a selection by a user of the at least one selectable portion of the page image displayed to the user, and, selectively reproduce, within the target area and in a predetermined manner, the reproducible content and/or the data associated with the at least one selectable portion selected by the user.

In addition to the foregoing, the system may also include a history information device. The history information device may be configured to receive information regarding the selection, by the user, of the at least one selectable portion selected by the user.

A method for reproducing an electronic book is provided. The method may include determining, using a processor, a target area based on a selection of at least one selectable displayed portion of a page image of the electronic book, and, selectively reproducing, within the target area, content associated with the selected displayed portion of the page image of the electronic book in a predetermined manner.

A non-transitory computer-readable medium on which computer executable instructions of a program for reproducing an electronic book are stored is provided. The instructions, when executed by a control unit, may cause the control unit to determine a target area based on a selection of at least one selectable displayed portion of a page image of the electronic book, and, selectively reproduce, within the target area, content associated with the selected displayed portion of the page image of the electronic book in a predetermined manner.

A method for producing an electronic book is provided. The method may include creating, using a processor, at least one page image for the electronic book including reproducible content; creating at least one selectable portion within the page image and associating a part of the reproducible content of the electronic book with the at least one selectable portion; and, associating data with one or more selectable portions of the page image, where the data associated with the one or more selectable portions may be reproducible upon selection of a respective selectable portion of the page image.

A non-transitory computer-readable medium on which computer executable instructions of a program for producing an electronic book are stored is provided. The instructions, when executed by a control unit, may cause the control unit to create at least one page image for the electronic book including reproducible content; create at least one selectable portion within the page image and associate a part of the reproducible content of the electronic book with the at least one selectable portion; and, associate data with one or more selectable portions of the page image, the data associated with the one or more selectable portions being reproducible upon selection of a respective selectable portion of the page image.

A method for maintaining information regarding an electronic book including at least one page image having at least one selectable portion including a part of reproducible content of the electronic book is provided, where the method may include receiving, using a processor, information regarding a selection, by a user, of each of the at least one selectable portion of each respective page image displayed to the user.

A non-transitory computer-readable medium on which computer executable instructions of a program for maintaining information regarding an electronic book including at least one page image having at least one selectable portion including a part of reproducible content of the electronic book are stored is provided. The instructions, when executed by a control unit, may configure the control unit to receive information regarding a selection, by a user, of each of the at least one selectable portion of each respective page image displayed to the user.

### BRIEF DESCRIPTION OF DRAWINGS

FIG. 1 is a block diagram showing an outline of a configuration of an electronic book providing system according to an embodiment.

FIG. 2 is an outlined line drawing showing a specific configuration of an electronic hook providing system according to an embodiment.

FIG. 3 is a block diagram showing a circuit configuration of an electronic book producing apparatus.

FIG. 4 is an outlined line drawing showing a configuration of an electronic book producing screen.

FIG. 5 is an outlined line drawing showing a configuration of book information.

FIG. 6 is an outlined line drawing showing a configuration of an electronic book producing screen when an electronic hook page image is selected.

FIG. 7 is an outlined line drawing showing a configuration of page information.

FIG. 8 is an outlined line drawing showing a configuration of an electronic book producing screen when an enlargement target area is chosen in a book page image.

FIG. 9 is an outlined line drawing showing a configuration of area information.

FIG. 10 is an outlined line drawing for illustrating production of electronic book data.

FIG. 11 is an outlined line drawing for illustrating production of electronic book data.

FIG. 12 is an outlined line drawing showing a configuration of book information.

FIG. 13 is an outlined line drawing showing a configuration of a book providing disc.

FIG. 14 is a block diagram showing a circuit configuration of an electronic book reproducing apparatus.

FIG. 15 is an outlined line drawing for illustrating display of book page image on a display apparatus.

FIG. 16 is an outlined line drawing for illustrating display of a thumbnail image for selecting another book page image on a hook page image.

FIG. 17 is an outlined line drawing for illustrating choosing of an enlargement target area on a book page image.

FIG. 18 is an outlined line drawing for illustrating enlargement and display of an enlargement target area.

FIG. 19 is an outlined line drawing showing a configuration of a display history.

FIG. 20 is an outlined line drawing showing a configuration of a program module mounted on an electronic book reproducing apparatus.

FIG. 21 is a block diagram showing a circuit configuration of a history obtaining apparatus.

FIG. 22 is a flowchart showing a procedure of image data producing processing for an electronic book.

FIG. 23 is a flowchart showing a procedure of electronic book data producing processing.

FIG. 24 is a flowchart showing a procedure of electronic book data producing processing.

FIG. 25 is a flowchart showing a procedure of electronic book registration processing.

FIG. 26 is a flowchart showing a procedure of electronic book reproducing processing.

FIG. 27 is a flowchart showing procedures of display history providing and obtaining processing where (A) shows a procedure of history providing processing by an electronic book reproducing apparatus and (B) shows a procedure of history obtaining processing by a history obtaining apparatus.

### DESCRIPTION OF EMBODIMENTS

Hereinafter, description will be made of best embodiments (hereinafter, also referred to as embodiments) for implementing the present invention with reference to the drawings. In addition, the description will be made in the following order.

### 1. Embodiments

### 2. Modified Examples

### 1. EMBODIMENTS

### 1-1. Outline of Embodiments

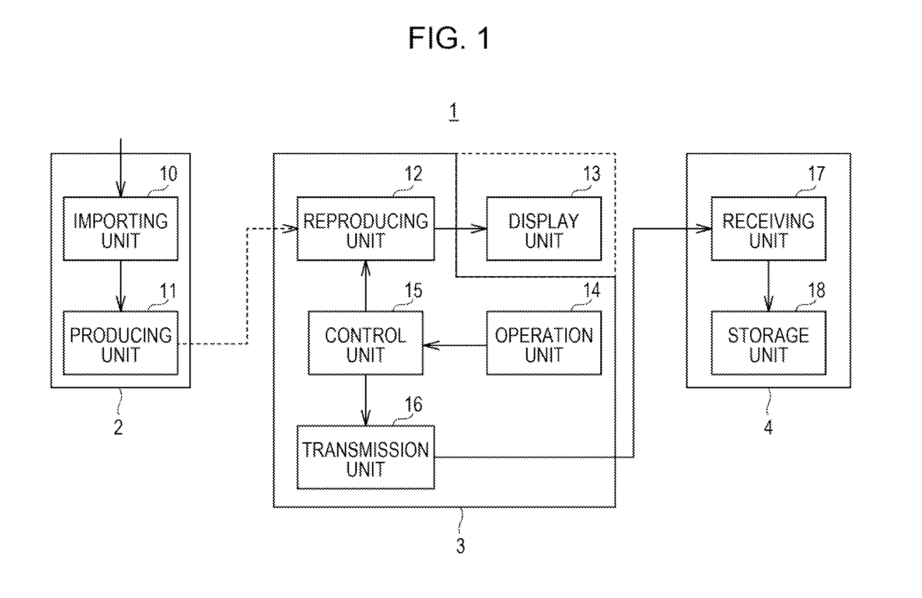

First, description will be made of an outline of embodiments. In addition, specific examples of embodiments will be described after the description of the outline. In FIG. 1, 1 shows an outline of a configuration of an electronic book providing system according to this embodiment as a whole. The electronic book providing system 1 is constituted by an electronic book producing apparatus 2, an electronic book reproducing apparatus 3, and a history obtaining apparatus 4.

In the electronic book producing apparatus 2, an importing unit 10 imports image data including images in one or a plurality of pages. In addition, in the electronic book producing apparatus 2, a producing unit 11 produces electronic book data for an electronic book, which includes one or a plurality of partially-selectable book page images including reproducible content of the electronic book, in which one or a plurality of parts or portions chosen in the book page images are individually set as selectable enlargement target areas which can be enlarged and displayed, based on the original document data imported by the importing unit 10.

On the other hand, in the electronic book reproducing apparatus 3, a reproducing unit 12 performs reproducing processing on the electronic book data produced by the electronic book producing apparatus 2 and displays book page images on a display unit 13. In addition, in the electronic book reproducing apparatus 3, an operation unit 14 is used for arbitrarily designating an enlargement target area in book page images displayed on the display unit 13.

Moreover, in the electronic book reproducing apparatus 3, a controller or control unit 15 controls the reproducing unit so as to enlarge and display the designated enlargement target area on the display unit 13 when the enlargement target area is designated in the document page image via the operation unit 14. Furthermore, in the electronic book reproducing apparatus 3, a transmission unit 16 transmits a display history of an electronic book whose enlargement target areas enlarged and displayed on the display unit 13 are shown.

In addition, although the display unit 13 may be provided in the electronic book reproducing apparatus 3, it is not necessary that the display unit 13 is provided in the electronic book reproducing apparatus 3, and the display unit 13 may be externally attached to the electronic book reproducing apparatus 3.

In addition to this, in the history obtaining apparatus 4, the receiving unit 17 receives the display history transmitted from the electronic book reproducing apparatus 3. Moreover, in the history obtaining apparatus 4, the storage unit 18 stores the display history received by the receiving unit 17.

With such a configuration, the electronic book providing system 1 can specifically determine which parts in the book page images of an electronic book have been actually read by the user based on the display history, by the history obtaining apparatus 4. Accordingly, it is possible to more effectively use the display history of the displayed electronic book according to the electronic book providing system 1.

### 1-2. Specific Configuration of Electronic Book Providing System According to Embodiment

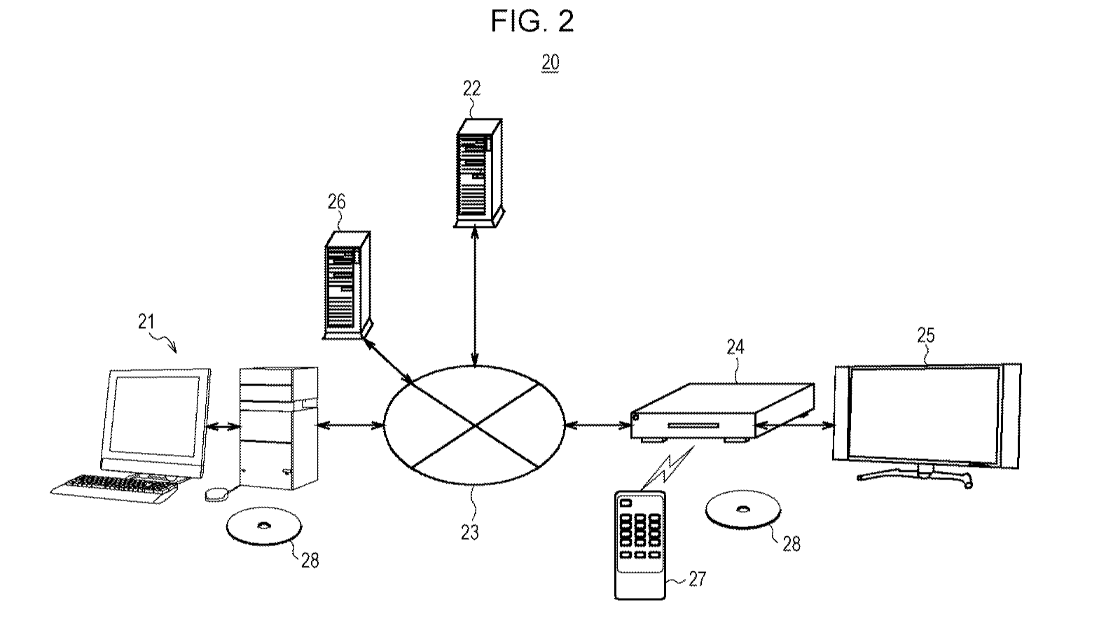

Next, description will be made of a configuration of an electronic book providing system 20 as a specific example of the electronic book providing system 1 shown in the aforementioned outline with the use of FIG. 2. In the electronic book providing system 20, an electronic book producing apparatus 21 as a specific example of the electronic book producing apparatus 2 shown in the aforementioned outline and a history obtaining apparatus 22 as a specific example of the history obtaining apparatus 4 shown in the aforementioned outline are connected to the network 23.

In addition, in the electronic book providing system 20, an electronic book reproducing apparatus 24, which is owned by a user, for example, as a specific example of the electronic book reproducing apparatus 3 shown in the aforementioned outline is also connected to the network 23. Moreover, a display apparatus 25 such as a television receiver, for example, which is owned by a user, as a specific example of the display unit 13 shown in the aforementioned outline is connected to the electronic book reproducing apparatus 24. Furthermore, in the electronic book providing system 20, a settlement server 26 which performs settlement processing when an electronic book is purchased by a user is also connected to the network 23.

The electronic book producing apparatus 21 produces electronic book data for an electronic book which is obtained by computerizing (digitizing) a publication based on original document data of an original document of the publication such as a novel, a magazine, a picture book, a reference book, a catalog, a brochure, or the like.

In addition, the electronic book producing apparatus 21 transmits the electronic book data to the history obtaining apparatus 22 via the network 23, causes the history obtaining apparatus 22 to store and manage the electronic book data, and causes the history obtaining apparatus 22 to provide the electronic book data via the network 23. That is, the history obtaining apparatus 22 manages a book selling site on the network 23 which can provide the electronic book data along with the electronic book reproducing program which is for reproducing the electronic book data.

In addition, the electronic data reproducing apparatus 24 is configured to be capable of accessing the book selling site on the network 23 for purchasing the electronic book data in response to an operation of a remote controller (hereinafter, also referred to as remote control) 27, for example.

If the electronic book reproducing apparatus 24 accesses the hook selling site and requests the purchase of desired electronic book data, the history obtaining apparatus 22 transmits the electronic book data along with the electronic book reproducing program to the electronic book reproducing apparatus 24 via the network 23. In so doing, the electronic book reproducing apparatus 24 receives the electronic book data and the electronic book reproducing program transmitted from the history obtaining apparatus 22 and stores the electronic book data and the electronic book reproducing program in an internal hard disk, for example.

In so doing, the electronic book providing system 20 allows a user to obtain the electronic hook data along with the electronic book reproducing program via the network 23. In addition, if the user uses the book selling site and obtains the electronic book data, the settlement server 26 electronically performs settlement processing for the purchasing charge of the electronic book data and allows the user to pay the purchasing charge with the electronic book providing system 20.

In addition, if the remote control 27 is operated, for example, in the state in which the electronic book data and the electronic book reproducing program are stored in the hard disk, the electronic book reproducing apparatus 24 reads the electronic book reproducing program from the hard disk in response to this.

At this time, the electronic book reproducing apparatus 24 reads the electronic book data from the hard disk based on the electronic book reproducing program and performs reproducing processing in so doing, the electronic book reproducing apparatus 24 appropriately switches and displays individual book page images of the electronic book on the display apparatus 25 based on the electronic book data. In so doing, the electronic book providing system 20 can provide an electronic book to a user with the use of the network 23 and allows the user to freely read the electronic book.

In addition, the electronic book producing apparatus 21 produces a disc-shaped recording medium (hereinafter, also referred to as a book providing disc) 27 such as a BD (Blu-ray Disc) or a DVD (Digital Versatile Disc) for providing an electronic book with the use of the electronic book data.

Actually, the electronic book producing apparatus 21 records one or a plurality of electronic book data items and the electronic book reproducing program for reproducing the electronic book data items on the disc-shaped recording medium, on which data has not been recorded, to produce the book providing disc 28.

In addition, the electronic book producing apparatus 21 records book specifying information, which is obtained from the history obtaining apparatus 22, with which one or a plurality of electronic book data items can be specified, and the electronic book reproducing program on the disc-shaped recording medium, on which data has not been recorded, to produce the book providing disc 28.

That is, the electronic book producing apparatus 21 can produce the book providing disc 28 which can provide an electronic book without particularly recording the electronic book data itself on the disc-shaped recording medium, on which data has not been recorded.

The electronic book providing system 20 sells the book providing disc 28 produced by the electronic book producing apparatus 21 as described above to a user through a real disc selling shop or a virtual disc selling site on the network 23, which is managed by the history obtaining apparatus 22, for example.

In addition, when the electronic book providing disc 28 is purchased by a user using a disk selling shop, the electronic book providing system 20 allows the user to directly pay the purchasing charge of the book providing disc 28 at the disk selling shop.

In addition, the electronic book reproducing apparatus 24 is configured to be capable of accessing a disk selling site on the network 23 to purchase the book providing disc 28 in response to the operation of the remote control 27, for example.

Moreover, even when the book providing disc 28 is purchased by a user using a disc selling site, the settlement server 26 electronically performs settlement processing for the purchasing charge of the book providing disc 28 and allows the user to pay the purchasing charge, with the electronic book providing system 20.

If the book providing disc 28 is purchased by the user as described above, the electronic book providing system 20 provides one or a plurality of electronic book data items to the user with the use of the purchased book providing disc 28.

That is, if the remote control 27 is operated, for example, in the state in which the book providing disc 28 with the electronic book data recorded thereon is loaded, the electronic book reproducing apparatus 24 reads the electronic book reproducing program from the book providing disc 28 in response to this.

In addition, the electronic book reproducing apparatus 24 reads the electronic book data from the book providing disc 28 based on the electronic book reproducing program and performs reproducing processing. In so doing, the electronic book reproducing apparatus 24 appropriately switches and displays images (hereinafter, also referred to as book page images) of individual pages of the electronic book on the display apparatus 25 based on the electronic book data.

Moreover, if the remote control 27 is operated, for example, in the state in which the book providing disc 28 without electronic book data recorded thereon is loaded, the electronic book reproducing apparatus 24 reads the electronic book reproducing program from the book providing disc 28 in response to this.

At this time, the electronic book reproducing apparatus 24 reads the book specifying information from the book providing disc 28 based on the electronic book reproducing program, obtains electronic book data, which is specified by the book specifying information, from the history obtaining apparatus 22 via the network 23, and performs reproducing processing. In so doing, the electronic book reproducing apparatus 24 appropriately switches individual book page images of the electronic book on the display apparatus 25 based on the electronic book data.

As described above, the electronic book providing system 20 can provide an electronic book to a user even with the use of the book providing disc 28 and thus allow the user to freely read the electronic book provided with the use of the book providing disc 28. Then, when the display of the electronic book is completed, the electronic book reproducing apparatus 24 transmits the display history of the electronic book displayed in response to the user operation to the history obtaining apparatus 22 via the network 23.

In addition, if the display history is transmitted from the electronic book reproducing apparatus 24 via the network 23, the history obtaining apparatus 22 receives and stores the display history. Accordingly, the history obtaining apparatus 22 can use the stored display history to manufacture an electronic book advertisement read by the user or a new electronic book. In addition, the history obtaining apparatus 22 can also use the display history to extract user preference and the like.

### 1-3. Circuit Configuration of Electronic Book Producing Apparatus 21

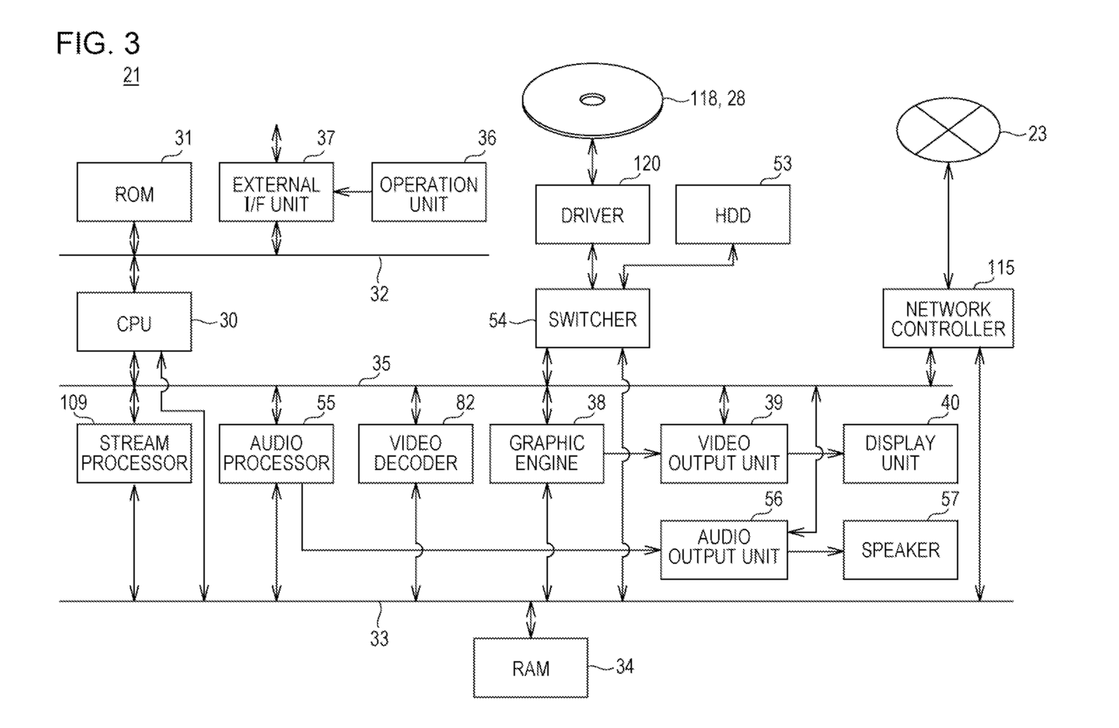

Next, description will be made of a circuit configuration of the electronic book producing apparatus 21 with the use of FIG. 3. The electronic book producing apparatus 21 includes a controller or control unit 30 constituted by a CPU (Central Processing Unit), for example. The control unit 30 reads various programs including a basic program stored in advance in a non-transitory computer-readable medium such as a ROM (Read Only Memory) 31, an electronic book producing program such as desktop publishing software, and the like, for example, via the input output bus 32.

The control unit 30 transfers various programs to the RAM (Random Access Memory) 34 as a work area of the control unit 30 via the memory bus 33 and executes the various programs. In addition, the control unit 30 controls the whole apparatus via the input output bus 32 and the system bus 35 based on the various programs executed on the RAM 34. Moreover, the control unit 30 executes predetermined computation processing based on the various programs.

Furthermore, the control unit 30 also executes various kinds of processing in response to the operation commands given from the operation unit 36 via the external interface unit 37 and the input output bus 32 in this order in response to the operation of the operation unit 36 constituted by a keyboard, a mouse, or the like based on the various programs.

In so doing, the control unit 30 imports the original document data of the original document of the publication such as a novel, a magazine, a picture book, a reference book, a catalog, a brochure, or the like as an original of the electronic book from the outside via the external interface unit 37 and the input output bus 32 in this order.

Here, the publication as the original of the electronic book is constituted by a front cover and a back cover, or a front cover and a spine and a back cover, and one or a plurality of pages. In addition, the front cover and the back cover, or the front cover and the spine and the back cover are also simply referred to as a cover as a whale in the following description.

The cover of a publication is constituted by arranging at least one of text describing the title of the publication, the author, the publisher, or the like, a picture image for the cover, an illustration image, and the like. In addition, the picture image for the cover, the illustration image, and the like are also referred to as a cover image as a whole in the following description.

In addition, the individual pages of the publication are constituted by arranging at least one of the text of at least one line, a picture image or an illustration image for artwork, a picture image or an illustration image for an advertisement, and the like. In addition, the picture image or the illustration image for artwork and the picture image or the illustration image for an advertisement are also referred to as an in-page image as a whole in the following description.

In addition, the control unit 30 imports the original data from the outside when the original document data of the original document of the publication is produced so as to be printed on a paper medium for manufacturing a publication, for example.

The original document data for printing the original document on a paper medium is constituted by connecting image data in which text, in-page images, and the like for each page with a page number added thereto are arranged to cover image data in which text, a cover image, and the like are arranged in the order of the page number, for example. In addition, the original document data is produced in a predetermined first format such as a desktop publishing format, a PDF (Portable Document Format), or the like.

In addition, when the publication was produced in the past and there was no original document data of the publication for printing the original document on the paper medium, the control unit 30 imported the original data produced by sequentially scanning the cover and the facing pages from the outside.

The original document data produced by scanning the publication is constituted such that the image data for each facing page in which text, in-page images, and the like are arranged, are arranged after the image data of the cover in which text, a cover image, and the like are arranged, in the order of being filed in the publication.

In addition, the original document data is produced in a predetermined second format such as TIFF (Togged Image File Format), JPEG (Joint Photographic Experts Group), or the like.

When the original document is imported, the control unit 30 determines a type of the original document data (that is, which format is the original document data based on among the first format and the second format) based on the format.

Then, when the original document data in the first format is imported, the control unit 30 cuts the decoded original document data into the image data for the cover of the publication and the image data for each facing page of the publication after decoding the original document data.

In addition, the control unit 30 detects the total page number of the publication, which is to be produced based on the original data, based on the page number added in advance in the image data for each facing page cut from the original data at this time.

On the other hand, when the original document data in the second format is imported, the control unit 30 adds page numbers to image data for one or a plurality of facing pages included in the original document data in turn. In addition, the control unit 30 detects the total page number of the publication as an original of the original document data based on the page numbers added to the image data for one or a plurality of facing pages included in the original document data at this time.

In so doing, the control unit 30 obtains the image data for the cover and one or a plurality of facing pages (that is, the image data in the first or second format) from the original document data in the first format or the second format.

Then, the control unit 30 respectively performs size conversion processing such as enlargement processing by interpolating of pixels or the like or downsize processing by thinning out or the like on the image data for the cover and the image data for one or a plurality of facing pages.

In so doing, the control unit 30 produces image data for an electronic book (that is, image data in the first or second format) with an image size of HDTV (High Definition Television) standard, for example, from the image data for the cover of the publication.

In addition, the control unit 30 produces image data for the electronic book (that is, image data in the first or second format) with an image size of HDTV standard even from the image data for each facing page of the publication.

In addition, the image data for the cover with an image size of HDTV standard (that is, each image size is matched to the image size of HDTV standard) for the electronic book will also be referred to as book cover image data in the following description.

In addition, the image data for each facing page with an image size of HDTV standard (that is, each image size is matched to the image size of HDTV standard) for the electronic book will also be referred to as book page image data in the following description.

The control unit 30 produces the book cover image data and the control page image data for the electronic book as described above and sends the produced book cover image data and the book page image data to a graphic engine 38.

When the book cover image data and the book page image data are given from the control unit 30, the graphic engine 38 produces the electronic book producing screen data for producing the electronic book based on the hook cover image data and the book page image data,

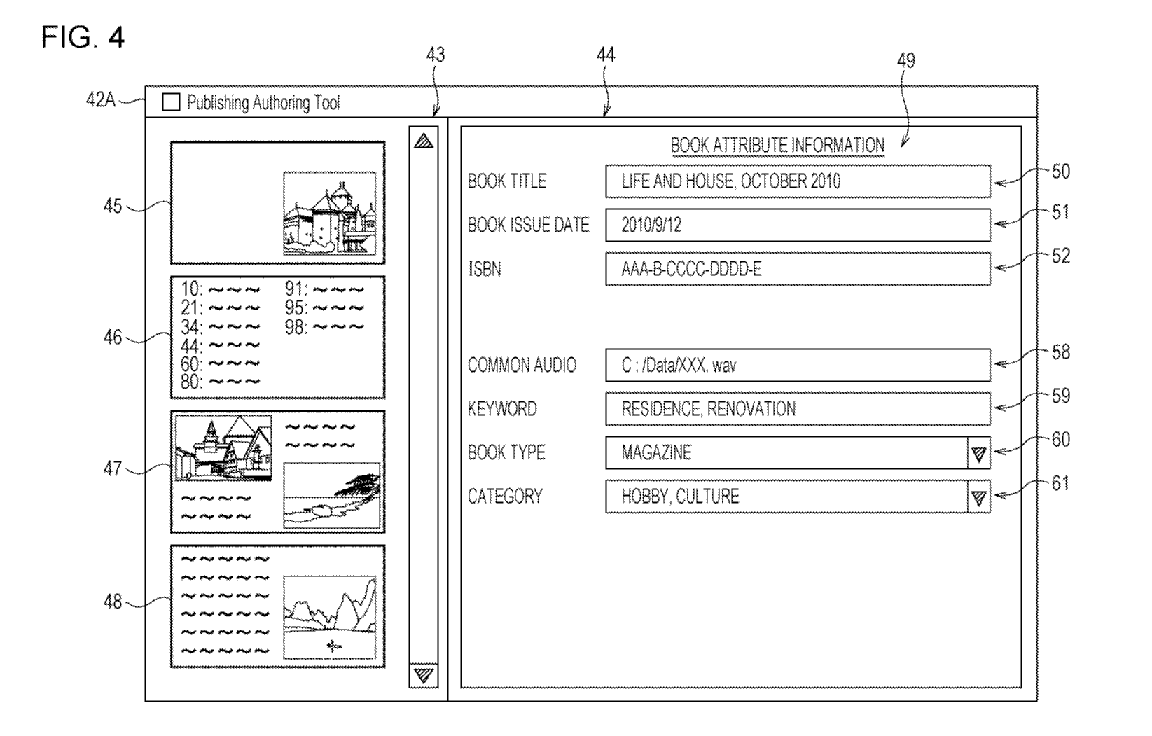

Then, the graphic engine 38 sends the electronic book producing screen data to the display unit 40 constituted by a liquid crystal display, an organic EL (Electro Luminescence) display, or the like via a video output unit 39. In so doing, the control unit 30 displays an electronic book producing screen 42A as shown in FIG. 4 on the display unit 40 via the graphic engine 38 based on the electronic book producing screen data.

In such a case, an image list display unit 43 is provided on the left side in the horizontal direction while an information input unit 44 which is for inputting various kinds of information relating to the electronic book is provided on the right side in the horizontal direction, for example, on the electronic book producing screen 42A.

A book cover image (not shown) based on the book cover image data and one or a plurality of book page images 45 to 48 based on one or a plurality of book page image data items are arranged and displayed in a line in the vertical direction of the screen, for example, in the image list display unit 43 on the electronic book producing screen 42A.

In addition, in the information input unit 44 on the electronic book producing screen 42A, a book attribute input image 49 which is for inputting attribute information of an electronic book to be produced at this time (hereinafter, also referred to as book attribute information) is displayed as an initial state, for example.

In the book attribute input image 49, a title input section 50 which is for inputting the title of the electronic book (the title of the original publication, for example) and an issue date input section 51 which is for inputting the issued data of the electronic book (the issue date of the original publication, for example, as the book attribute information are provided. In addition, the title of the electronic book will also be referred to as the book title, and the issue date of the electronic book will also be referred to as the book issued data in the following description.

In addition, a book number input section 52 which is for inputting an international standard book number called an ISBN (International Standard Book Number), given to the publication as the original of the electronic book as the book attribute information is also provided in the book attribute input image 49.

A non-transitory computer-readable medium such as a hard disk drive 53 is provided in the electronic book producing apparatus 21. In addition, the control unit 30 stores on the hard disk driver 53 audio data of various kinds of audio such as music, narration, reading of texts in the electronic book, or the like for being associated with all or portions of the electronic book and being reproduced and allowing a user to listen while the electronic book is purchased and displayed by the user.

That is, the control unit 30 prepares in advance various kinds of audio data to be reproduced while the book cover image and the book page images are displayed by the user. Moreover, the control unit 30 reads the audio data from the hard disk driver 53 is the switcher 54 and sends the audio data to an audio processor 55 in response to the operation of the operation unit 36 by an operator.

The audio processor 55 sends the audio data to a speaker 57 is an audio output unit 56 after decoding the audio data and causes the speaker 57 to output the audio based on the audio data. As described above, the control unit 30 can reproduce the audio data stored in the hard disk driver 53 for reproducing the electronic book and allow the operator to listen to the audio such as music, narration, and the like.

Moreover, the control unit 30 is configured to be capable of allowing the operator to arbitrarily choose the audio data to be reproduced during the display of the electronic book by the user from among the various kinds of audio data prepared in advance with the use of the hard disk drive 53.

Therefore, an audio specifying information input section 58 which is for inputting audio specifying information capable of specifying audio data chosen from the hard disk driver 53 is also provided for the reproduction during the display of the electronic book by the user, as the book attribute information in the book attribute input image 49.

That is, the audio specifying information input section 58 which is for setting audio data to be commonly reproduced during the display of the book cover image and each of the book page images 45 to 48 as the electronic book by the user is provided in the book attribute input image 49.

In addition, the audio data set to be commonly reproduced while the book cover image and each of the book page images 45 to 48 of the electronic book are displayed will be particularly referred to as common audio data in the following description.

In addition, a key word input section 59 which is for inputting a keyword (that is, a keyword representing a feature of the electronic book) arbitrarily chosen in accordance with the content of the electronic book as the book attribute information is also provided in the book attribute input image 49.

Moreover, a type input section 60 which is for arbitrarily choosing and inputting a type of an electronic book (hereinafter, this is also referred to as a book type) as the book attribute information from among a plurality of candidates prepared in advance as a pull-down menu or the like, for example is also provided in the book attribute input image 49.

Furthermore, a category input section 61 which is for arbitrarily choosing and inputting a category to which the electronic book belongs as the book attribute information from among a plurality of candidates prepared in advance as a pull-down menu or the like is also provided in the book attribute input image 49.

Accordingly, when the book attribute input image 49 is displayed in the information input unit 44 on the electronic book producing screen 42A, the control unit 30 allows the operator to input the book attribute information on the book attribute input image 49 via the operation unit 36.

That is, the control unit 30 allows the operator to input a book title, a book issue date, an ISBN, a keyword, a book type, and a category on the book attribute input image 49 at this time. In addition, the control unit 30 also allows the user to input the audio specifying information for common audio data to be reproduced as BGM (Back Ground Music), for example, while the electronic book is displayed by the user, on the book attribute input image 49.

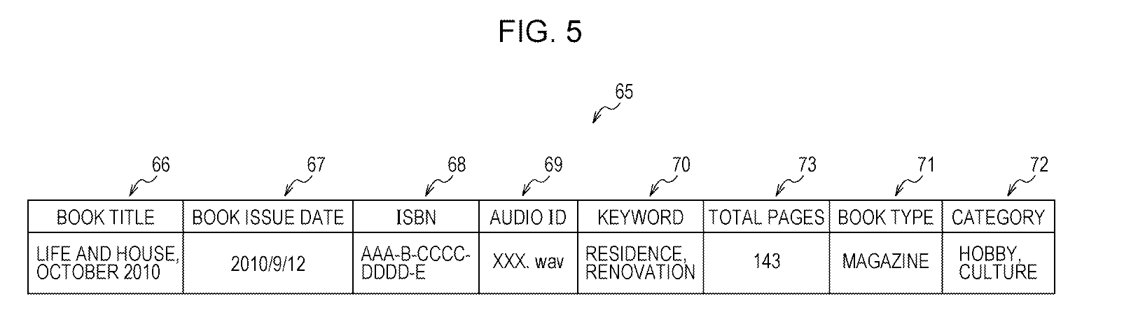

In addition, if the input of the book attribute information is finalized by the operator via the operation unit 36, the control unit 30 organizes the book attribute information in the book attribute input image 49 along with the total page number as the book attribute information of the electronic book. In so doing, the control unit 30 produces the book information 65 constituted by various book attribute information items of the electronic book as shown in FIG. 5.

That is, the control unit 30 produces the book information 65 storing the book title 66, the book issue date 67, the international standard book number 68, the audio specifying information 69, the keyword 70, the book type 71, and the category 72 along with the total page number 73, which are input by the operator.

The control unit 30 sets the keyword 70, the category 72, and the like of the electronic book by the book information 65 by producing the book information 65 of the electronic book as described above. In addition, the control unit 30 sets the common audio data to be reproduced while the electronic book is displayed by the user to the audio data to be specified by the audio specifying information 69 in the book information 65 by the book information 65.

As publications as originals of the electronic books, however, there are publications such as a brochure to which the international standard book number is not added. Therefore, the control unit 30 can produce the book information 65 based on the other input book attribute information (that is, without the international standard book number) even if the international standard book number 68 is not input by the operator on the book attribute input image 49.

When the electronic book producing screen 42A is displayed on the display unit 40, the control unit 30 can allow the operator to arbitrarily select the book page images 45 to 48 by the image list display unit 43 on the electronic book producing screen 42A via the operation unit 36.

In addition, if one of the book page images 45 to 48 is arbitrarily selected by the operator with the image list display unit 43 via the operation unit 36, the control unit 30 notifies the graphic engine 38 of the selected book page image of the book page images 45 to 48.

The graphic engine 38 updates the reproducible contents of the electronic book producing image data based on the book page images 45 to 48 in the notification from the control unit 30 at this time. In addition, the graphic engine 38 sends the electronic book producing screen data whose contents are updated to the display unit 40 via the video output unit 39.

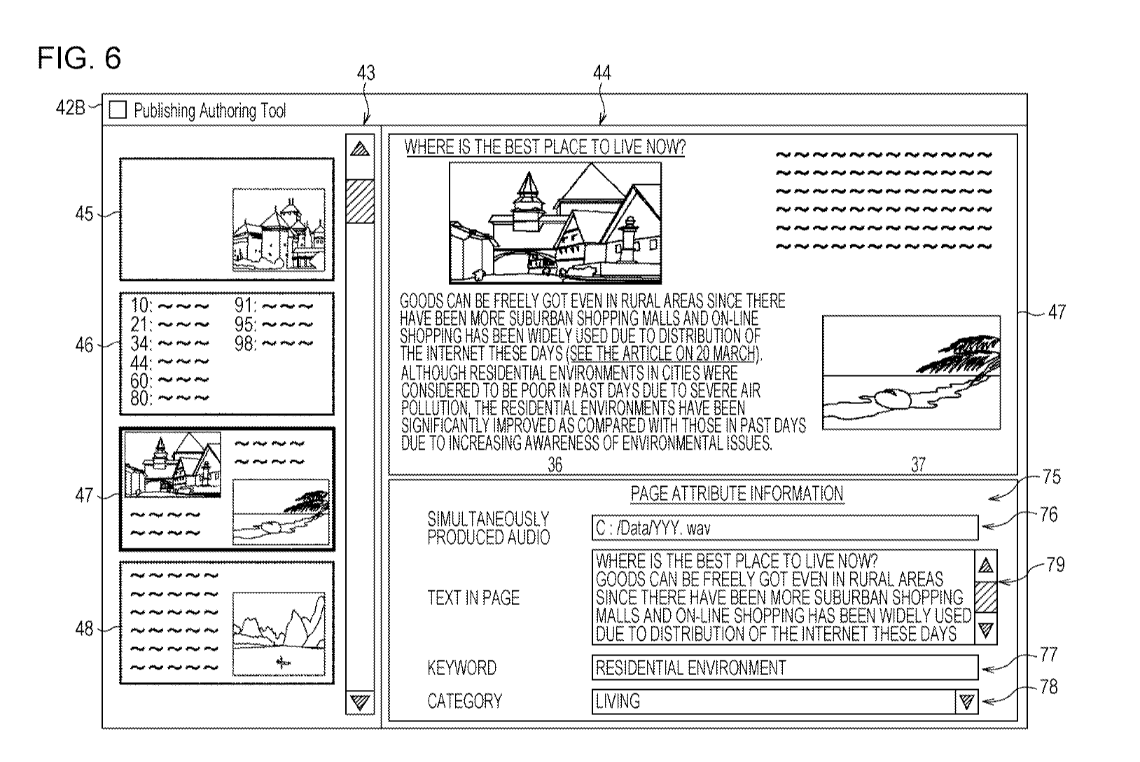

In so doing, the control unit 30 displays on the display unit 40 the electronic book producing screen 42B as shown in FIG. 6, in which the same reference numerals are added to the parts corresponding those in FIG. 4, based on the electronic book producing screen data whose contents are updated.

In such a case, in the electronic book producing screen 42B, the book page image 47 selected by the operator at this time is enlarged and displayed on the upper side in the information input unit 44 in the vertical direction of the screen. In addition, in the electronic book producing screen 42B, the page attribute input image 75 which is for inputting the attribute information of the book page image 47 (hereinafter, also referred to as page attribute information) selected by the operator at this time on the lower side in the information input unit 44 in the vertical direction of the screen.

In the page attribute input image 75, an audio specifying information input section 76 which is for inputting audio specifying information of the audio data chosen in the hard disk driver 53 so as to be reproduced during the display of the book page image 47 by the user as the page attribute information is provided.

That is, the audio specifying information input section 76 which is for setting the audio data to be reproduced during the display of the book page image 47 by the user is provided in the page attribute input image 75. In addition, the audio data set to be reproduced during the display of the book page images 45 to 48 of the electronic book will also be referred to as page audio data in particular in the following description.

Moreover, a keyword input section 77 which is for inputting a keyword arbitrarily chosen in accordance with the contents of the book page image 47 (that is, the keyword representing the feature of the book page image 47) as the page attribute information is also provided in the page attribute input image 75.

Furthermore, a category input section 78 which is for arbitrarily choosing and inputting the category to which the content of the book page image 47 belongs from among a plurality of candidates prepared in advance as a pull-down menu or the like as the page attribute information is also provided in the page attribute input image 75.

Furthermore, a text display section 79 which is for displaying the text in the book page image 47 as the page attribute information is provided in the page attribute input image 75. In addition, text in the book page image 47 (hereinafter, this is also referred to as in-page text) is automatically displayed on the text display section 79.

Accordingly, if the page attribute input image 75 is displayed on the information input unit 44 in the electronic book producing screen 42B, the control unit 30 allows the operator to input the page attribute information on the page attribute input image 75 via the operation unit 36.

That is, the control unit 30 allows the operator to input the page attribute information of the book page image 47 via the page attribute input image 75 of the information input unit 44 while the book page image 47 selected at this time is enlarged and displayed to be shown.

By the way, the control unit stores on the hard disk driver 53 various kinds of data associated with the electronic book, such as audio data, movie data, and still image data to be reproduced in response to the selection of specific reproducible parts of the article (text), and the in-page images in the book page image 47.

In addition, the specific parts of the article (text), the in-page images, and the like in the book page image 47 will also be referred to as associated parts in the following description. In addition, the various kinds of audio data, movie data, and still image data associated with the associated parts in the book page image 47 will also be referred to as associated data for reproduction as a whole in the following description. Moreover, the movie data associated with the associated parts is constituted by audio data and moving image data.

That is, the control unit 30 prepares in advance various kinds of associated data for reproduction to be reproduced in response to the instruction of the associated parts in the book page image 47 when the book page images 45 to 48 are displayed by the user.

In addition, the control unit 30 reads the associated data for reproduction from the hard disk driver 53 via the switcher 54 in response to the operation of the operation unit 36 by the operator. At this time, if the associated data for reproduction read from the hard disk drive 53 is audio data, or the associated data for reproduction is movie data including audio data, the control unit 30 sends the audio data to the audio processor 55.

At this time, the audio processor 55 sends the audio data to the speaker 57 via the audio output unit 56 after decoding the audio data in the same manner as described above and causes the speaker 57 to output the audio based on the audio data.

In addition, if the associated data for reproduction read from the hard disk drive 53 is movie data including moving image data, or the associated data for reproduction is still image data, the control unit 30 sends the moving image data or the still image data to the video decoder 82.

The video decoder 82 sends the moving image data or the still image data to the display unit 40 via the graphic engine 38 and the video output unit 39 in this order after decoding the moving image data or the still image data and causes the display unit 40 to display the moving image or the still image based on the moving image data or the still image data.

In so doing, the control unit 30 can reproduce the movie data or the still image data stored in the hard disk drive 53 for reproduction of the electronic book and allow the operator to view the movie or the still image.

In addition, the control unit 30 is configured to be capable of allowing the operator to arbitrarily choose the associated data for reproduction to be reproduced in response to the instruction of the associated parts during the display of the book page image 47 by the user from among various kinds of associated data for reproduction prepared in advance.

Moreover, the control unit 30 can allow the operator to arbitrarily designate an associated part in the article associated with the associated data for reproduction (at least a part of the text), the in-page image, and the like on the book page image 47 displayed in the information input unit 44, via the operation unit 36.

Furthermore, the control unit 30 allows the operator to input the association specifying information for reproduction (not shown) with which the associated data for reproduction associated with the associated part can be specified as the page attribute information on the page attribute input image 75 when the associated part associated with the associated data for reproduction is instructed.

Then, when the association specifying information for reproduction is input, the control unit 30 associates the association specifying information for reproduction with position information representing the position of the associated part chosen in the book page image 47 at this time to produce the associating information. In so doing, the control unit 30 associates the associated part in the book page image 47 with the associated data for reproduction associated therewith by the associating information.

Furthermore, the control unit 30 can also allow the operator to arbitrarily designate the associated part associated with the book page image of the same or another electronic book on the book page image 47 displayed in the information input unit 44, via the operation unit 36.

In addition, the electronic book including the book page image associated with the associated part in the book page image 47 in the electronic book will also be referred to as an associated electronic book, and the book page image associated with the associated part will also be referred to as an associated page image, in the following description.

In addition, when the associated part associated with the associated page image is chosen, the control unit 30 allows the operator to input the book title of the associated electronic book (not shown) including the associated page image associated with the associated part as the page attribute information on the page attribute input image 75.

Moreover, when the associated part associated with the associated page image is chosen, the control unit 30 allows the operator to input the page number (not shown) of the associated page image associated with the associated part as the page attribute information on the page attribute input image 75. In addition, the book title of the associated electronic book will also be referred to as an associated book title, and the page number of the associated page image will also be referred to as an associated page number, in the following description.

Then, when the associated book title and the associated page number are input as described above, the control unit 30 associates the input associated book title and the associated page number with the position information representing the position of the associated part chosen at this time to produce the associating information. In so doing, the control unit 30 associates the associated part in the book page image 47 with the associated page image associated therewith by the associating information.

In addition to this, the control unit 30 can also allow the operator to arbitrarily designate an associated part associated with movie data, homepages, and the like provided via the network 23, on the book page image 47 displayed in the information input unit 44 via the operation unit 36. In addition, movie data, homepages, and the like via the network 23, which are associated with the associated parts, will also be referred to as associated data for provision as a whole in the following description.

In addition, the control unit 30 allows the operator to input a network address (not shown) representing the providing source of the associated data for provision associated with the associated part as the page attribute information on the page attribute input image 75 when the associated part associated with the provision associated data is chosen. In addition, the network address representing the providing source of the associated data for provision associated with the associated parts chosen by the operator will also be referred to as an associated address in the following description.

Then, when the associated address is input as described above, the control unit 30 associates the input associated address with the position information representing the position of the associated part chosen in the book page image 47 at this time to produce the associating information. In so doing, the control unit 30 associates the associated part in the book page image 47 with the associated data for provision associated therewith by the associating information.

In addition, when at least a part of the text is chosen as the associated part on the book page image 47, the control unit 30 processes the book page image 47 so as to differentiate the display state of at least a part of the selected text from those of the other parts by an underline or the like.

In addition, when the in-page image is chosen as the associated part on the book page image 47, the control unit 30 processes the book page image 47 so as to differentiate the display state from those of the other in-page images by surrounding the in-page image by a frame or the like. When the book page image 47 is processed as described above, the control unit 30 sets the processed book page image data of the book page image 47 to the book page image data for the electronic book.

Accordingly, the control unit 30 is configured to be capable of easily determining the associated parts associated with the associated data for reproduction, the associated page image, and the associated data for provision in the book page image 47 when the processed book page image 47 of the electronic book is displayed by the user.

Moreover, when the associated part is not specified and the book page image 47 is not particularly processed, the control unit 30 sets the unprocessed book page image data of the book page image 47 to the book page image data for the electronic book as it is.

In addition, when the input of the page attribute information is finalized by the operator via the operation unit 36, the control unit 30 associates the page attribute information in the page attribute input image 75 with the page number as the page attribute information of the book page image 47. In so doing, the control unit 30 produces the individual book page information constituted by various kinds of page attribute information of the hook page image 47 selected by the operator.

The control unit 30 sets the keyword and the category of the book page image 47 based on the individual book page information by producing the individual book page information of the book page image 47 as describe above. In addition, the control unit 30 sets audio data for the page such as BGM, or reading of the texts in the book page image 47, for example, to be reproduced while the book page image 47 is displayed by the user who has purchased the electronic book, based on the individual book page information.

That is, the control unit 30 sets the audio data for the page to be reproduced while the book page image 47 is displayed by the user to the audio data specified by the audio specifying information in the individual book page information.

By the way, if the input of the page attribute information is finalized while the audio specifying information is not input on the page attribute input image 75, for example, the control unit 30 produces the individual book page information based on the other input page attribute information (that is, without the audio specifying information).

Then, when the individual book page information is produced while the audio specifying information is not input on the page attribute input image 75 as described above, the control unit 30 makes a setting so as to reproduce the common audio data referring to the book information 65 during the display of the book page image 47.

In addition, when text with various contents and various in-page images are included in the book page image 47, and it is difficult to set a keyword and a category, for example, the control unit 30 can allow the finalization of the input of the page attribute information with the input of the keyword and the category.

In so doing, the control unit 30 can produce the individual book page information which does not include a keyword and a category (that is, in which a keyword and a category are not particularly set) for the hook page image 47 selected by the operator.

Then, when the individual book page information of the book page image 47 is produced, the control unit 30 performs downsize processing on the book page image data of the book page image 47 so as to interpolate the pixels. In so doing, the control unit 30 produces thumbnail image data for a thumbnail image as an index of the book page image 47 obtained by reducing the image size while the contents (designs) of the book page image 47 remain the same.

In addition, the control unit 30 adds the page number of the original book page image 47 to the thumbnail image data such that it is possible to specify which book page image 47 the thumbnail image data is for.

described above, the control unit 30 allows the operator to input the page attribute information for the selected one of the book page images 45 to 48 in the same manner as described above every time the book page 45 to 45 are selected by the operator via the operation unit 36.

In addition, the control unit 30 associates the page attribute information of the book page images 45 to 48 with the page numbers of the book page images 45 to 45 and produces the individual book page information for each of the book page images 45 to 48.

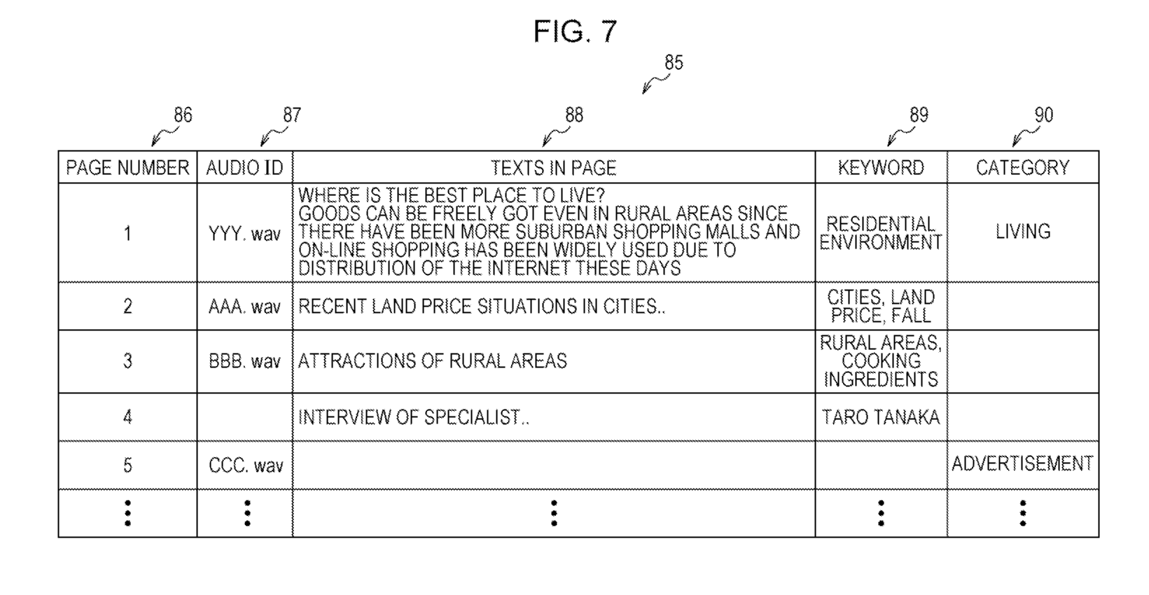

In addition, when respective individual book page information is produced for all of the book page images 45 to 48 of the electronic book, the control unit 30 organizes the individual book page information for each of the book page images 45 to 48 to produce the page information 85 as shown in FIG. 7.

That is, the control unit 30 produces the page information 85 which associates and stores the page number 86, the audio specifying information 87, the in-page text 88, the keyword 89, the category 90, and the associating information which is not shown in the drawing for each of the book page image 45 to 48.

By the way, the control unit 30 can allow the operator to draw square frames, for example, so as to surround the individual articles, the paragraphs in the articles, the in-page image, and the like on the book page image 47, which is enlarged and displayed on the information input unit 44, via the operation unit 36.

In so doing, the control unit 30 can allow the operator to choose one or a plurality of areas surrounded by the square frames as enlargement target areas which can be individually enlarged and displayed by the user, in the book page image 47 enlarged and displayed on the information input unit 44.

In addition, the control unit 30 issues area specifying information with which the enlargement target areas can be individually specified every time one enlargement target area is chosen in the book page image 47. Moreover, the control unit 30 notifies the graphic engine 38 of the area specifying information of the enlargement target areas.

The graphic engine 38 updates the contents of the electronic book producing image data with the use of the area specifying information in the notification from the control unit 30 at this time. In addition, the graphic engine 39 sends the electronic book producing screen data whose contents are updated to the display unit 40 via the video output unit 39.

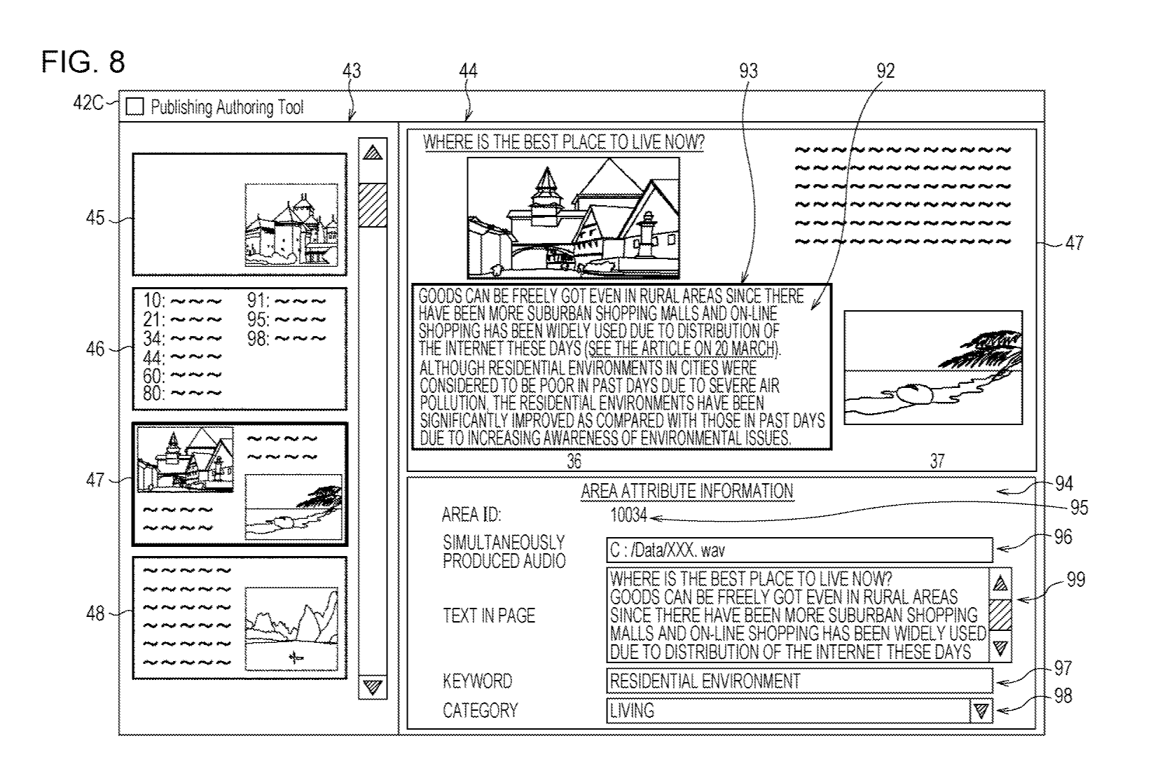

In so doing, the control unit 30 displays on the display unit 40 the electronic book producing screen 42C as shown in FIG. 8, in which the same reference numerals are given to the parts corresponding to those in FIG. 6, based on the electronic book producing screen data whose contents are updated.

In such a case, the book page image 47 is continuously enlarged and displayed on the upper side in the information input unit 44 in the vertical direction of the screen on the electronic book producing screen 42C. In addition, a square frame image 93 representing the enlargement target area 92 chosen by the operator at this time (that is, drawn by the operator) on the book page image 47 in the information input unit 44 on the electronic book producing screen 42C.

In addition, an area attribute input image 94 which is for inputting attribute information of the enlargement target area 92 (hereinafter, this is also referred to as area attribute information) chosen by the operator at this time is displayed on the lower side in the information input unit 44 in the vertical direction of the screen on the electronic book producing screen 42C.

The area specifying information 95 for the enlargement target area 92 chosen at this time is displayed as the area attribute information in the area attribute input image 94. In addition, an audio specifying information input section 96 which is for inputting the audio specifying information for the audio data chosen in the hard disk driver 53 to be reproduced during enlargement and display of the enlargement target area 92 by the user as the area attribute information is provided in the area attribute input image 94.

That is, the audio specifying information input section 96 which is for setting the audio data to be reproduced while the enlargement target area 92 in the book page image 47 is enlarged and displayed by the user is provided in the area attribute input image 94.

In addition, the audio specifying information in this case is also a file name of the audio data, for example, with which the audio data can be specified in the same manner as described above. Moreover, the audio data set to be reproduced during the display of the enlargement target area 92 will also be referred to as audio data for the area in particular in the following description.

In addition, a keyword input section 97 which is for inputting the keyword (that is, the keyword representing the feature of the enlargement target area 92) arbitrarily chosen in accordance with the content of the enlargement target area 92 as the area attribute information is also provided in the area attribute input image 94.

Moreover, a category input section 98 which is for arbitrarily choosing and inputting the category to which the content of the enlargement target area 92 belongs to from among a plurality of candidates, for example, as the area attribute information is also provided in the area attribute input image 94.

In addition, a text display section 99 which is for displaying the text in the enlargement target area 92 as the area attribute information is provided in the area attribute input image 94 when the text is included in the enlargement target area 92. Moreover, the text in the enlargement target area 92 (hereinafter, this is also referred to as in-area text) is automatically displayed in the text display section 99.

Accordingly, the control unit 30 allows the operator to input the area attribute information on the area attribute input image 94 via the operation unit 36 when the area attribute input image 94 is displayed on the information input unit 44 on the electronic book producing screen 420.

That is, the control unit 30 allows the operator to input the area attribute information of the enlargement target area 92 while emphasizing, displaying, and showing the enlargement target area 92 chosen at this time with the frame image 93, via the area attribute input image 94 of the information input unit 44.

Then, if the input of the area attribute information is finalized by the operator via the operation unit 36, the control unit 30 associates the area attribute information in the area attribute input image 94 with the area position information representing the position of the enlargement target area 92 in the book page image 47 as the area attribute information.

In addition, the control unit 30 also associates the area attribute information in the area attribute input image 94 with the page number of the book page image 47 including the enlargement target area 92. In so doing, the control unit 30 produces the area individual information constituted by various kinds of area attribute information for the enlargement target area 92 chosen by the operator.

The control unit 30 sets the keywords and the category of the enlargement target area 92 based on the area individual information by producing the area individual information of the enlargement target area 92 as described above. In addition, the control unit 30 sets the audio data for the area such as BGM and the reading of the texts within the enlargement target area 92 to be reproduced while the enlargement target area 92 is enlarged and displayed by the user who has purchased the electronic book, by the area individual information.

That is, the control unit 30 sets the audio data for the area to be reproduced while the enlargement target area 92 is enlarged and displayed by the user to the audio data specified by the audio specifying information in the area individual information.

By the way, if the input of the area attribute information is finalized while the audio specifying information is not input on the area attribute input image 94, for example, the control unit 30 produces the area individual information based on the other input area attribute information (that is, without the audio specifying information).

Then, when the area individual information is produced while the audio specifying information is not input on the area attribute input image 94, the control unit 30 makes the setting so as to reproduce the common audio data referring to the book information 65 during enlargement and display of the enlargement target area 92.

In addition, when text of various contents and various in-page images is included in the enlargement target area 92, and it is difficult to set a keyword and a category, for example, the control unit 30 can allow the finalization of the input of the area attribute information without the input of the keyword and the category.

The control unit 30 can produce the area individual information which does not include a keyword and a category (that is, in which a keyword and a category are not particularly set) for the enlargement target area 92 chosen by the operator as described above.

In addition to this, when the input, of the area attribute information is finalized by the operator via the operation unit 36, the control unit 30 extracts a part of the enlargement target area 92 chosen at this time as area data from the book page image data for the book page image 47.

In addition, the control unit 30 adds the area specifying information for the original enlargement target area 92 after performing the enlargement processing on the area data by interpolating the pixels or the like and produces the area enlargement image data obtained by enlarging the enlargement target area 92 (that is, by increasing the image size of the enlargement target area 92).

In so doing, the control unit 30 allows the operator to input the area attribute information for the chosen enlargement target area 92 in the same manner as described above every time the enlargement target area 92 is chosen by the operator via the operation unit 36.

In addition, the control unit 30 associates the area attribute information of the enlargement target area 92 with the page numbers of the book page images 45 to 48 including the enlargement target area 92 and produces the area individual information for each enlargement target area 92. Moreover, the control unit 30 performs enlargement processing on the area data for the enlargement target area 92 and produces the area enlargement image data for enlarging and displaying the enlargement target area 92.

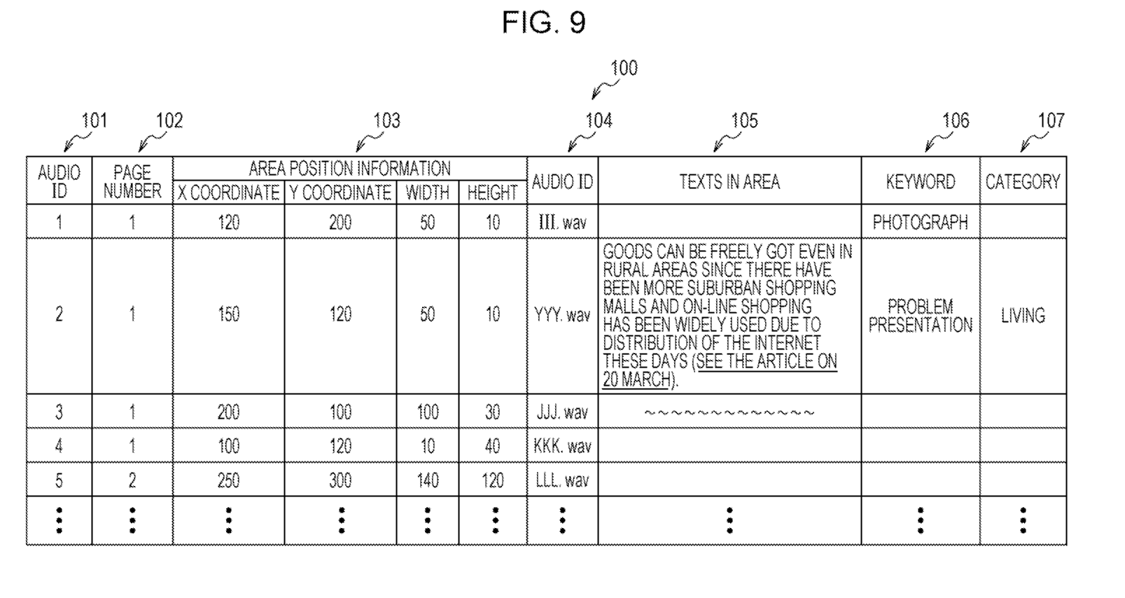

In addition, when area individual information is respectively produced for all of the enlargement target areas 92 chosen in the electronic book, the control unit 30 organizes the area individual information for each enlargement target area 92 and produces the area information 100, as shown in FIG. 9.

That is, the control unit 30 generates the area information 100 associating and storing the area specifying information 101, the page number 102, the area position information 103, the audio specifying information 104, the in-area text 105, the keyword 106 and the category 107 for each enlargement target area 92.

In addition, the area position information 103 stored in the area information 100 represents the position of the enlargement target area 92 by the x coordinate and the y coordinate of the left upper corner of the enlargement target area 92 in the book page images 45 to 48, and the width and the height of the enlargement target area 92, for example.

The control unit 30 produces the page information 85 and the area information 100 and reads the common audio data and the audio data for the page set to be reproduced during the display of the electronic book, and the audio data for the area via the switcher 54 from the hard disk drive 53.

In addition, the common audio data, the audio data for the page set to be reproduced during the display of the electronic book and the audio data for the area will be referred to as audio data for the book as a whole in the following description.

In addition, the control unit 30 reads the associated data for reproduction set to be reproduced when the associated part in the book page images 45 to 48 are selected by the user, from the hard disk driver 53 via the switcher 54.

Moreover, the control unit 30 sends the audio data for the book and the associated data for reproduction to a stream processor 109. In so doing, the control unit 30 respectively codes the audio data for the book and the associated data for reproduction in the stream processor 109.

Moreover, the control unit 30 organizes the book cover image data, the book page image data, the thumbnail image data, the area enlargement image data, which are produced at this time, and book information 65, the page information 85, the area information 100, the coded audio data for the book and the associated data for reproduction.

In addition, the book cover image data, the book page image data, the thumbnail image data, and the area enlargement image data included in the electronic book data will also be referred to as book image data as a whole in the following description when the discrimination thereof is not particularly necessary. In addition, the coded audio data for the book will also be referred to as coded audio data, and the coded associated data for reproduction will also be referred to as coded associated data in the following description.

In so doing, the control unit 30 produces the electronic book data for one electronic book including the book image data, the book information 65, the page information 85, the area information 100, the coded audio data, and the coded associated data.

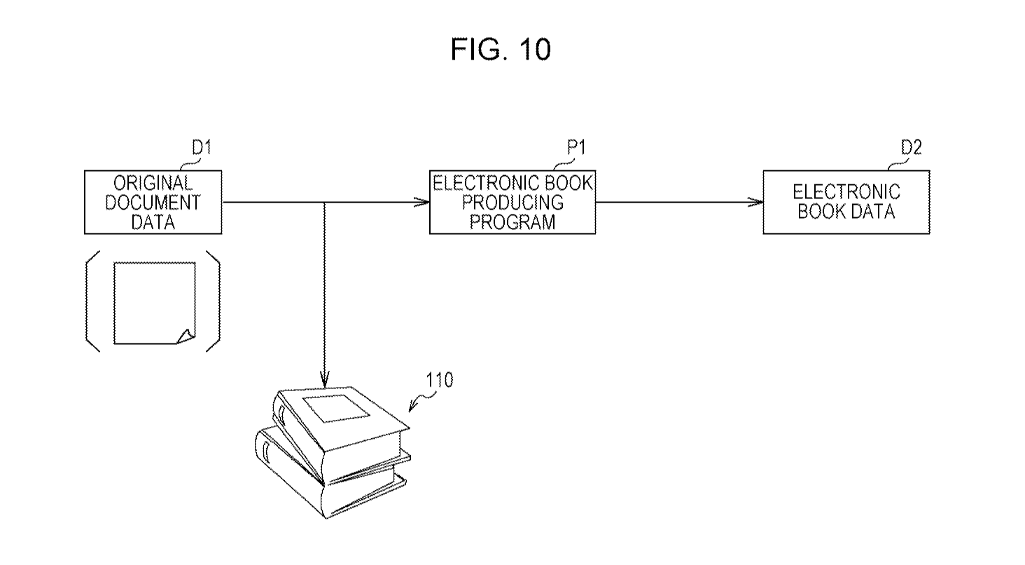

That is, as shown in FIG. 10, the control unit 30 produces the electronic book data D2 based on an electronic book producing program P1 with the use of the original document data D1 in the first format, which is imported from the outside and produced for manufacturing the publication 110.

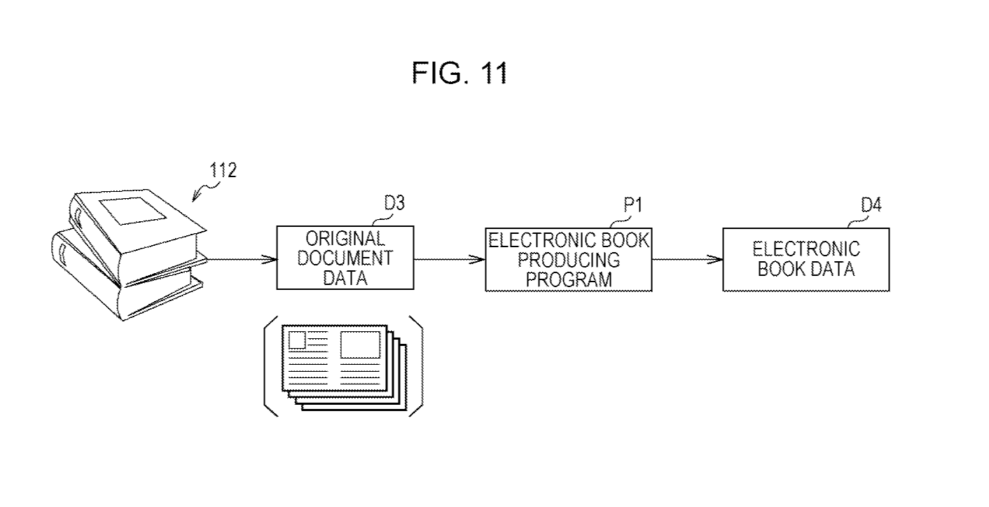

In addition, as shown in FIG. 11, the control unit 30 produces the electronic book data D4 based on the electronic book producing program P1 with the use of the original document data D3 in the second format, which is produced by scanning the publication 112 which has already been published.

Then, when the electronic book data D2 and D4 are produced, the control unit 30 transmits the electronic book data D2 and D4 to the history obtaining apparatus 22 via the network controller 115. In addition, the control unit 30 also sends the specification request information requesting the book specifying information with which the electronic book can be specified based on the electronic book data D2 and D4 to the history obtaining apparatus 22 via the network controller 115 at this time along with the electronic book data D2 and D4.

When the electronic book data D2 and D4 and the specification request information sent from the electronic book producing apparatus 21 are received, the history obtaining apparatus 22 issues the book specifying information, with which the electronic book based on the electronic book data D2 and D4 can be specified, based on the specification request information. In addition, the history obtaining apparatus 22 replies the book specification information to the electronic book producing apparatus 21 via the network 23.

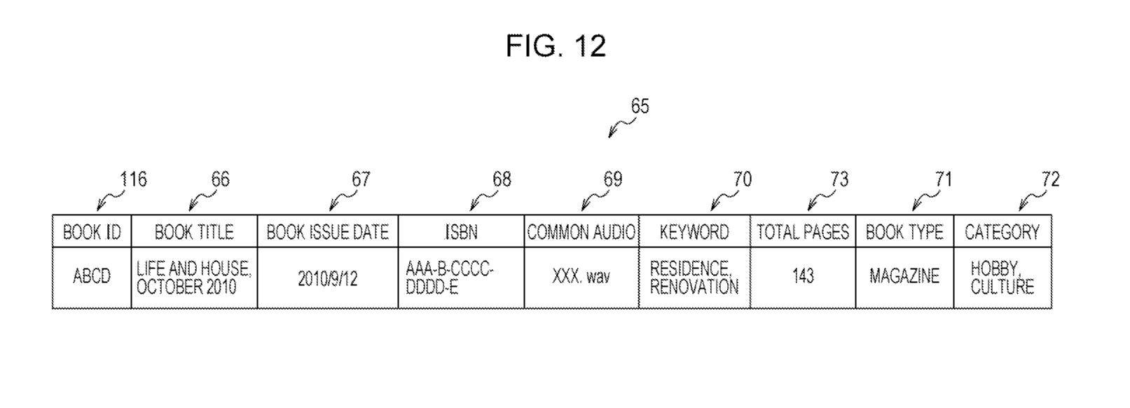

At this time, the control unit 30 of the electronic book producing apparatus 21 receives and imports the book specifying information returned from the history obtaining apparatus 22 by the network controller 115. Then, the control unit 30 stores the book specifying information 116 on the book information 65 produced at this time as shown in FIG. 12. In so doing, the control unit 30 updates the contents of the book information 65 for recording of the electronic book data D2 and D4 on the disc-shaped recording medium.

By the way, when the electronic book data D2 and D4 are produced, the control unit 30 allows the operator to input the condition for converting the first or second format of the book image data into the disc format for the book providing disc 20 via the operation unit 36.

In addition, when the electronic book data D2 and D4 are produced, the control unit 30 allows the operator to input a parameter or the like for converting the first or second format of the book image data into the disc format for the book providing disc 28 via the operation unit 36.

In addition, the condition, the parameter, and the like for converting the first or second format of the book image data included in the electronic book data D2 and D4 into the disc format for the book providing disc 28 will also be referred to as format conversion information as a whole in the following description.

Accordingly, when the book specifying information 116 is stored on the hook information 65, the control unit 30 sequentially sends the electronic book data D2 and D4 including the book information 65 along with the format conversion information to the hard disk driver 53 via the switcher 54. In so doing, the control unit 30 makes a correspondence relationship between the electronic book data D2 and D4 and the format conversion information and stores the electronic book data D2 and D4 on the hard disk drive 53.

In so doing, the control unit 30 accumulates and stores a plurality of electronic book data items D2 and D4 on the hard disk drive 53 by storing the electronic book data D2 and D4 on the hard disk drive 53 every time the electronic book data D2 and D4 are produced.

Then, when the production of the book providing disc 28 is requested by the operator via the operation unit 36 in the state in which the disc-shaped recording medium 118 is mounted on the electronic book producing apparatus 21, the control unit 30 executes the producing processing of the book providing disc 28.

At this time, the control unit 30 reads the electronic book reproducing program stored in advance from the hard disk drive 53 via the switcher 54. In addition, the control unit 30 sends the electronic book reproducing program to the drive 120 via the switcher 54. In so doing, the control unit 30 stores the electronic book reproducing program in the disc-shaped recording medium 118 by the drive 120.

In addition, the control unit 30 reads the book information 65 included in each of a plurality of electronic book data items D2 and D4 from the hard disk drive 53 via the switcher 54. Moreover, the control unit 30 extracts the book title 66, the book issue date 67, the book type 71, and the category 72, for example, from each of a plurality of book information items 65 and sends them to the graphic engine 38.

The graphic engine 38 produces the book selection screen data, which is for selecting the electronic book, with the use of the book title 66, the book issued data 67, the book type 71, and the category 72 of each of the plurality of electronic books given from the control unit 30.

That is, the graphic engine 38 produces the book selection screen data which is for selecting the electronic book to be provided using the book providing disc 28, with the use of the book title 66, the book issue date 67, the book type 71, and the category 72 of each of the plurality of electronic books.

In addition, the graphic engine 38 sends the book selection screen data to the display unit 40 via the video output unit 39. In so doing, the graphic engine 38 displays the book selection screen (not shown) based on the book selection screen data on the display unit 40.

In such a case, a list of the book titles 66, the book issue dates 67, the book types 71, and the categories 72 of the plurality of electronic books is displayed in the book selection screen. In addition, a selection button which is for selecting the presence of the recording of the electronic book data D2 and D4 on the book providing disc 28 produced at this time is also displayed in the book selection screen.

Accordingly, the control unit 30 allows the operator to select one or a plurality of electronic books to be provided is the book providing disc 28 produced at this time, on the book selection screen via the operation unit 36. In addition, the control unit 30 allows the operator to select the presence of the recording of the electronic book data D2 and D4 on the book providing disc 28 produced at this time, on the book selection screen via the operation unit 36.

That is, the control unit 30 allows the operator to select which one of the book providing disc 28 recording the electronic book data D2 and D4 and the book providing disc 28 without the electronic book data D2 and D4 recorded thereon is to be produced at this time, on the book selection screen.

At this time, if the recording of the electronic book data D2 and D4 on the book providing disc 28 along with one or a plurality of electronic books is selected, the control unit 30 reads the electronic book data D2 and D4 of the selected electronic book from the hard disk drive 53 via the switcher 54. In addition, the control unit 30 also reads the format conversion information corresponding to the electronic book data D2 and D4 of the selected electronic book from the hard disk drive 53 via the switcher 54.

Moreover, the control unit 30 sends the book image data included in the electronic book data D2 and D4 to the stream processor 109 along with the format conversion information. Moreover, the control unit 30 converts the book image data in the first or second format into the disc format based on the format conversion information by the stream processor 109.

Then, the control unit 30 sends one or a plurality of electronic book data items D2 and D4 including the book image data, for which the first or second format is converted into the disc format, to the drive 120 via the switcher 54. In so doing, the control unit 30 records one or a plurality of electronic book data D2 and D4 on the disc-shaped recording medium 118 by the drive 120.

In addition, when the recording of one or a plurality of electronic book data items D2 and D4 on the disc-shaped recording medium 118 is completed, the control unit 30 produces an index table as a list of the book titles of one or a plurality of electronic book data items D2 and D4 whose recording has been completed.

In addition, the control unit 30 records the index table on the disc-shaped recording medium 118 by the drive 120 by sending the index table to the drive 120 via the switcher 54.

Moreover, the control unit 30 also sends a decoding key information for decoding (breaking the codes) the coded associated data D7 and the coded audio data D8 included in one or a plurality of electronic book data D2 and D4 whose recording has been completed, to the drive 120 via the switcher 54. In so doing, the control unit 30 also records the decoding key information on the disc-shaped recording medium 118 by the drive 120.

Furthermore, the control unit 30 stores in advance on the hard disk drive 53 a route certificate as an open key certificate which is issued by a third party and necessary for the electronic book reproducing apparatus 24 to communicate with the history obtaining apparatus 22 via SSL. In addition, SSL is an abbreviation of Secure Sockets Layer Protocol.

Accordingly, the control unit 30 reads the route certificate from the hard disk drive 53 via the switcher 54 and sends the read route certificate to the drive 120 via the switcher 54 at this time. In so doing, the control unit 30 also records the route certificate on the disc-shaped recording medium 118 by the drive 120.

In addition to this, the control unit 30 calculates a data verification value to be user for the verification of validity of the electronic data D2 and D4 such as a hash with the use of at least a part of the electronic book data D2 and D4 for each of the electronic book data D2 and D4 whose recording has been completed. In addition, the control unit 30 makes a correspondence relationship between the verification value for each of the electronic book data D2 and D4 and the book specifying information 116 of the electronic book data D2 and D4.

Moreover, the control unit 30 calculates the certificate verification value to be used for verification of validity of the route certificate such as a hash with the use of at least a part of the route certificate recorded on the disc-shaped recording medium 118.

Then, the control unit 30 organizes the data verification value, the book specifying information 116 corresponded to the data verification value, and the certificate verification value to produce the electronic book certificate and sends the produced electronic book certificate to the drive 120 via the switcher 54. In so doing, the control unit 30 also records the electronic book certificate on the disc-shaped recording medium 118 by the drive 120.

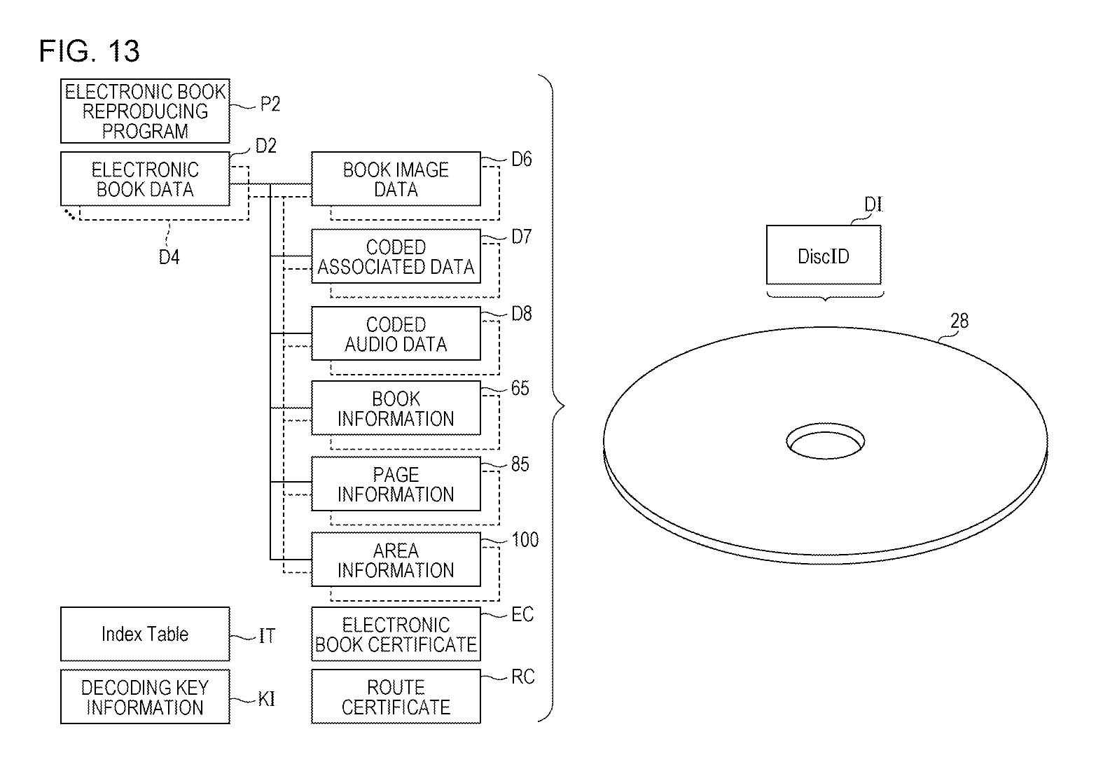

In so doing, the control unit 30 produces the book providing disc 28 recording the electronic book reproducing program P2, one or a plurality of electronic book data D2 and D4, the index table IT, the decoding key information KI, the electronic book certificate EC, and the route certificate RC as shown in FIG. 13.

In addition, the electronic book data D2 and D4 recorded in the book providing disc 28 is constituted by the book image data D6 in the disc format, the coded associated data D7, the coded audio data D8, the book information 65, the page information 85, and the area information 100. In addition, the book specifying information 116 is stored on the book information 65 recorded on the book providing disc 28.

By the way, disc specifying information DI with which the disc-shaped recording medium 118 can be individually specified is printed or engraved on the book providing disc 28 at an inner most circumferential part at the time of manufacturing as the original disc-shaped recording medium 118, for example. In addition, such disc specifying information DI is used for managing the book providing disc 28 purchased by the user as will be described later, for example.

In addition, the control unit 30 codes not only the coded associated data D7 and the coded audio data D8 included in the electronic book data D2 and D4 but also the entire electronic book data D2 and D4 in accordance with the presetting, for example.

In addition, the control unit 30 can code at least one of the book image data D6, the coded associated data D7, the coded audio data D8, the book information 65, the page information 85, and the area information 100 included in the electronic book data D2 and D4 in accordance with the presetting. In addition, the control unit 30 can also produce the book providing disc 28 recording the electronic book data D2 and D4 in which at least a part is encoded as described above.

In addition, when the book providing disc 28 recording the electronic book data D2 and D4 in which at least a part is coded is produced as described above, the control unit 30 records the decoding key information which is for decoding the coding, on the book providing disc 28.

On the other hand, if non-recording of the electronic book data D2 and D4 along with one or a plurality of electronic books is selected on the book selection screen, the control unit 30 reads the electronic book data D2 and D4 of the electronic book selected from the hard disk drive 53 via the switcher 54.

In addition, the control unit 30 produces the index table in the same manner as described above based on the book information 65 included in the electronic book data D2 and D4 read from the hard disk drive 53. Then, the control unit 30 records the index table on the disc-shaped recording medium 118 by the drive 120 by sending the index table to the drive 120 via the switcher 54.

Moreover, the control unit 30 reads the route certificate from the hard disk drive 53 via the switcher 54 and sends the read route certificate to the drive 120 via the switcher 54. In so doing, the control unit 30 stores the route certificate on the disc-shaped recording medium 118 via the drive 120.

Furthermore, the control unit 30 produces the electronic book certificate in the same manner as described above with the use of the electronic book data D2 and D4 of the electronic book selected at this time along with the route certificate and sends the produced electronic book certificate to the drive 120 via the switcher 54. In so doing, the control unit 30 records the electronic book certificate on the disc-shaped recording medium 118 by the drive 120.

When the non-recording of the electronic book data D2 and D4 is selected as described above, the control unit 30 produces the book providing disc 28 (not shown) recording the electronic book reproducing program P2, the index table IT, the electronic book certificate EC, and the route certificate RC.

In so doing, the control unit 30 can produce the book providing disc 28 recording the electronic book data D2 and D4 and produce the book providing disc 28 which does not record the electronic book data D2 and D4.

In addition, when a large number of book providing disks 28 with the same recording content are produced, the control unit 30 takes over the entire data to be recorded on the book providing disc 28 to a disc manufacturing factory via a portable recording medium or the network 23.

In addition, when the book providing disc 28 records the electronic book data D2 and D4, the entire data to be recorded on the book providing disc 28 means the electronic book reproducing program P2, one or a plurality of electronic book data items D2 and D4, the index table IT, the decoding key information KI, the electronic book certificate EC, and the route certificate RC.

In addition, when the book providing disc 28 does not record the electronic book data, the entire data to be recorded on the book providing disc 28 means the electronic book reproducing program 22, the index table IT, the electronic book certificate EC, and the route certificate RC.

According to the electronic book providing system 20, when the entire data to be recorded on the book providing disc 28 is handed over to the disc manufacturing factory, a stamper for injection molding is manufactured based on the entire data in the disc manufacturing factory, for example.

In addition, according to the electronic book providing system 20, the book providing disc 28 is injection-molded with the use of the stamper in the disc manufacturing factory. In so doing, it is possible to produce a large number of book providing discs 28 with the same recording contents according to the electronic book providing system 20.

### 1-4. Configuration of Electronic Book Reproducing Apparatus 24

### [1-4-1. Circuit Configuration of Electronic Book Reproducing Apparatus 24]

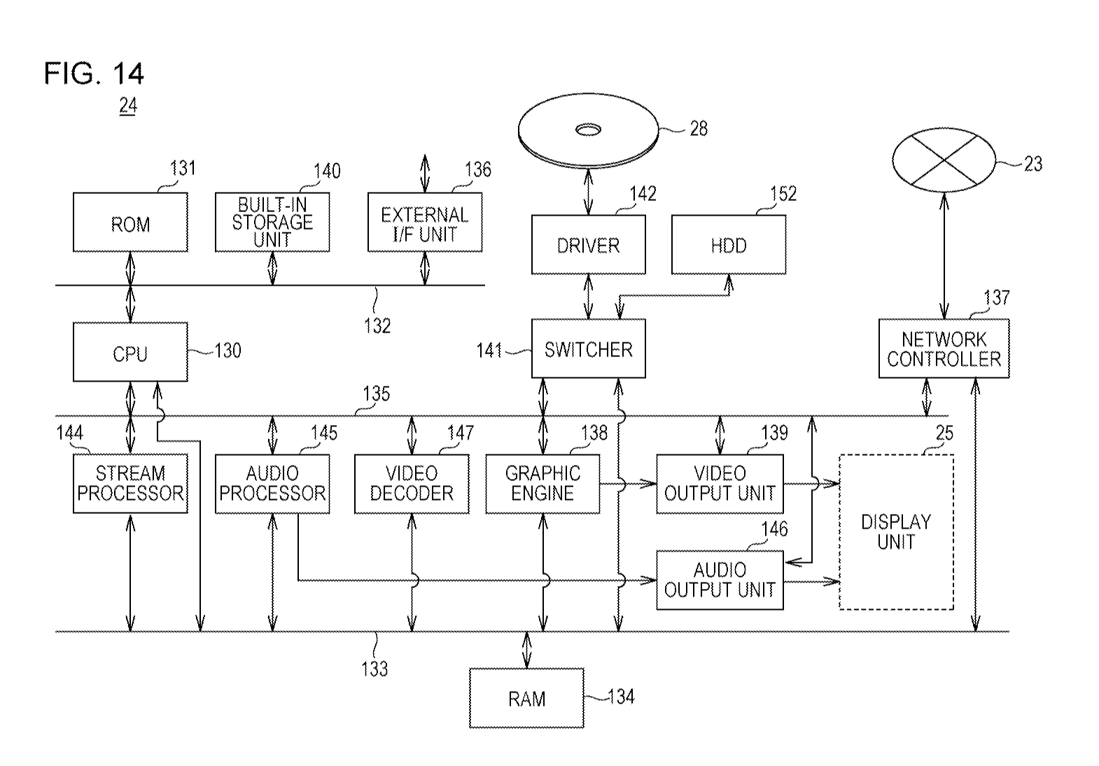

Next, description will be made of the circuit configuration of the electronic book reproducing apparatus 24 with the use of FIG. 14. The electronic book reproducing apparatus 24 includes a controller or control unit 130 constituted by a CPU. The control unit 130 reads various programs such as a basic program and/or various application programs stored in advance in a non-transitory computer-readable medium such as the ROM 131, via the input output bus 132.

In addition, the control unit 130 transfers the various programs to the RAM 134 as a work area of the control unit 130 via the memory bus 133 and executes the various programs thereon. Then, the control unit 30 controls the overall apparatus via the input output bus 132 and the system bus 135 based on the various programs executed on the RAM 134. In addition, the control unit 130 executes predetermined computation processing based on the various programs.

Furthermore, the control unit 130 also executes various kinds of processing in response to the operation command given from the remote control 27 via the external interface unit 136 and the input output bus 132 in this order in response to the operation of the remote control 27 (not shown in FIG. 14) based on the various programs.

In so doing, the control unit 130 produces user registration screen request information requesting the user registration screen data when the user registration to the history obtaining apparatus 22 is requested by the user via the remote control 27, for example.

In addition, the control unit 130 transmits the user registration screen request information to the history obtaining apparatus 22 from the network controller 137 via the network 23. As a result, the control unit 130 receives and imports the user registration screen data by the network controller 137 when the user registration screen data is returned from the history obtaining apparatus 22.

In addition, the control unit 130 sends the user registration screen data to the display apparatus 25 via the graphic engine 138 and the video output unit 139 in this order and displays a user registration screen (not shown) based on the user screen data on the display surface of the display apparatus 25.

The control unit 130 stores the user information and produces the user registration request information for requesting the user registration when the user information of the user is input by the user on the user registration screen via the remote control 27 in this state. In addition, the user information includes a user's name, an address, a credit card number, user specifying information, a password, and the like.

Then, the control unit 130 transmits the user registration request information to the history obtaining apparatus 22 from the network controller 137 via the network 23. As a result, the control unit 130 receives and imports the user registration completion notification screen data by the network controller 137 when the user registration is completed and the user registration completion notification screen data for notifying of the completion is returned from the history obtaining apparatus 22.

In addition, the control unit 130 sends the user registration completion notification screen data to the display apparatus 25 via the graphic engine 138 and the video output unit 139 in this order. In so doing, the control unit 130 notifies the user of the completion of the user registration by displaying the user registration completion notification screen (not shown) based on the user registration completion notification screen data on the display surface of the display unit 25. In addition, the control unit 130 sends the user identification information and the password of the user to a built-in storage unit 140 and stores and keeps the user identification information and the password when the user registration is completed as described above.

On the other hand, if the book providing disc 28 is purchased by a user, and a registration of the book providing disk 28 is requested via the remote control 27, the control unit 130 reads the user specification information and the password from the built-in storage unit 140.

In addition, the control unit 130 stores the user specifying information and the password and produces the authentication processing request information for requesting the user authentication processing. Then, the control unit 130 transmits the authentication processing request information to the history obtaining apparatus 22 from the network controller 137 via the network 23.

As a result, when the user authentication processing is performed by the history obtaining apparatus 22 based on the authentication processing request information, the user is authenticated, and the authentication notification information is returned, the control unit 130 receives and imports the authentication notification information by the network controller 137.

When it is detected that the user has been authenticated based on the authentication notification information, the control unit 130 produces disc registration screen request information for requesting the disc registration screen data. Then, the control unit 130 transmits the disc registration screen request information to the history obtaining apparatus 22 from the network controller 137 via the network 23.

As a result, when the disc registration screen data is returned from the history obtaining apparatus 22, the control unit 130 receives and imports the disc registration screen data by the network controller 137. In addition, the control unit 130 sends the disc registration screen data to the display apparatus 25 via the graphic engine 138 and the video output unit 139 in this order and displays on the display surface of the display apparatus 25 a disc registration screen (not shown) based on the user screen data.

When the disc information is input on the disc registration screen by the user via the remote control 27, the control unit 130 stores the disc information along with the user specifying information and the password and produces the disc registration request information for requesting the disc registration. In addition, the disc information includes disc specifying information of the book providing disc 28 purchased by the user and the book title of the electronic book provided by the book providing disc 28.

Then, the control unit 130 transmits the disc registration request information to the history obtaining apparatus 22 from the network controller 137 via the network 23. As a result, when the disk registration is completed, and the disc registration completion notification screen data for notifying of the completion is returned from the history obtaining apparatus 22, the control unit 130 receives and imports the disc registration completion notification screen data by the network controller 137.

In addition, the control unit 130 sends the disc registration completion notification screen data to the display apparatus 25 via the graphic engine 138 and the video output unit 139 in this order. In so doing, the control unit 130 displays the disc registration completion notification screen (not shown) based on the disc registration completion notification screen data on the display surface of the display apparatus 25 and notifies the user of the completion of the disc registration. In addition, when the disc registration is completed as described above, the control unit 130 sends the disc specifying information and the book title used for the disc registration to the built-in storage unit 140 and stores and keeps the disc specifying information and the book title.

By the way, when the book providing disc 28 is mounted on the electronic book reproducing apparatus 24, and the reproduction of the electronic book is instructed by the user via the remote control 27, the control unit 130 accesses the book providing disc 28 via the switcher 141 and the drive 142.

In so doing, the control unit 130 reads the electronic book reproducing program from the book providing disc 28 via the switcher 141 and the drive 142 in this order and transfers the read electronic book reproducing program to the RAM 134 and executes the program thereon.

Then, the control unit 130 executes the electronic book reproducing processing based on the electronic book reproducing program along with the aforementioned various programs which have been already executed on the RAM 134. In such a case, the control unit 130 reads the index table from the book providing disc 28 via the switcher 141 and the drive 142 in this order and sends the index table to the graphic engine 138.

The graphic engine 138 produces the index screen data for list-displaying the book titles of the all (one or a plurality of) electronic books provided via the book providing disc 28 based on the index table given from the control unit 130.

In addition, the graphic engine 138 sends the index screen data to the display apparatus 25 via the video output unit 139 and displays the index screen (not shown) based on the index screen data on the display surface of the display apparatus 25.

In so doing, the control unit 130 notifies the user of the electronic book to be provided by the book providing disc 28 mounted on the electronic book reproducing apparatus 24 at this time as the book title, via the index screen displayed on the display surface of the display apparatus 25.

In addition, when the index screen is displayed on the display surface of the display apparatus 25 as described above, the control unit 130 can allow the user to select, the electronic book to be displayed as the book title on the index screen via the remote control 27.

When the electronic book is selected on the index screen, the control unit 130 detects whether or not the electronic book data D2 and D4 of the selected electronic book is stored on the book providing disc 28 via the switcher 141 and the drive 142 in this order.

That is, the control unit 130 detects whether or not the book providing disc 28 recording the electronic book data D2 and D4 is mounted on the electronic book reproducing apparatus 24 at this time. As a result, if the electronic book data D2 and D4 are recorded on the book providing disc 28, the control unit 130 reads the electronic book data D2 and D4 of the selected electronic book from the book providing disc 28 via the switcher 141 and the drive 142 in this order.

In addition, the control unit 130 reads the electronic book certificate and the route certificate from the book providing disc 28 via the switcher 141 and the drive 142 in this order. Moreover, the control unit 130 calculates the data verification value with the use of at least a part of the electronic book data D2 and D4 read from the book providing disc 28. Furthermore, the control unit 130 calculates the certificate verification value with the use of at least a part of the route certificate.

Then, the control unit 130 checks the validity of the electronic book data D2 and D4 (that is, whether the data has been falsified) read from the book providing disc 28 at this time, based on the electronic book certificate, the calculated data verification value, and the certificate verification value. If it is confirmed as a result that the electronic book data D2 and D4 are valid, the control unit 130 sends the book cover image data included in the electronic book data D2 and D4 to the graphic engine 138.

When the book over image data is given from the control unit 130, the graphic engine 138 sends the book cover image data to the display apparatus 25 via the video output unit 139 after performing display processing on the book cover image data. In so doing, the graphic engine 138 displays the book cover image based on the book cover image data over the entire surface of the display surface of the display apparatus 25.

If the page sending is instructed by the user via the remote control 27 in this state, the control unit 130 sends the book page image data of the top facing pages to the graphic engine 138 from among the book page image data included in the electronic book data D2 and D4.

Then, when the top book page image data is given from the control unit 130, the graphic engine 138 sends the book page image data to the display apparatus 25 via the video output unit 139 after performing display processing on the book page image data in the same manner as described above. In so doing, the graphic engine 138 displays the book page images of the top facing pages on the entire surface of the display surface of the display apparatus 25 instead of the book cover image which have been displayed until then.

In addition, if the page sending is instructed by the user via the remote control 27 in the state in which the book page image is displayed on the display apparatus 25, the control unit 130 sends the book image data of the facing pages in accordance with the instruction to the graphic engine 138.

Then, when the new book page image data is given from the control unit 130, the graphic engine 138 sends the book page image data to the display apparatus 25 via the video output unit 139 after performing display processing on the book page image data in the same manner as described above.

In so doing, the graphic engine 138 displays the book page images of the next facing pages over the entire surface of the display surface of the display apparatus 25 instead of the book page images of the facing pages which have been displayed until then.

Furthermore, when the page return is instructed by the user via the remote control 27 in the state in which the book page image is displayed on the display apparatus 25, the control unit 130 sends the book page image data of the facing pages in accordance with the instruction to the graphic engine 138.

Then, when the new book page image data is given from the control unit 130, the graphic engine 138 sends the book page image data to the display apparatus 25 via the video output unit 139 after performing display processing on the book page image data in the same manner as described above. In so doing, the graphic engine 138 displays the book page images of the previous facing pages over the entire surface of the display surface of the display apparatus 25 instead of the book page images of the facing pages which have been displayed until then.

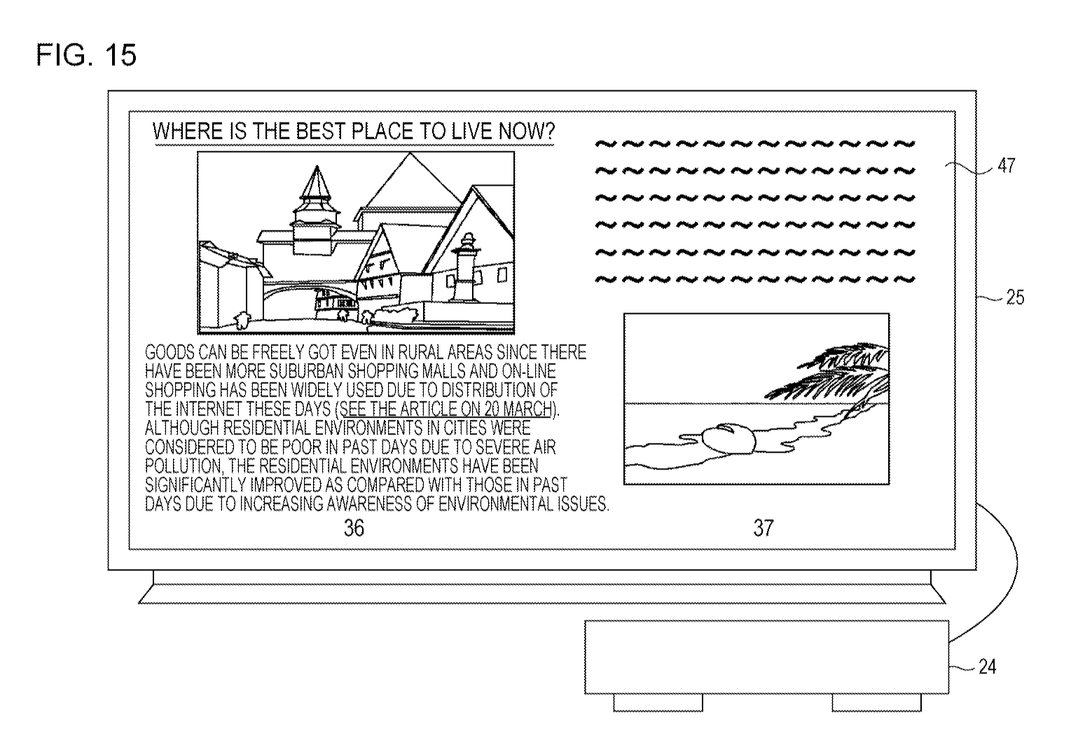

As described above, the control unit 130 displays the book page image 47 of the electronic book over the entire surface of the display surface of the display apparatus 25 connected to the electronic book reproducing apparatus 24 and appropriately switches the book page images 47 to be displayed over the entire surface of the display surface, as shown in FIG. 15.

In addition, when the index display of the book page image is instructed by the user is the remote control 2/during the display of the book page image 47, the control unit 130 sends a plurality of thumbnail image data items included in the electronic book data D2 and D4 to the graphic engine 138.

When a plurality of thumbnail image data items are given from the control unit 130, the graphic engine 138 synthesizes the plurality of thumbnail image data items with the book page image data of the book page image 47 displayed at this time and performs display processing.

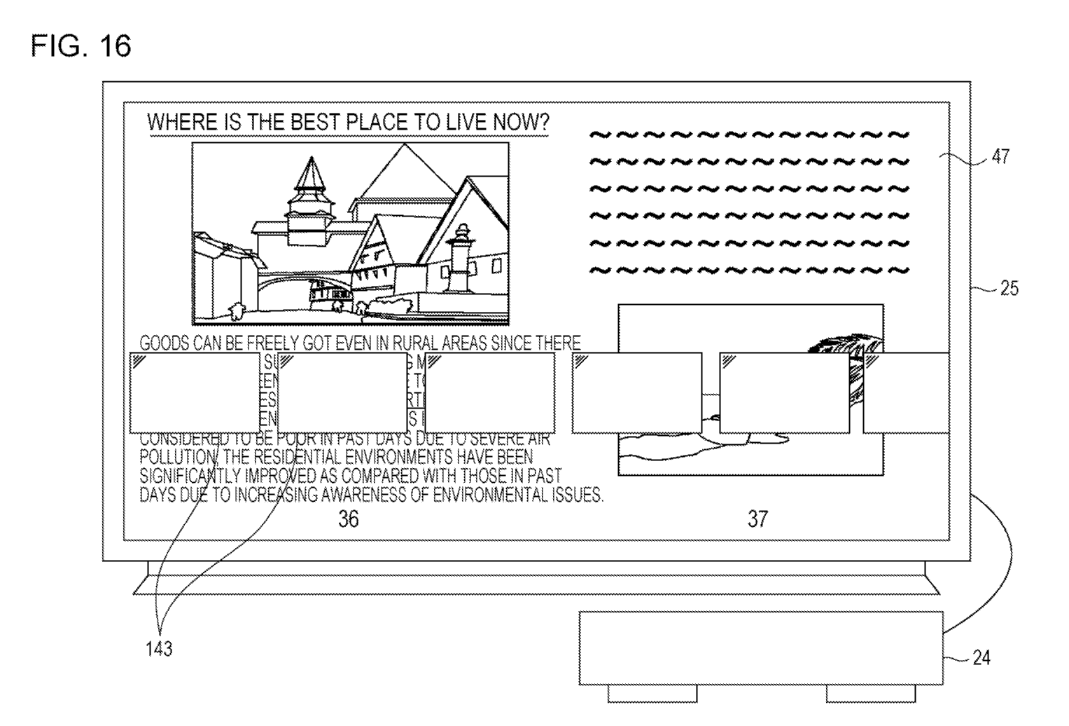

Then, the graphic engine 138 sends the book page image data with which the thumbnail image data has been synthesized to the display apparatus 25 via the video output unit 139. In so doing, the graphic engine 138 continuously displays the book page image 47 which has been displayed until then and displays a plurality of thumbnail images 143 arranged in a line in the horizontal direction of the screen on the book page image 47, in the display surface of the display apparatus 25 as shown in FIG. 16.

When the index display of the book page image is instructed, the control unit 130 shows a plurality of book page images of the electronic book as thumbnail images 143 on the book page image 47.

At this time, if the scrolling of the thumbnail images 143 is instructed by the user via the remote control 27, the control unit 130 controls the graphic engine 138 to scroll the plurality of thumbnail images 143 in the horizontal direction of the screen on the book page image 47.

Then, when a desired thumbnail image 143 is selected by the user via the remote control 27 on the book page image 47, the control unit 130 sends the book page image data corresponding to the selected thumbnail image 143 to the graphic engine 138.

When the book page image data is given from the control unit 130, the graphic engine 138 performs the same processing as described above. In so doing, the graphic engine 138 displays the book page image of the facing pages corresponding to the selected thumbnail image 143 over the entire surface of the display surface of the display apparatus 25 instead of the book page image 47 and the plurality of thumbnail images 143 which have been displayed until then.

The control unit 130 can also switch the book page images 47 to be displayed on the display surface of the display apparatus 25 as if a plurality of pages are skipped regardless of the order of the pages as described above.

As described above, the control unit 130 can allow the user to read the electronic book by appropriately switching and displaying the book page images 45 to 48 of the electronic book on the display surface of the display apparatus 25 after the book cover image of the electronic book.

By the way, when the book cover image is displayed on the display surface of the display apparatus 25, the control unit 130 specifies the common audio data included in the electronic book data D2 and D4 based on the audio specifying information stored on the book information 65 and sends the common audio data to the stream processor 144. In addition, the control unit 130 reads the decoding key information from the book providing disc 28 via the switcher 141 and the drive 142 in this order and sends the decoding key information to the stream processor 144 at this time.

If the decoding key information is given from the control unit 130 along with the coded common audio data, the stream processor 144 decodes (breaks the code) of the coded common audio data based on the decoding key information and produces the common audio data. Then, the stream processor 144 sends the common audio data to the audio processor 145.

When the common audio data is given from the stream processor 144, the audio processor 145 sends the common audio data to the display apparatus 25 via the audio output unit 146 after decoding the common audio data. In so doing, the audio processor 145 causes the speaker provided in the display apparatus 25 to output the audio based on the common audio data.

When the display of the book cover image is started, the control unit 130 starts the reproduction of the common audio data as described above. Then, the control unit 130 continues the reproduction of the common audio data and allows the user to listen to the audio based on the common audio data while the book cover image is displayed.

In addition, when the book page image 47 is displayed on the display apparatus 25 instead of the book cover image, the control unit 130 refers to the page information 85 corresponding to the book page image 47. Then, if the audio specifying information is store in the referred page information 85, the control unit 130 sends the audio data for the page specified by the audio specifying information included in the electronic book data D2 and D4 to the stream processor 144 instead of the common audio data.

When the coded audio data for the page is given from the control unit 130 instead of the common audio data, the stream processor 144 decodes (breaks the code) the coded audio data for the page based on the decoding key information and produces the page audio data. Then, the stream processor 144 sends the page audio data to the audio processor 145.

When the audio data for the page is given from the stream processor 144 instead of the common audio data, the audio processor 145 sends the audio data for the page to the display apparatus 25 via the audio output unit 146 after decoding the audio data for the page. In so doing, the audio processor 145 causes the speaker provided in the display apparatus 25 to output the audio based on the audio data for the page instead of the audio based on the common audio data.

When the display of the book page image is started, the control unit 130 starts the reproduction of the audio data for the page instead of the common audio data as described above. Then, the control unit 130 continues the reproduction of the audio data for the page and allows the user to listen to the audio based on the audio data for the page while the written page image is displayed.

On the other hand, if the audio specifying information is not stored on the referred page information 85, the control unit 130 continuously sends the common audio data to the stream processor 144. Therefore, the stream processor 144 continuously sends the common audio data to the audio processor 145 after decoding (breaking the code) the coded common audio data based on the decoding key information.

Then, the audio processor 145 also sends the common audio data to the display apparatus 25 via the audio output unit 146 after decoding the common audio data. In so doing, the audio processor 145 causes the speaker provided in the display apparatus 25 to continuously output the audio based on the common audio data.

If setting is made such that the common audio data is reproduced while the book page image 47 is displayed, the control unit 130 allows the user to continuously listen to the audio based on the common audio data during the display of the book page image 47.

Moreover, when the book page image displayed on the display apparatus 25 is switched, the control unit 130 refers to the page information 85 corresponding to the book page image before switching and the page information 85 corresponding to the book page image after switching and compares therebetween.

As a result, if setting is made such that different audio data is produced for the book page images before switching and after switching, the control unit 130 stops sending the common audio data or the audio data for the pages which have been sent to the stream processor 144 until then.

Then, the control unit 130 sends the audio data for the page and the common audio data set to be reproduced during the display of the book page image after switching to the stream processor 144. At this time, the stream processor 144 performs processing on the audio data for the page or the common audio data in the same manner as described above. In addition, the audio processor 145 also performs processing on the audio data for the page or the common audio data in the same manner as described above.

In so doing, the audio processor 145 causes the speaker of the display apparatus 25 to output via the audio output unit 146 the audio based on the audio data for the page or the common audio data, which is different from the previous data, instead of the audio which has been output until then.

In so doing, if setting is made such that different audio data is reproduced for the book page images before switching and after switching, the control unit 130 switches the audio to be listened to by the user in accordance with the switching of the display of the book page images.

On the other hand, if setting is made such that the same audio data is reproduced for the book page images before switching and after switching, the control unit 130 continuously sends the common audio data or the audio data for the pages which have been sent to the stream processor 144 until then.

At this time, the stream processor 144 continuously performs processing on the same audio data for the page or the common audio data in the same manner. In addition, the audio processor 145 also continuously performs processing on the same audio data for the page or the common audio data in the same manner. In so doing, the audio processor 145 causes the speaker of the display apparatus 25 to continuously output the audio which have been output until then, via the audio output unit 146.

When setting is made such that the same audio data is reproduced for the book page images before switching and after switching, the control unit 130 allows the user to listen to the same audio even if the displayed book page images are switched.

In addition, when an associated part is designated on the book page image 47 displayed on the display surface of the display apparatus 25 by the user via the remote control 27, the control unit 130 refers to the associating information for the designated associated part included in the page information 85.

If the association specifying information for reproduction is stored on the associating information as a result, the control unit 130 sends the associated data for reproduction specified by the association specifying information for reproduction included in the electronic book data D2 and D4 to the stream processor 144.

In addition, the control unit 130 reads the decoding key information from the book providing disc 28 via the switcher 141 and the drive 142 in this order and sends the decoding key information to the stream processor 144 at this time. When the decoding key information is given from the control unit 130 along with the coded associated data for reproduction, the stream processor 144 decodes (breaks the code) the coded associated data for reproduction based on the decoding key information.

Then, if the associated data for reproduction decoded at this time is audio data or includes audio data, the stream processor 144 sends the audio data to the audio processor 145. In addition, if the associated data for reproduction decoded at this time is still image data or includes moving image data, the stream processor 144 sends the still image data or the moving image data to the video decoder 147.

At this time, when the audio data is given from the stream processor 144, the audio processor 145 sends the audio data to the display apparatus 25 via the audio output unit 146 after decoding the audio data. In so doing, the audio processor 145 causes the speaker of the display apparatus 25 to output the audio based on the audio data.

In addition, when the still image data or the moving image data is given from the stream processor 144, the video decoder 147 decodes the still image data or the moving image data. Then, the video decoder 147 sends the decoded still image data or the moving image data to the display apparatus 25 via the graphic engine 138 and the video output unit 139 in this order.

In so doing, the video decoder 147 displays the still image or the moving image based on the still image data or the moving image data instead of the book page image 47 or so as to be overlapped with at least a part of the book page image 47 on the display surface of the display apparatus 25.

The control unit 130 can allow the used to view the still image, the movie, or the like associated with the associated part by reproducing the associated data for reproduction when the associated part associated with the associated data for reproduction is designated on the book page image 47 as described above.

On the other hand, if an associated is stored on the referred associating information, the control unit 130 accesses the associated address on the network 23 via the network controller 137. Accordingly, the control unit 130 receives and imports the associated data for provision, which is associated with the associated part designated by the user, by the network controller 137 from the providing source of the associated data for provision represented by the associated address.

Then, if audio data is included in the associated data for provision, the control unit 130 sends the audio data to the audio processor 145. In addition, if still image data or moving image data is included in the associated data for provision, the control unit 130 sends the still image data or the moving image data to the video decoder 147.

When the audio data is given from the control unit 130 at this time, the audio processor 145 decodes the audio data in the same manner as described above and sends the audio data to the display apparatus 25 via the audio output unit 146. In so doing, the audio processor 145 causes the speaker of the display apparatus 25 to output the sound based on the audio data.

In addition, when the still image data or the moving image data is given form the control unit 130, the video decoder 147 decodes the still image data or the moving image data in the same manner as described above. Then, the video decoder 147 sends the decoded still image data or the moving image data to the display apparatus 25 via the graphic engine 138 and the video output unit 139 in this order.

In so doing, the video decoder 147 displays the still image or the moving image based on the still image data or the moving image data instead of the book page image 47 so as to be overlapped with at least a part of the book page image 47 on the display surface of the display apparatus 25.

In so doing, the control unit 130 can allow the user to watch the movie or the like or view the homepages associated with the associated part by reproducing the associated data for provision when the associated part associated with the associated data for provision is designated on the book page image 47.

In addition, if the associated book title is stored on the referred associating information, the control unit 130 determines whether or not the electronic book data D2 and D4 with the associated book title is recorder on the book providing disc 28 via the switcher 141 and the drive 142 in this order.

If the electronic book data D2 and P4 with the associated book title is recorded in the book providing disc 28 as a result, the control unit 130 reads the electronic book data D2 and D4 from the book providing disc 28 via the switcher 141 and the drive 142 in this order.

Then, the control unit 130 sends the book page image data to which the associated page number stored on the associating information is added to the graphic engine 138 from among the book page image data included in the electronic book data D2 and D4.

When the book page image data is given form the control unit 130, the graphic engine 138 sends the book page image data to the display apparatus 25 via the video output unit 139 after performing display processing on the book page image data in the same manner as described above. In so doing, the graphic engine 138 displays the associated page image instead of the book page image 47 which has been displayed until then or so as to be overlapped with at least a part of the book page image 47 on the display surface of the display apparatus 25.

On the other hand, if the electronic book data D2 and D4 with the associated book title is not recorded in the book providing disc 28, the control unit 130 reads the user specifying information and the password from the built-in storage unit 140. In addition, the control unit 130 produces authentication processing request information storing the user specifying information and the password. Then, the control unit 130 transmits the authentication processing request information to the history obtaining apparatus 22 from the network controller 137 via the network 23.

if the user authentication processing is executed used on the authentication processing request information, the user is authenticated, and the authentication notification information is returned from the history obtaining apparatus 22 as a result, the control unit 130 receives and imports the authentication notification information by the network controller 137.

When it is detected that the user has been authenticated based on the authentication notification information, the control unit 130 stores the associated book title and the associated book number and produces image request information for requesting the book page image data to which the associated page number is added.

Then, the control unit 130 transmits the image request information to the history obtaining apparatus 22 from the network controller 137 via the network 23. When the book page image data to which the associated page number is added is returned from the history obtaining apparatus 22 as a result, the control unit 130 receives and imports the book page image data by the network controller 137. Then, the control unit 130 sends the book page image data to the graphic engine 138.

When the book page image data is given from the control unit 130, the graphic engine 138 sends the book page image data to the display apparatus 25 via the video output unit 139 after performing display processing on the hook page image data in the same manner as described above.

In so doing, the graphic engine 138 displays the associated page image instead of the book page image 47 which has been displayed until then or so as to be overlapped with at least a part of the book page image 47, on the display surface of the display apparatus 25.

As described above, the control unit 130 can show the user the associated page image by reproducing the associated data for provision when the associated part associated with the associated page image is designated on the book page image 47.

In addition, the control unit 130 controls the graphic engine 138 and the video decoder 147 if the display return is instructed via the remote control 27 in the state in which movie, a still image, or the like is output via the display apparatus 25 in response to the designation of the associated part by the user.

In so doing, the control unit 130 stops the output of the movie, the still image, or the like associated with the associated part via the display apparatus 25 and displays only the book page image 47 which has been displayed before the movie, the still image, or the like is output in the display apparatus 25.

Accordingly, the control unit 130 can easily return to the display of the book page image 47 before output and allow the user to read the electronic book again even if the movie, the still image, or the like associated with the associated part is output via the display apparatus 25.

By the way, if showing of the enlargement target area is instructed by the user is the remote control 27 in the state in which the book page image is displayed, the control unit 130 determines whether or not the enlargement target area is present in the book page image 47 based on the area information 100.

If it is detected that the enlargement target area is not present in the book page image being currently displayed as a result, the control unit 130 controls the graphic engine 138, for example. At this time, the graphic engine 138 produces synthesis image data by synthesizing message image data for notifying of that the enlargement target area is not present in the book page image with the book page image data of the book page image being currently displayed.

Then, the graphic engine 138 sends the synthesis data to the display apparatus 25 via the video output unit 139. In so doing, the graphic engine 138 displays the message image so as to be overlapped with the book page image being displayed on the display surface of the display apparatus 25.

When the enlargement target area is not present in the book page image 47 even if the showing of the enlargement target area is instructed, the control unit 130 notifies the user of the fact as described above.

On the other hand, if it is detected that the enlargement target area is present in the book page image 47, the control unit 130 extracts any one of the area position information items 103 corresponding to the page number of the book page image 47 being currently displayed from the area information 100. Then, the control unit 130 sends the area position information 103 to the graphic engine 138.

When the area position information 103 is given from the control unit 130, the graphic engine 138 processes the book page image data of the book page image 47 being currently displayed based on the area position information 103.

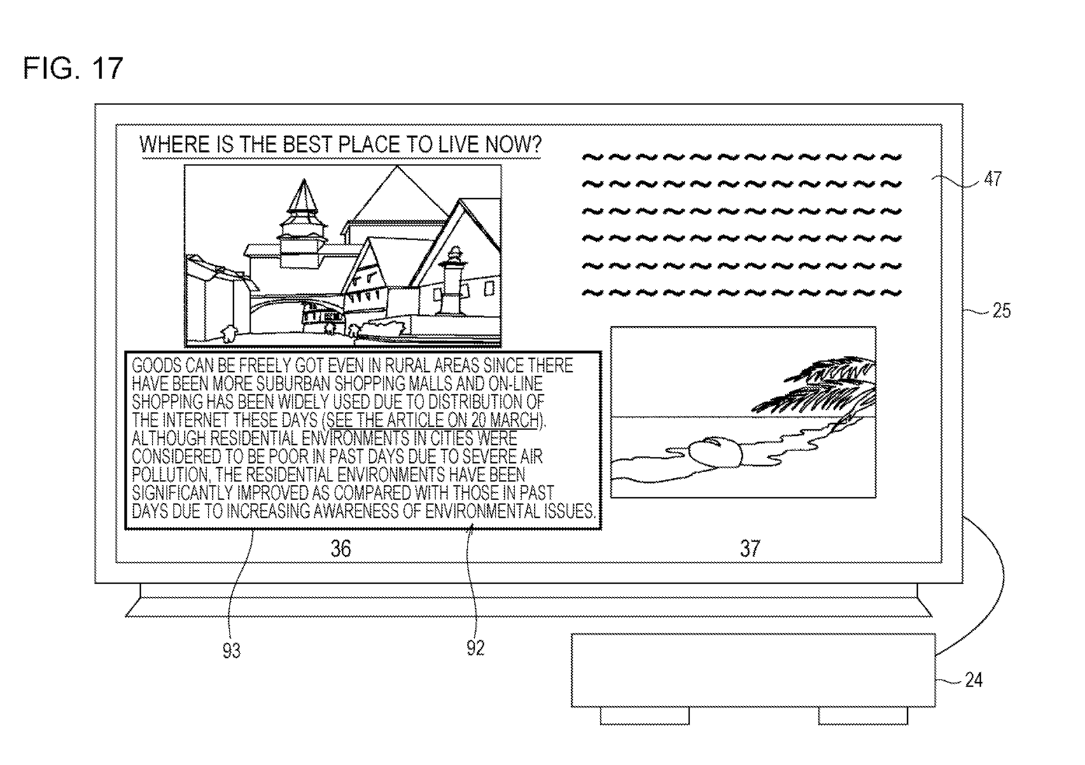

In addition, the graphic engine 138 sends the processed book page image data to the display apparatus 25 via the video output unit 139. In so doing, the graphic engine 138 displays a frame image 93 surrounding any one of the enlargement target areas 92 so as to be overlapped with the book page image 47 being displayed on the display surface of the display apparatus 25 as shown in FIG. 17.

In addition, if the moving of the frame image 93 is instructed by the user via the remote control 27 in the state in which the frame image 93 is displayed on the book page image 47, the control unit 130 determines whether or not another enlargement target area is present in the book page image 47 based on the area information 100.

If it is detected that another enlargement target area is not present in the book page image 47 being currently displayed as a result, the control unit 130 controls the graphic engine 138, for example. At this time, the graphic engine 138 synthesizes message image data for notifying of that only one enlargement target area is present in the book page image 47 with the book page image data of the book page image 47 being currently displayed and produces synthesis image data.

Then, the graphic engine 138 sends the synthesis image data to the display apparatus 25 via the video output unit 139. In so doing, the graphic engine 138 displays the message image so as to be overlapped with the book page image 47 being displayed on the display surface of the display apparatus 25.

When only one enlargement target area is present in the book page image 47, the control unit 130 notifies the user of that the frame image 93 cannot be moved, via the message image even if the movement of the frame image 93 for the enlargement target area is instructed.

On the other hand, if it is detected that another enlargement target area is present in the book page image 47, the control unit 130 extracts another area position information item 103 corresponding to the page number of the book page image 47 being currently displayed from the area information 100. Then, the control unit 130 sends the area position information 103 to the graphic engine 138.

When the area position information 103 is given from the control unit 130, the graphic engine 138 processes the book page image data based on the area position information 103 in the same manner as described above and sends the book page image data to the display apparatus 25 via the video output unit 139.

In so doing, the graphic engine 138 moves and displays the frame image 93, which has been displayed so as to surround any one of the enlargement target areas 92 until then, so as to surround another enlargement target area on the book page image 47 being displayed on the display surface of the display apparatus 25.

As described above, the control unit 130 can notify of whether or not enlargement target area 92 is present in the book page image 47 by display of the frame image 93 and the message image in response to the instruction of showing the enlargement target area. In addition, if only one enlargement target area 92 is present in the book page image 47, the control unit 130 can notify of the fact by the message image.

Moreover, if a plurality of enlargement target areas 92 is present in the book page image 47, the control unit 130 can allow the user to check the plurality of enlargement target areas 92 in turns by sequentially moving the frame image 93 in response to the instruction of the movement of the frame image 93.

In addition, if one or a plurality of enlargement target areas 92 is present in the book page image 47, the control unit 130 can allow the user to designate a desired enlargement target area 92 by surrounding the enlargement target area 92 with the frame image 93.

That is, if selection is instructed by the user via the remote control 27 in the state in which any one of the enlargement target areas 92 in the book page image 47 is surrounded by the frame image 93, the control unit 130 recognizes that the enlargement target area 92 surrounded by the frame image 93 at this time is selected.

At this time, the control unit 130 detects area specifying information for the designated enlargement target area 93 in the area information 100. In addition, the control unit 130 sends the area enlargement image data to which the detected area specifying information is added to the graphic engine 138 from among one or a plurality of area enlargement image data items included in the electronic book data D2 and D4.

When the area enlargement image data is given from the control unit 130, the graphic engine 138 synthesizes the area enlargement image data with the book page image data of the book page image 47 being currently displayed and produces synthesis image data.

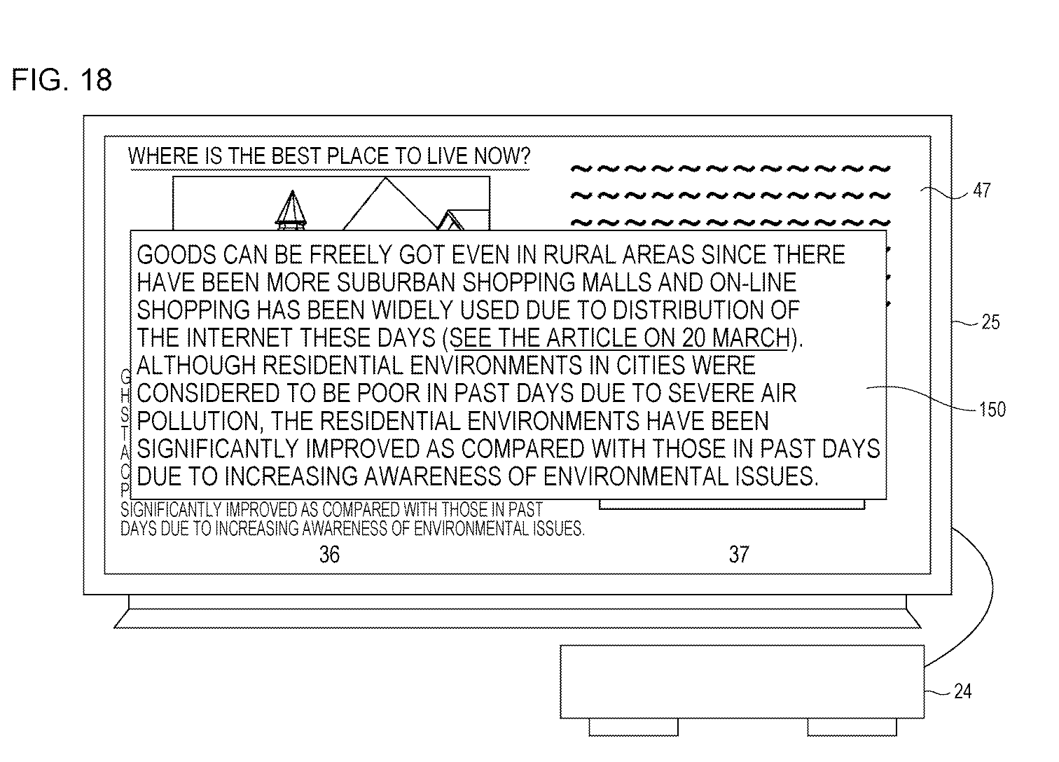

Then, the graphic engine 138 sends the synthesis image data to the display apparatus 25 via the video output unit 139. In so doing, the graphic engine 138 displays the area enlargement image 150 based on the area enlargement image data so as to be overlapped with the book page image 47 being displayed on the display surface of the display apparatus 25, as shown in FIG. 18.

If a desired enlargement target area 92 is designated on the book page image 47 being displayed on the display surface of the display apparatus 25, the control unit 130 can enlarge and display the designated enlargement target area 92 as the area enlargement image 150 on the book page image 47.

Accordingly, the control unit 130 can enhance the visibility and show the enlargement target area 92 enlarged and displayed on the display surface of the display apparatus 25. Particularly, when text is included in the enlargement target area 92, the control unit 130 can enlarge the text so as to be easily read.

In addition, if return of the display is instructed by the user via the remote control 27 in the state in which the enlargement target area 92 is enlarged and displayed as the area enlargement image 150, the control unit 130 controls the graphic engine 138, the video decoder 147, and the like.

In so doing, the control unit 130 deletes only the area enlargement image 150 while the display of the book page image 47 and the frame image 93 is left as it is on the display surface of the display apparatus 25. That is, the control unit 130 recovers the display contents on the display surface of the display apparatus 25 to the state immediately before enlarging and displaying the enlargement target area 92 (that is, immediately before displaying the area enlargement image 150). Accordingly, the control unit 130 can allow the user to check and appropriately designate the enlargement target area 92 again with the frame image 93 by deleting the area enlargement image 150 from the display surface of the display apparatus 25.

In addition, if return of the display is instructed by the user via the remote control 27 in the state in which the frame image 93 is displayed so as to be overlapped with the book page image 47, the control unit 130 controls the graphic engine 138, the video decoder 147, and the like.

In so doing, the control unit 130 deletes the frame image 93 from the book page image 47 on the display surface of the display apparatus 25. That is, the control unit 130 recovers the display contents on the display surface of the display apparatus 25 to the state immediately before displaying the frame image 93. Accordingly, the control unit 130 can allow the user to read the electronic book by deleting the frame image 93 from the display surface of the display apparatus 25 and switching the book page images to be displayed again and the like.

By the way, if display of the index screen is requested by the user via the remote control 27 in the state in which the book cover image, the book page image 47, and the like are output via the display apparatus 25, the control unit 130 produces the index screen data in the same manner as described above.

Then, when the index screen is displayed on the display surface of the display apparatus 25, and a new electronic book is selected, the control unit 130 displays the book cover image of the selected electronic book on the display surface of the display apparatus 25 in the same manner as described above.

In addition, the control unit 130 displays the book page image, the enlargement target area, and the like of the selected electronic book on the display surface of the display apparatus 25 in response to the operation of the remote control 27 by the user in the same manner as described above after displaying the book cover image on the display surface of the display apparatus 25.

On the other hand, if completion of the display of the electronic book is instructed by the user via the remote control 27 in the state in which the book cover image, the book page image 47, and the like are output via the display apparatus 25, the control unit 130 completes the electronic book reproducing processing in response to this.

That is, the control unit 130 stops the output of the book cover image, the book page image, and the movie and the like associated with the associated part via the display apparatus 25 and completes the reproduction of the electronic book. In so doing, the control unit 130 can allow the user to read one or a plurality of electronic books and watch and view various kinds of information associated with the associated part in the electronic book while the electronic book reproduction processing is executed.

By the way, if the electronic book data D2 and D4 of the electronic book selected on the index screen is not recorded on the book providing disc 28 when the electronic book reproduction processing is started, the control unit 130 is provided with the electronic book from the history obtaining apparatus 22.

That is, if it is detected that the book providing disc 28 in which the electronic book data D2 and D4 is not recorded is mounted on the electronic book reproducing apparatus 24, the control unit 130 reads the user specifying information and the password from the built-in storage unit 140.

In addition, the control unit 130 produces the authentication processing request information storing the user specifying information and the password. Then, the control unit 130 transmits the authentication processing request information to the history obtaining apparatus 22 from the network controller 137 via the network 23.

If the user authentication processing is executed based on the authentication processing request information, the user is authenticated, and the authentication notification information is returned from the history obtaining apparatus 22 as a result, the control unit 130 receives and imports the authentication notification information by the network controller 137.

When it is detected that the user is authenticated based on the authentication notification information, the control unit 130 stores the book specifying information 116 of the electronic book selected on the index screen by the user and produces the electronic book obtaining request information for requesting the obtaining of the electronic book.

Then, the control unit 130 transmits the electronic book obtaining request information to the history obtaining apparatus 22 from the network controller 137 via the network 23. In so doing, when the electronic book data D2 and D4 of the electronic book selected by the user is returned from the history obtaining apparatus 22, the control unit 130 receives and imports the electronic book data D2 and D4 by the network controller 137,

In so doing, when the electronic book data D2 and D4 is obtained from the history obtaining apparatus 22, the control unit 130 reads the electronic book certificate and the route certificate from the book providing disc 28 via the switcher 141 and the drive 142 in this order.

In addition, the control unit 130 calculates the data verification value with the use of at least a part of the electronic book data D2 and D4 obtained from the history obtaining apparatus 22. Moreover, the control unit 130 calculates the certificate verification value with the use of at least a part of the route certificate.

Then, the control unit 130 checks the validity of the electronic book data D2 and D4 (that is, whether the data has been falsified) obtained from the history obtaining apparatus 22 at this time based on the electronic book certificate, the calculated data verification value, and the certificate verification value. If it is confirmed that the electronic book data D2 and D4 is valid as a result, the control unit sends the book cover image data included in the electronic book data D2 and D4 to the graphic engine 138.

When the book over image data is given from the control unit 130, the graphic engine 138 performs processing in the same manner as described above and displays the book cover image over the entire surface of the display surface of the display apparatus 25 via the video output unit 139.

As described above, even when the electronic book data D2 and D4 are obtained from the history obtaining apparatus 22, the control unit 130 displays the book page image, the enlargement target area, and the like on the display surface of the display apparatus 25 in response to the operation of the remote control 27 by the user in the same manner as described above after this.

Then, when display of the index screen is requested by the user via the remote control 27 in the state in which the book cover image, the book page image 47, and the like are output via the display apparatus 25, the control unit 130 produces the index screen data in the same manner as described above.

When the index screen is displayed on the display surface of the display apparatus 25, and a new electronic book is selected at this time, the control unit 130 obtains the electronic book data D2 and D4 of the selected electronic book from the history obtaining apparatus 22 in the same manner as described above.

Accordingly, the control unit 130 performs the processing again in the same manner as described above and displays the book cover image, the book page image, the enlargement target area, and the like of the new electronic book on the display surface of the display apparatus 25. Even in such a case, if the completion of the display of the electronic book is instructed by the user via the remote control 27 in the state in which the book cover image, the book page image 47, and the like are output via the display apparatus 25, the control unit 130 completes the electronic book reproduction processing in response to this.

As described above, the control unit 130 can allow the user to read one or a plurality of electronic books even when the electronic book reproduction processing is executed in the state in which the book providing disc 28 in which the electronic data D2 and D4 is not recorded is mounted on the electronic book reproducing apparatus 24. In addition, the control unit 130 can allow the user to watch and view various kinds of information associated with the associated part in the electronic book in the same manner as described above.

By the way, when obtaining of the electronic book introducing screen data for introducing the electronic book to be provided on the network 23 is requested by the user via the remote control 27, the control unit 130 reads the user specifying information and the password from the built-in storage unit 140.

In addition, the control unit 130 produces the authentication processing request information storing the usr specifying information and the password. Then, the control unit 130 transmits the authentication request information to the history obtaining apparatus 22 from the network controller 137 via the network 23.

If the user authentication processing is executed based on the authentication processing request information, the user is authenticated, and the authentication notification information is returned from the history obtaining apparatus 22 as a result, the control unit 130 receives and imports the authentication notification information by the network controller 137.

When it is detected that the user has been authenticated based on the authentication notification information, the control unit 130 produces the introducing screen obtaining request information for requesting the obtaining of the electronic book introducing screen data. Then, the control unit 130 transmits the introducing screen obtaining request information to the history obtaining apparatus 22 from the network controller 137 via the network 23.

When the electronic book introducing screen data is returned from the history obtaining apparatus 22 as a result, the control unit 130 receives and imports the electronic book introducing screen data by the network controller 137. In addition, the control unit 130 sends the electronic book introducing screen data to the display apparatus 25 via the graphic engine 138 and the video output unit 139 in this order. In so doing, the control unit 130 displays the electronic book introducing screen (not shown) based on the electronic book introducing screen data on the display surface of the display apparatus 25.

In addition, book titles, book issue dates, book types, categories, and the like of the electronic books which can be provided by the history obtaining apparatus 22 are displayed on the electronic book introducing screen. In addition, the book specifying information 116 of the electronic books are embedded so as to correspond to the book titles of the electronic books displayed on the electronic book introducing screen in the electronic book introducing screen data.

If one or a plurality of desired electronic books are selected as the book titles on the electronic book introducing screen by the user via the remote control 27 in this state, the control unit 130 extracts the book specifying information 116 of each selected electronic book from the electronic book introducing screen data.

Moreover, the control unit 130 stores one or a plurality of book specifying information items 116 extracted from the electronic book introducing screen data along with the user specifying information and the password and produces electronic book purchasing request information for requesting the purchase of one or a plurality of electronic books selected by the user.

Then, the control unit 130 transmits the electronic book purchasing request information to the history obtaining apparatus 22 from the network controller 137 via the network 23. If the electronic book data D2 and D4 of one or a plurality of electronic book data is returned after performing purchasing processing of one or a plurality of electronic books whose purchase is requested from the history obtaining apparatus 22 as a result, the control unit 130 receives and imports them by the network controller 137.

In addition, the control unit 130 also receives and imports the electronic book reproducing program and the index table returned along with one or a plurality of electronic book data items D2 and D4 from the history obtaining apparatus 22 at this time by the network controller 137.

Moreover, the control unit 130 also receives and imports the decoding key information, the electronic book certificate, and the route certificate returned along with one or a plurality of electronic book data items D2 and P4 from the history obtaining apparatus 22 at this time by the network controller 137.

Then, the control unit 130 sends one or a plurality of electronic book data items D2 and D4, the electronic book reproducing program, the index table, the decoding key information, the electronic book certificate, and the route certificate to the hard disk drive 152 via the switcher 141.

In so doing, the control unit 130 associates and stores one or a plurality of electronic book data items D2 and D4 purchased at this time with the index table, the decoding key information, the electronic book certificate, and the route information on the hard disk drive 152. In addition, the control unit 130 also stores the electronic book reproducing program on the hard disk drive 152.

If reproduction of the electronic book in the hard disk drive 152 is instructed by the user via the remote control 27 in this state, the control unit 130 reads the electronic book reproducing program from the hard disk drive 152 via the switcher 141.

In addition, the control unit 130 transfers the electronic book reproducing program to the RAM 134 and executes the program thereon. In so doing, the control unit 130 executes the electronic book reproduction processing based on the electronic book reproducing program along with the aforementioned various programs which have been already executed on the RAM 134. In such a case, the control unit 130 reads the index table from the hard disk drive 152 via the switcher 141 and sends the index table to the graphic engine 138.

The graphic engine 138 produces index screen data for list-displaying the book titles of all (one or a plurality of) electronic books to be provided via the book providing disc 28 based on the index table given from the control unit 130.

In addition, the graphic engine 138 sends the index screen data to the display apparatus 25 via the video output unit 139 and displays the index screen (not shown) based on the index screen data on the display surface of the display apparatus 25.

In so doing, the control unit 130 notifies the user of the electronic books to be provided by the book providing disc 28 mounted on the electronic book reproducing apparatus 24 at this time as the book titles via the index screen displayed on the display surface of the display apparatus 25.

Then, when the index screen is displayed on the display surface of the display apparatus 25 as described above, the control unit 130 can allow the user to select the electronic book to be displayed as the book title on the index screen via the remote control 27 in the same manner as described above.

When the electronic book is selected on the index screen, the control unit 130 reads the electronic book data D2 and D4 of the selected electronic book from the hard disk drive 152 via the switcher 141.

In addition, the control unit 130 reads the electronic book certificate and the route certificate from the hard disk drive 152 via the switcher 141. Moreover, the control unit 130 calculates the data verification value with the use of at least a part of the electronic book data D2 and D4 read from the hard disk drive 152. Furthermore, the control unit 130 also calculates the certificate verification value with the use of at least a part of the route certificate.

Then, the control unit 130 checks the validity of the electronic book data D2 and D4 (that is, whether the data has been falsified) read from the book providing disc 28 at this time based on the electronic book certificate, the calculated data verification value, and the certificate verification value if it is confirmed that the electronic book data D2 and D4 is valid as a result, the control unit 130 sends the book cover image data included in the electronic book data D2 and D4 to the graphic engine 138.

When the book cover image data is given from the control unit 130, the graphic engine 138 performs processing in the same manner as described above and displays the book cover image over the entire surface of the display screen of the display apparatus 25 via the video output unit 139.

In so doing, the control unit 130 displays the book page image, the enlargement target area, and the like on the display surface of the display apparatus 25 in response to the operation of the remote control 27 by the user in the same manner as described above after this even when the electronic book data D2 and D4 is purchased from the history obtaining apparatus 22.

In addition, if the display of the index screen is requested by the user via the remote control 27 in the state in which the book cover image, the book page image 47, and the like are output via the display apparatus 25, the control unit 130 produces the index screen data again in the same manner as described above.

If the index screen is displayed on the display surface of the display apparatus 25, and a new electronic book is selected at this time, the control unit 130 reads the electronic book data D2 and D4 of the selected electronic book from the hard disk drive 152 in the same manner as described above.

Accordingly, the control unit 130 performs processing again in the same manner as described above and displays the book cover image, the book page image, the enlargement target area, and the like of the new electronic book on the display surface of the display apparatus 25. Even in such a case, if completion of the display of the electronic book is instructed by the user via the remote control 27 in the state in which the book cover image, the book page image 47, and the like are output via the display apparatus 25, the control unit 130 completes the electronic book reproduction processing in response to this.

As described above, the control unit 130 reproduces the electronic book data D2 and D4 with the use of the hard disc drive 152 instead of the book providing disc 28 when the electronic book data D2 and D4 are purchased from the history obtaining apparatus 22.

However, the control unit 130 basically executes the same electronic book reproduction processing as that in the case of using the book providing disc 28 even when the hard disk drive 152 is used instead of the book providing disc 28 and reproduces the electronic book data D2 and D4.

Accordingly, the control unit 130 can allow the user to read one or a plurality of electronic books in the same manner as in the case of using the book providing disc 28 even when the electronic book data D2 and D4 are reproduced with the use of the hard disk drive 152. In addition, the control unit 130 can also allow the user to watch and view various kinds of information associated with the associated part in the electronic book.

By the way, the control unit 130 extracts the book specifying information 116 of the electronic book from the book information 65 when the display of the book cover image on the display surface of the display apparatus 25 is started in response to the selection of the electronic book while the electronic hook reproduction processing is executed. In addition, the control unit 130 checks the current time by a time which is not shown in the drawing and detects the time at the time point at which the display of the book cover image is started.

Moreover, the control unit 130 makes a correspondence relationship between the book specifying information 116 extracted from the book information 65 and the time information indicating the time at the display start time point of the detected book cover image as a display history of the electronic book displayed in response to the user operation. Then, the control unit 130 sends and stores the display history to the built-in storage unit 140.

In addition, when the display of the book page image 47 on the display surface of the display apparatus 25 is started in response to the page sending instruction, the control unit 130 extracts the page number 86 of the book page image 47 from the page information 85.

Moreover, the control unit 130 detects the time at the time point at which the display of the book page image 47 is started based on the current time shown by the timer. Then, the control unit 130 associates and sends the page number 86 extracted from the page information 85 with the time information indicating the time at the display start time point of the detected book page image 47 to the built-in storage unit 140.

In so doing, the control unit 130 stores the associated page number 86 and the time information to be added to the display history in the built-in storage unit 140 and updates the display history in the built-in storage unit 140.

Moreover, when the enlargement target area 92 is enlarged and displayed as the area enlargement image 150 on the display surface of the display apparatus 25 in response to the designation of the enlargement target area 92, the control unit 130 extracts the area specifying information 101 of the enlargement target area 92 from the area information 100.

In addition, the control unit 130 detects the time at the time point at which the enlargement and display of the enlargement target area 92 is started based on the current time shown by the timer. Then, the control unit 130 associates and sends the area specifying information 101 extracted from the area information 100 with the time information indication the time at the enlargement and display start time point of the detected enlargement target area 92 to the built-in storage unit 140.

In so doing, the control unit 130 stores the associated area specifying information 101 and the time information to be added to the display history in the built-in storage unit 140 and updates the display history in the built-in storage unit 140.

As described above, the control unit 130 updates the display history such that the book specifying information 116, the page number 86, and the area specifying information 101 are stored on the built-in storage unit 140 along with the time information every time the book cover image, the book page image 47, and the area enlargement image 150.

Then, the control unit 130 detects the time at the time point at which the reproduction of the electronic book is completed based on the current time shown by the time when the reproduction of the electronic book is completed in response to the instruction by the user.

In addition, the control unit 130 sends the time information indicating the time at the reproduction completion time point of the detected electronic book to the built-in storage unit 140. In so doing, the control unit 130 stores the time information at the reproduction completion time point of the electronic book so as to be added to the display history which has been already stored in the built-in storage unit 140 and finally updates the display history in the built-in storage unit 140.

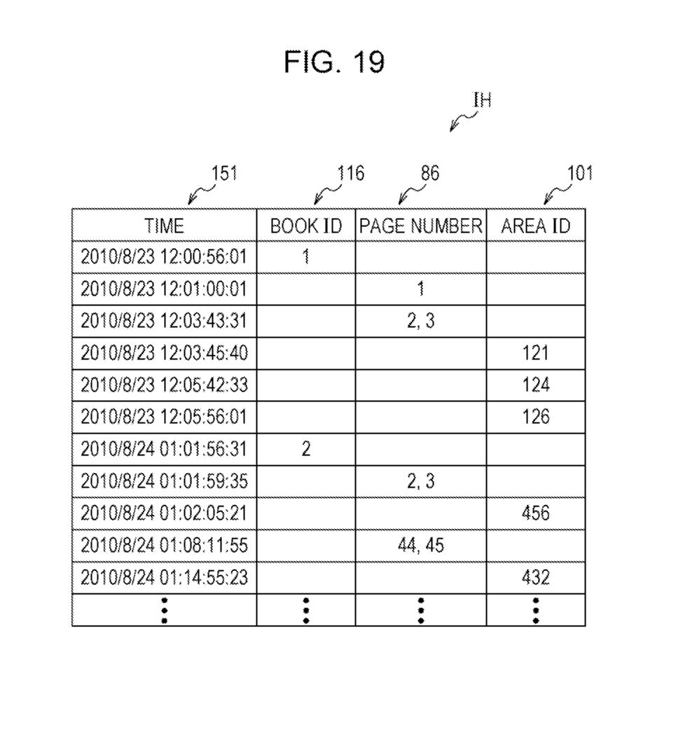

As described above, the control unit 130 produces the display history IH in which the book specifying information 116, the page number 86, and the area specifying information 101 are arranged in a time-series manner along with the time information 151 in the built-in storage unit 140 while the electronic book reproduction processing is executed as shown in FIG. 19.

That is, the control unit 130 produces the display history IH specifically showing the electronic book whose display is started in response to the user operation and the book page image 47 and the enlargement target area 92, which have been actually displayed, in the electronic book, while the electronic book reproduction processing is executed.

When the production of the display history IH in the built-in storage unit 140 is completed in accordance with the completion of the reproduction of the electronic book, the control unit 130 reads the display history IH, whose production is completed, from the built-in storage unit 140. In addition, the control unit 130 also reads the user specifying information and the password from the built-in storage unit 140.

Furthermore, the control unit 130 stores the user specifying information and the password and produces the authentication processing request information for requesting the user authentication processing. Then, the control unit 130 transmits the authentication processing request information to the history obtaining apparatus 22 from the network controller 137 via the network 23.

If the usr authentication processing is executed based on the authentication processing request information, the user is authenticated, and the authentication notification information is returned from the history obtaining apparatus 22 as a result, the control unit 130 receives and imports the authentication notification information by the network controller 137. When it is detected that the user is authenticated based on the authentication notification information, the control unit 130 produces the display history notification data storing the user specifying information and the password along with the display history IH.

Then, the control unit 130 transmits the display history notification data to the history obtaining apparatus 22 from the network controller 137 via the network 23. In so doing, the control unit 130 can notify the history obtaining apparatus 22 of the book page image 47 and the enlargement target area 92 of the electronic book read by the user by the display history IH stored on the display history notification data.

### [1-4-2. Configuration of Program Module Mounted on Electronic Book Reproducing Apparatus 24]

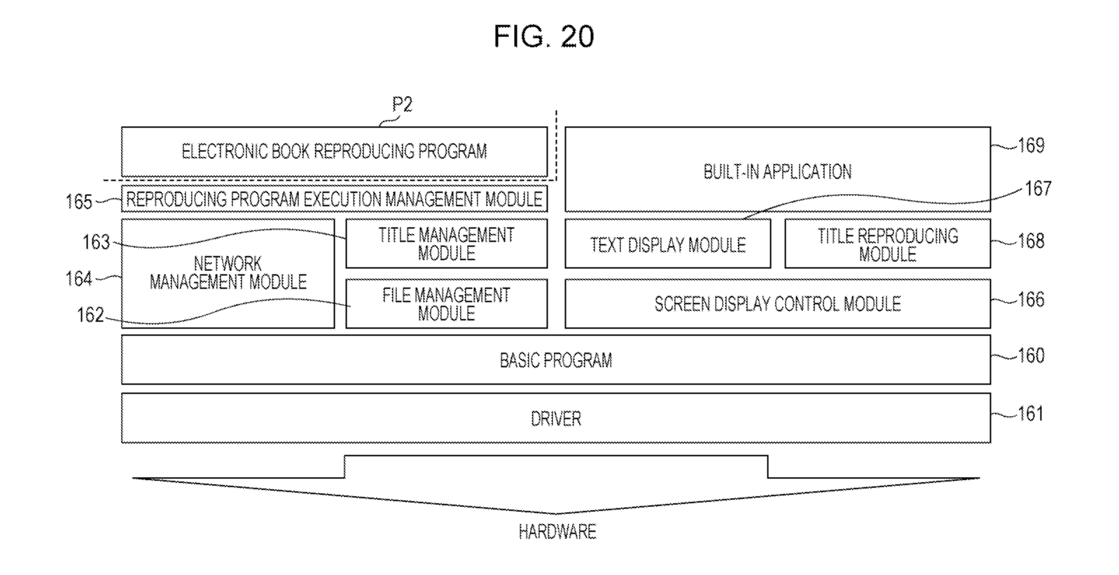

Next, description will be made of various program modules as the aforementioned various programs mounted on a non-transitory computer-readable medium within the electronic book reproducing apparatus 24 (for example, stored in advance on the ROM 131) with the use of FIG. 20.

The various program modules mounted on the electronic book reproducing apparatus 24 are configured to be operated on a basic program 160 such as an operation system. In addition, the basic program 160 manages the resources of various program modules in the higher order. In addition, the basic program 160 also manages input and output of the hardware in the electronic book reproducing apparatus 24 via the driver 161.

The file management module 162 which manages a data file existing on the basic program 160 is positioned in the higher order of the basic program 160. In addition, a title management module 163 which manages the electronic book data D2 and D4 stored on the book providing disc 28 and the electronic book data D2 and D4 stored on the hard disk drive 152 is positioned in the higher order of the file management module 162. In addition, the title management module 163 is for operating the data file existing on the basic program 160 via the file management module 162.

Moreover, a network management module 164 which performs the control at the time of using the network 23 is positioned in the higher order of the basic program 160. In addition, a reproducing program execution management module 165 is positioned in the higher order of the title management module 163 and the network management module 164.

The reproducing program execution module 165 is provided by the book providing disc 28 and manages the communication between the electronic book reproducing program P2 provided by the history obtaining apparatus 22 and the other program modules mounted on the electronic book reproducing apparatus 24.

Furthermore, a screen display control module 166 is positioned in the higher order of the basic program 160, and a text module display module 167 and a title reproduction module 168 which controls the reproduction of the electronic book data D2 and D4 are positioned in the higher order of the screen display control module 165. Furthermore, a built-in application 169 is positioned in the higher order of the text display module 167 and the title reproduction module 158.

The built-in application 169 provides a graphic user interface to the electronic book reproducing apparatus 24. In addition, the text display module 167 instructs the drawing of book cover image, the book page image, and the like of the selected electronic book via the graphic user interface provided by the built-in application 169.

In addition, the screen display control module 166 decides how to draw the book cover image, the book page image, and the like based on the instruction of the text display module 167 and performs drawing as decided.

In addition, when the book providing disc 28 is a BD, for example, in this embodiment, a BD-Java (registered trademark) program is recorded on the book providing disc 28 as the electronic book reproducing program 92.

In addition, when the electronic book data D2 and D4 recorded on the book providing disc 28, which is a BD, is reproduced in the electronic book reproducing apparatus 24, Java Virtual Machine (Java (registered trademark) VM) (registered trademark) is used as the reproducing program execution management module 165.

### 1-5. Circuit Configuration of History Obtaining Apparatus 22

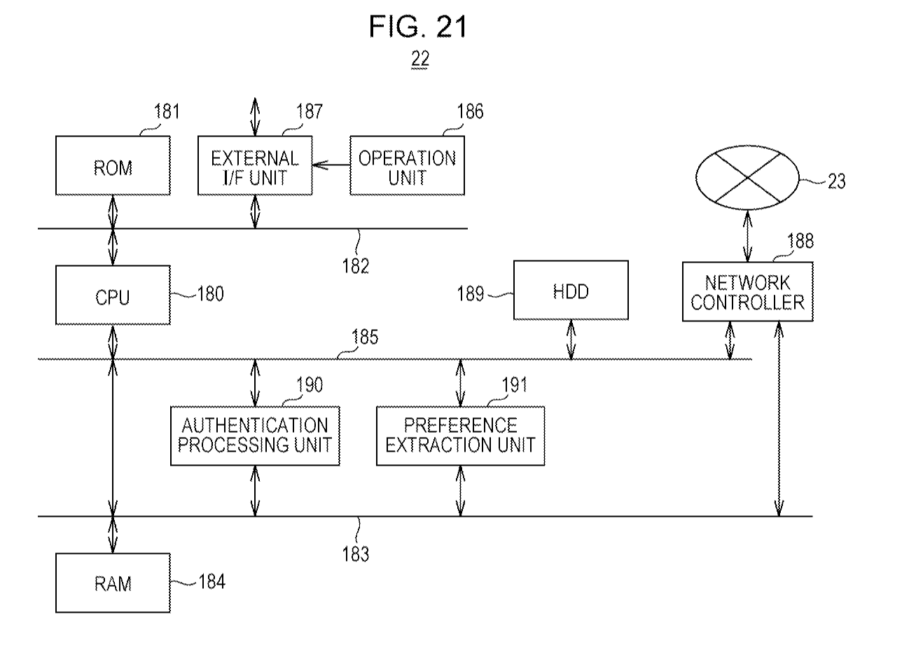

Next, description will be made of the circuit configuration of the history obtaining apparatus 22 with the use of FIG. 21. The history obtaining apparatus 22 includes a control unit 180 constituted by a CPU. The control unit 180 reads various programs such as a basic program, a history obtaining program, and the like which are stored in advance in a non-transitory computer readable medium such as the ROM 181, for example, via the input output bus 182.

In addition, the control unit 180 transfers the various programs to the RAM 184 as a work area of the control unit 180 via the memory bus 183 and executes the programs thereon. Then, the control unit 180 controls the entire apparatus via the input output bus 182 and the system bus 185 based on the various programs executed on the RAM 184. In addition, the control unit 180 executes predetermined computation processing based on the various programs.

Moreover, the control unit 180 also executes various kinds of processing in response to an operation command given from the operation unit 186 via the external interface unit 187 and the input output bus 182 in this order in response to the operation of the operation unit 186 constituted by a keyboard, a mouse, or the like based on the various programs.

In so doing, when user registration screen request information is transmitted from the electronic book reproducing apparatus 24 via the network 23, the control unit 180 receives and imports the user registration screen request information by the network controller 188.

When the user registration screen request information is imported as described above, the control unit 180 reads user registration screen data stored in advance from the hard disk drive 189. Then, the control unit 180 transmits the user registration screen data to the electronic book reproducing apparatus 24 from the network controller 188 via the network 23.

When user information input on the user registration screen is transmitted from the electronic book reproducing apparatus 24 via the network 23 as a result, the control unit 180 receives and imports the user information by the network controller 188.

Here, the control unit 180 constitutes database for registering a user in the hard disk drive 189. In addition, the database for registering a user will also be referred to as user database in the following description.

Accordingly, the control unit 180 sends the user information to the and disk drive 189 at this time. In so doing, the control unit 189 stores the user information on the hard disk drive 180 and registers the user information in the user database.

When the user information is registered in the user database, and the user registration for a user of the electronic book reproducing apparatus 24 is completed as described above, the control unit 180 reads user registration completion notification screen data stored in advance from the hard disk drive 189.

Then, the control unit 180 transmits the user registration completion notification screen data to the electronic book reproducing apparatus 24 from the network controller 188 via the network 23. In so doing, the control unit 180 notifies the user of the electronic book reproducing apparatus 24 of that the user registration has been completed.

In addition, when authentication processing request information is transmitted from the electronic book reproducing apparatus 24 via the network 23, the control unit 180 sends the authentication processing request information to the authentication processing unit 190 after receiving and importing the authentication processing request information by the network controller 188.

At this time, the authentication processing unit 190 extracts the use specifying information and the password from the authentication processing request information and executes user authentication processing based on the user specifying information and the password. In such a case, the authentication processing unit 190 detects whether or not the usr specifying information and the password extracted from the authentication processing request information have already been registered in the user database of the hard disk drive 189.

If the user specifying information and the password extracted from the authentication processing request information has already been registered in the user database as a result, the authentication processing unit 190 authenticates the user of the electronic book reproducing apparatus 24, who has accessed the history obtaining apparatus 22 at this time, as a normal user. Then, when the user is authenticated as described above, the authentication processing unit 190 notifies the control unit 180 of this.

When the control unit 180 is notified by the authentication processing unit 190 of that the user has been authenticated, the control unit 180 transmits authentication notification information for notifying of that the user has been authenticated to the electronic book reproducing apparatus 24 from the network controller 188 via the network 23. In so doing, the control unit notifies the electronic book reproducing apparatus 24 of that the user has been authenticated.

On the other hand, if the user specifying information and the password extracted from the authentication processing request information have not been registered in the user database, the authentication processing unit 190 does not authenticate the user of the electronic book reproducing apparatus 24, who has accessed the history obtaining apparatus 22 at this time, as a normal user. Then, the authentication processing unit 190 notifies the control unit 180 of that the user is not authenticated.

If the control unit 180 is notified by the authentication processing unit 190 of that the user is not authenticated, the control unit 180 transmits authentication error information for notifying of that the user is not authenticated to the electronic book reproducing apparatus 24 from the network controller 188 via the network 23. In so doing, the control unit 180 notifies the electronic book reproducing apparatus 24 that the user is not authenticated.

By the way, when disc registration screen request information is transmitted from the electronic book reproducing apparatus 24 as a result of transmitting the authentication notification information to the electronic book reproducing apparatus 24, the control unit 180 receives and imports the disc registration screen request information by the network controller 188.

When the disc registration screen request information is imported as described above, the control unit 180 reads disc registration screen data stored in advance from the hard disk drive 189 in response to this. Then, the control unit 180 transmits the disc registration screen data to the electronic book reproducing apparatus 24 from the network controller 188 via the network 23.

When disc registration request information in which the disc information input on the disc registration screen is stored is transmitted from the electronic book reproducing apparatus 24 as a result, the control unit 180 receives and imports the disc registration request information by the network controller 188.

At this time, the control unit 180 extracts the user specifying information and the password from the disc registration request information along with the disc information. In addition, the control unit 180 specifies the user information including the user specifying information and the password in the user database of the hard disk drive 189 based on the user specifying information and the password.

Then, the control unit 180 sends the disc information to the hard disk drive 189. In so doing, the control unit 180 stores the disc information on the hard disk drive 189 and associates and registered the disc information with the specified user information in the user database.

When the disc information is registered as described above, the control unit 180 reads disc registration completion notification screen data stored in advance from the hard disk drive 189. Then, the control unit 180 transmits the disc registration completion notification screen data to the electronic book reproducing apparatus 24 from the network controller 188 via the network 23. In so doing, the control unit 180 notifies the user of the electronic book reproducing apparatus 24 of that the disc registration has been completed.

By the way, when the electronic book data D2 and D4 is transmitted from the electronic book reproducing apparatus 21 via the network 23 along with the specification request information, the control unit 180 receives and imports the electronic book data D2 and D4 and the specification request information by the network controller 188.

At this time, the book specifying information 116 with which the electronic book which is received at this time and is based on the electronic book D2 and D4 is issued in accordance with the control unit 180 and the specification request information. Then, the control unit 180 transmits the book specifying information 116 to the electronic book producing apparatus 21 from the network controller 188 via the network 23.

Here, the control unit 180 constitutes a database for registering the electronic book (that is, for registering the electronic book data D2 and D4 produced in the electronic book producing apparatus 21) in the hard disk drive 189. In addition, the database for registering the electronic book will also be referred to as a book database in the following description.

Accordingly, the control unit 180 stores the issued book specifying information 116 on the book information 65 included in the electronic book data D2 and D4 received at this time. Then, the control unit 180 sends the book information 65 storing the book specifying information 116 to the hard disk drive 189 along with the book specifying information 116.

In so doing, the control unit 180 stores the book information 55 and the book specifying information 116 on the hard disk drive 189 and associates and registers the book information 65 with the book specifying information 116 in the book database.

In addition, the control unit 180 sends the page information 85 included in the electronic book data D2 and D4 received at this time to the hard disk drive 189. In so doing, the control unit 180 stores the page information 85 on the hard disk drive 189 and associates and registers the page information 85 with the book specifying information 115 in the book database.

Moreover, the control unit 180 sends the area information 100 included in the electronic book data D2 and D4 received at this time to the hard disk drive 189. In so doing, the control unit 180 stores the area information 100 on the hard disk drive 189 and associates and registers the area information 100 with the book specifying information 116 in the book database.

Then, when the electronic book data D2 and D4 is designated as a provision target using the network 23 by the operator via the operation unit 186, the control unit 180 sends the book image data D6 included in the electronic book data D2 and D4 to the hard disk drive 189.

In addition, the control unit 180 also sends the coded associated data D7 and the coded audio data D8 included in the electronic book data D2 and D4 to the hard disk drive 189. In so doing, the control unit 180 stores the book image data D6 on the hard disk drive 189 and associates and registers the book image data D6 with the book specifying information 116 in the book database.

In addition, the control unit 180 stores the coded associated data D7 and the coded audio data D8 on the hard disk drive 189 and associates and registers the coded associated data D7 and the coded audio data D8 with the book specifying information 116 in the book database.

On the other hand, if the operator instructs to exclude the electronic book data D2 and D4 from the provision target using the network 23 via the operation unit 186, the control unit 180 discards the book image data D6 included in the electronic book data D2 and D4. In addition, the control unit 180 also discards the coded associated data D7 and the coded audio data D8 included in the electronic book data D2 and D4.

That is, if the provision of an electronic book, which is produced based on a publication, with the use of the network 23 is permitted by a publisher of the publication, for example, the control unit 180 registers the entire electronic book data D2 and D4 of the electronic book in the book database.

In so doing, the control unit 180 maintains and manages the electronic book data D2 and D4 for the electronic book whose provision with the use of the network 23 is permitted and makes it possible to provide the electronic book with the use of the network 23.

On the other hand, if the provision of the electronic book with the use of the network 23 is not permitted by the publisher, the control unit 180 registers only the book information 65, the page information 85, and the area information 100 included in the electronic book data D2 and D4 of the electronic book.

Then, the control unit 180 discards the book image data D6, the coded associated data D7, and the coded audio data D8 included in the electronic book data D2 and D4. In so doing, the control unit 180 makes it impossible to provide the electronic book whose provision with the use of the network 23 is not permitted in practice by discarding the book image data D6 while managing the data by the book database.

By the way, the control unit 180 receives and imports the authentication processing request information, which provides the electronic book and the associated page images to the electronic book reproducing apparatus 24 and has been firstly transmitted from the electronic book reproducing apparatus 24 via the network 23, by the network controller 188.

When the authentication processing request information is imported as described above, the control unit 180 sends the authentication processing request information to the authentication processing unit 190 and causes the authentication processing unit 190 to execute the same user authentication processing as that described above. In addition, the control unit 180 transmits the authentication notification information or the authentication error information to the electronic book reproducing apparatus 24 from the network controller 188 via the network 23 in accordance with the execution result of the user authentication processing by the authentication processing unit 190.

Then, when the authentication notification information is transmitted to the electronic book reproducing apparatus 24, the control unit 180 sequentially receives the obtaining and the purchasing of the electronic book and requests for the associated page images from the electronic book reproducing apparatus 24.

When the electronic book obtaining request information is actually transmitted from the electronic book reproducing apparatus 24, which has received the authentication notification information, via the network 23, the control unit 180 receives and imports the electronic book request information by the network controller 188.

At this time, the control unit 180 extracts from the electronic book obtaining request information the book specifying information 116 for one or a plurality of electronic books selected on the index screen by the user in the electronic book reproducing apparatus 24.

Then, the control unit 180 reads the book information 65 associated with the book specifying information 116, the page information 85, and the area information 100 from the hard disk drive 189 based on the book specifying information 116 extracted from the electronic book obtaining request information.

In addition, the control unit 180 also reads the book image data D6 associated with the book specifying information 116 from the hard disk drive 189 based on the book specifying information 116 extracted from the electronic book obtaining request information.

Moreover, the control unit 180 also reads the coded associated data D7 and the coded audio data D8 associated with the book specifying information 116 from the hard disk drive 189 based on the book specifying information 116 extracted from the electronic book obtaining request information.

Then, the control unit 180 organizes the book information 65, the page information 85, the area information 100, the book image data D6, the coded associated data D7, and the coded audio data D8, which are read from the hard disk drive 189, to produce the electronic book data D2 and D4.

As described above, the control unit 180 produces the electronic book data D2 and D4 for each of one or a plurality of electronic books selected by the user in the electronic book reproducing apparatus 24. Then, the control unit 180 transmits one or a plurality of produced electronic book data items D2 and D4 to the electronic book reproducing apparatus 24 from the network controller 188 via the network 23.

In so doing, when the electronic book data D2 and D4 are reproduced with the use of the book providing disc 28 in which the electronic book data D2 and D4 are not recorder, the control unit 180 can provide the electronic book data D2 and D4 to the electronic book reproducing apparatus 24.

In addition, when the introducing screen obtaining request information is transmitted from the electronic book reproducing apparatus 24, which has received the authentication notification information, via the network 23, the control unit 180 receives and imports the introducing screen obtaining request information by the network controller 188.

At this time, the control unit 180 reads from the hard disk drive 189 the electronic book introducing screen data stored thereon. In addition, the control unit 180 transmits the electronic book introducing screen data to the electronic book reproducing apparatus 24 from the network controller 188 via the network 23. In so doing, the control unit 180 can introduce the electronic books to be provided on the network 23, via the electronic book introducing screen in the electronic book reproducing apparatus 24 to the user.

Then, if the electronic book purchasing request information is continuously transmitted from the electronic book reproducing apparatus 24, which has received the electronic book introducing screen data, via the network 23, the control unit 180 receives and imports the electronic book purchasing request information by the network controller 188.

At this time, the control unit 180 extracts the book specifying information 116 for one or a plurality of electronic books selected by the user to be purchased on the electronic book introducing screen in the electronic book reproducing apparatus 24, from the electronic book purchasing request information. In addition, the control unit 180 also extracts the user specifying information and the password from the electronic book purchasing request information.

Then, the control unit 180 firstly executes purchasing processing of the electronic book, whose purchasing has been requested, for the user. In such a case, the control unit 180 specifies the user information including the user specifying information and the password from the hard disk drive 189 based on the user specifying information and the password.

In addition, the control unit 180 reads the user's name and the credit card number, for example, included in the user information from the hard disk drive 189. Moreover, the control unit 180 produces charging data for electronically making settlement of the charge of the electronic book, whose purchasing has been requested by the user, based on the name, the credit card number, and one or a plurality of book specifying information items extracted from the electronic book purchasing request information. Then, the control unit 180 transmits the charging data to the settlement server 26 from the network controller 188 via the network 23.

In so doing, when the purchasing of the electronic book is requested by the user, the control unit 180 allows the user to electronically make settlement to pay the charge of the electronic book by the settlement server 26 by executing the purchasing processing.

When the purchasing processing is completed, the control unit 180 reads the book information 65 associated with the book specifying information 116, the page information 85, and the area information 100 from the hard disk drive 189 based on the book specifying information 116 extracted from the electronic book obtaining request information.

In addition, the control unit 180 also reads the book image data D6 associated with the book specifying information 116 from the hard disk drive 189 based on the book specifying information 115 extracted from the electronic book obtaining request information.

Moreover, the control unit 180 also reads the coded associated data D7 and the coded audio data D8 associated with the book specifying information 116 from the hard disk drive 189 based on the book specifying information 116 extracted from the electronic book obtaining request information.

Then, the control unit 180 organizes the book information 65, the page information 85, the area information 100, the book image data D6, the coded associated data D7, and the coded audio data D8, which are read from the hard disk drive 189, to produce the electronic book data D2 and D4. In so doing, the control unit 180 produces the electronic book data D2 and D4 for each of one or a plurality of electronic books selected by the user to be purchased in the electronic book reproducing apparatus 24.

In addition to this, when one or a plurality of electronic book data D2 and D4 are produced, the control unit 180 reads the electronic book reproducing program, which is stored in advance for reproducing the electronic book data D2 and D4, from the hard disk drive 189.

In addition, the control unit 180 reads the decoding key information which has been previously obtained from the electronic book producing apparatus 21 and stored on the hard disk drive 189 for decoding the coded associated data D7 and the coded audio data D8, for example.

Moreover, the control unit 180 reads the route certificate, which is stored in advance, from the hard disk drive 189. Then, the control unit 180 produces the electronic book certificate with the use of the electronic book data D2 and D4 along with the route certificate by the same method as the aforementioned method by the electronic book producing apparatus 21.

Furthermore, the control unit 180 produces an index table as a list of the book titles of one or a plurality of produced electronic book data items D2 and D4. Then, the control unit 180 transmits one or a plurality of produced electronic book data items D2 and D4 to the electronic book reproducing apparatus 24 from the network controller 188 via the network 23 along with the electronic book reproducing program and the index table.

The control unit 180 also sends the decoding key information, the electronic book certificate, and the route certificate to the electronic book reproducing apparatus 24 from the network controller 188 via the network 23 at this time. In so doing, when the purchasing of one or a plurality of electronic books is requested, the control unit 180 can provide the electronic book data D2 and D4 for one of a plurality of electronic books to the electronic book reproducing apparatus 24.

Moreover, when the image request information is transmitted from the electronic book reproducing apparatus 24, which has received the authentication notification information, via the network 23, the control unit 180 receives and imports the image request information by the network controller 188.

At this time, the control unit 180 extracts the associated book title and the associated page number corresponding to the associated part designated by the user in the electronic book reproducing apparatus 24, from the image request information. In addition, the control unit 180 reads the book page image data to which the associated page number is added from among a plurality of book page image data items for the electronic book with the associated book title from the hard disk drive 189 based on the associated book title and the associated page number.

Then, the control unit 180 transmits the book page image data to the electronic book reproducing apparatus 24 from the network controller 188 via the network 23. In so doing, when an associated part associated with another associated page image is designated on the book page image, the control unit 180 provides the book page image data for the associated page image to the electronic book reproducing apparatus 24.

Moreover, when history notification data is transmitted from the electronic book reproducing apparatus 24, which has received the authentication notification information, via the network 23, the control unit 180 receives and imports the history notification data by the network controller 188.

At this time, the control unit 180 extracts the user specifying information and the password from the history notification data along with the display history IH. In addition, the control unit 180 specifies the user information including the user specifying information and the password in the user database of the hard disk drive 139 based on the user specifying information and the password.

Then, the control unit 180 sends the display history IH to the hard disk drive 189. In so doing, the control unit 180 stores the display history IH on the hard disk drive 189 and associates and registers the display history IH with the specified user information in the user database.

Here, the page number 86 of the book page image 47 displayed in the electronic book reproducing apparatus 24 is included in the display history IH, and the book specifying information 116 of the electronic book including the book page image 47 is also stored thereon. Therefore, the control unit 180 can determine the book page image 47 including the articles and the like read by the user in the electronic book reproducing apparatus 24 based on the display history IH.

In addition, the book page image data to which the page number 86 is added is associated with the book specifying information 116 as described above and registered in the book database of the hard disk drive 189.

Accordingly, the control unit 180 can easily specify the contents of the book page image, which has been actually displayed, as the book page image data along with the electronic book selected to be displayed in the electronic book reproducing apparatus 24 with the use of the book database based on the display history IH.

By the way, when the book page image 47 is displayed, the enlargement target area 92 is made to be purposely designated in the book page image 47 to be enlarged and displayed. That is, the enlarged and displayed enlargement target area 92 is designated for enlargement and display just because the user is interested in the enlargement target area 92. Accordingly, it is considered that the contents of the enlarged and displayed enlargement target area 92 have been substantially surely checked (that is, read) by the user.

In addition, the area specifying information 101 of the enlargement target area 92 enlarged and displayed in the electronic book reproducing apparatus 24 is included in the display history IH, and the book specifying information 116 for the electronic book including the book page image 47 in which the enlargement target area 92 is present is also stored thereon.

Accordingly, the control unit ISO can specifically determine a part, which has been actually read by the user by the electronic book reproducing apparatus 24, in the book page image 47 as the enlargement target area 92 based on the display history IH.

Moreover, the enlargement target image data added to the area specifying information 101 is associated with the book specifying information 116 as described above and registered in the book database of the hard disk drive 189.

Accordingly, the control unit 180 can easily specify the contents of the enlargement target area 92, which has been actually enlarged and displayed by the electronic book reproducing apparatus 24, as the area enlargement image data with the use of the book database based on the display history IH.

In addition, the control unit 180 can allow an advertising company and a manufacturing company of the electronic book to use the book page images and the contents of the enlargement target area in order to manufacture the electronic book advertisement or a new electronic book by providing the book page image data and the area enlargement image data specified as described above to the advertising company and the manufacturing company of the electronic book.

That is, the control unit 180 can specifically determine not only the book page image 47, which is read by the user, in the electronic book but also a part, which has been actually read, in the book page image 47 as the enlargement target area 92 based on the display history IH. Accordingly, the control unit 180 can allow the advertising company and the manufacturing company to more effectively use the display history IH for advertising the electronic book and manufacturing a new electronic book.

By the way, the control unit 180 sends the display history IH to the preference extraction unit 191 at this time. When the display history IH is given from the control unit 180, the preference extraction unit 191 extracts the book specifying information 116, the page number 86, and the area specifying information 101 along with the corresponding time information 151 from the display history IH.

In addition, the preference extraction unit 191 specifies the book information 65 of the electronic book associated with the book specifying information (that is, the book information 65 including the book specifying information 116) in the book database of the hard disk drive 189 based on the book specifying information 116.

in so doing, the preference extraction unit 191 reads the category 72 as specific book attribute information for preference extraction from among the book attribute information included in the specified book information 65 from the hard disk drive 189.

Moreover, the preference extraction unit 191 specifies the page information 85 including the page number 86 from among the page information 85 associated with the book specifying information 116 in the book database of the hard disk drive 189 based on the book specifying information 116 and the page number 86.

In so doing, the preference extraction unit 191 reads the in-page text 88, the keyword 89, and the category 90 as the page attribute information for preference extraction from among the page attribute information included in the specified page information 85 from the hard disk drive 189.

Moreover, the preference extraction unit 191 specifies the area information 100 including the area specifying information 101 from among the area information 100 associated with the book specifying information 116 in the book database of the hard disk drive 189 based on the book specifying information 116 and the area specifying information 101.

In so doing, the preference extraction unit 191 reads the in-page text 105, the keyword 106, and the category 107 as specific area attribute information for preference extraction from among the area attribute information included in the specified area information 100 from the hard disk drive 189.

Then, the preference extraction unit 191 extracts the user preference based on the book attribute information, the page attribute information, and the area attribute information, which are read from the hard disk drive 189, and the time information 151 extracted from the display history IH.

In such a case, the preference extraction unit 191 selects the specific book attribute information for preference extraction read from the hard disk drive 189 to be used as it is for preference extraction since the specific book attribute information for preference extraction is related to the electronic book which the user is interested in and selects to actually read.

In addition, since the enlargement target area 92 is made to be purposely designated in the book page image 47 to be enlarged and displayed when the book page image 47 is displayed as described above, and it is considered that the contents thereof is substantially surely checked by the user when the enlargement target area 92 when the enlargement target area 92 is enlarged and displayed. Therefore, the preference extraction unit 191 selects all specific area attribute information for preference extraction read from the hard disk drive 189 so as to be used as it is for preference extraction.

However, the book page image 47 may be temporarily displayed in response to the instruction of sending and returning of the page for searching for a desired book page image 47, and the articles and the like in the book page image 47 is not actually read in some cases.

Therefore, the preference extraction unit 191 performs subtraction processing with the use of time information 151 at the display start time point of the book page image 47 (that is, corresponding to the page number 86) and the time information 151 indicating the next time after the time indicated by the former time information 151 in a time series manner from among the time information 151.

In so doing, the preference extraction unit 191 calculates the display time of the book page image 47 (that is, the time during which the display is continued) displayed in response to the user operation indicated by the display history IH. In addition, the preference extraction unit 191 compares the calculated display time with a predetermined threshold value which is chosen in advance in order to determine whether or not the articles and the like in the book page image 47 has been read.

The preference extraction unit 191 selects specific page attribute information corresponding to the book page image 47, whose articles and the like have been determined to be read, from among the specific page attribute information read from the hard disk drive 189 based on the comparison result so as to be used for preference extraction.

In addition to this, the preference extraction unit 191 executes natural language processing for the in-area text 105 as the specific area attribute information and the in-page text 88 as the specific page information selected to be used for preference extraction.

In such a case, the preference extraction unit 191 reads morpheme dictionary data and semantic dictionary data stored in advance from the hard disk drive 189. In addition, the morpheme dictionary data is produced by associating a plurality of morphemes of various word classes such as nouns verbs, particles, adverbs, and the like with the reading, the word classes, and the like of the morphemes.

In addition, the morpheme is a minimum unit of a language with a meaning, and some constitute words by themselves, others constitute words in combination with another morpheme, and others do not constitute any word by themselves and even in combination with another morpheme.

In addition, the semantic dictionary data represents specific words of word classes such as nouns and verbs and represents the meanings of the words with the broader concept in a hierarchical manner. When the specific words are nouns “ramen” and “udon”, for example, the semantic dictionary data shows the meaning “cooking: noodles” with the broader concept as the meaning of the words.

When the morpheme dictionary data and the semantic dictionary data are read from the hard disk drive 189, the preference extraction unit 191 performs morpheme analysis on the in-area text 105 based on the morpheme dictionary data. In so doing, the preference extraction unit 191 specifies each of the word classes of a plurality of morphemes by sectioning the in-area text 105 into the plurality of morphemes.

In addition, the preference extraction unit 191 determines one or a plurality of morphemes constituting specific words of word classes such as nouns and verbs from among the plurality of morphemes based on the result of the morpheme analysis and the semantic dictionary data. Moreover, the preference extraction unit 191 specifies the meanings of a word constituted by one or a plurality of determined morphemes.

Then, the preference extraction unit 191 performs syntax analysis on the in-area text 105 based on such a result of the morpheme analysis and the word meaning specification result obtained for the in-area text 105. In so doing, the preference extracting unit 191 specifies the grammatical roles of the morphemes included in the in-area text 105 and specifies the modification relationship and the like between the morphemes in the in-area text 105.

As described above, the preference extraction unit 191 obtains the processing result of the natural language processing (that is, the result of the morpheme analysis, the word meaning specification result, and the result of the syntax analysis) for the in-area text 105. The preference extraction unit 191 detects a keyword, which is important to understand the contents of the in-area text 105, from the in-area text 105 based on the processing result of the natural language processing for the in-area text 105.

That is, the preference extraction unit 191 maintains a list (hereinafter, this will also be referred to as a word class list) of morphemes of predetermined word classes such as particles and adverbs, which have been detected in advance by learning with the use of various texts, for example, and do not contribute to understanding of the contents of the text.

In addition, the preference extraction unit 191 also maintains a list of words with predetermined meanings, which have been detected in advance by learning with the use of various texts, for example, and do not contribute to understanding of the contents of the text.

Accordingly, the preference extraction unit 191 excludes from the candidates of keywords the morphemes of the word classes registered in the word class list as the morphemes which are not important to understand the contents of the in-area text 105, from among a plurality of morphemes included in the in-area text 105.

In addition, the preference extraction unit 191 also excludes from the candidates of keywords one or a plurality of morphemes constituting words with meanings registered in the meaning list as the morphemes which are not important to understand the contents of the in-area text 105, from among a plurality of words included in the in-area text 105.

Moreover, the preference extraction unit 191 specifies morphemes which are not important in the context to understand the contents of the in-area text 105 from among a plurality of morphemes in the in-area text 105 based on the grammatical roles, modification relationships, and the like of the plurality of morphemes included in the in-area text 105. Then, the preference extraction unit 191 excludes the specified morphemes from the candidates of keywords.

As described above, the preference extraction unit 191 detects the words such as nouns and verbs constituted by one or a plurality of morphemes, which are not excluded and remain from among a plurality of morphemes in the in-area text 105, as the keywords which are important to understand the contents of the in-area text 105.

In addition, the preference extraction unit 191 also performs natural language processing on the in-page text 88 selected to be used for preference extraction in the same manner as in the case of the in-area text 105 and detects keywords, which are important to understand the contents of the in-page text 88, based on the processing result.

Then, the preference extraction unit 191 gathers the categories 72, 90, and 107 selected to be used for preference extraction. That is, the preference extraction unit 191 sets the number of the categories to one if the category is different from any one of the other categories 72, 50, and 107, and the preference extraction unit 191 sets the number of categories to the number which is two or greater as a whole if the two or more same categories are present.

Moreover, the preference extraction unit 191 gathers the keywords 89, and 106 selected to be used for preference extraction with the keywords detected from the in-area text 105 and the in-page text 88. That is, the preference extraction unit 191 sets the number of the categories to one if the category is different from any one of the other categories, and the preference extraction unit 191 sets the number of categories to the number which is two or greater as a whole if the two or more same categories are present.

In so doing, the preference extraction unit 191 extracts a predetermined number or greater of the categories as categories of items, in which the user is interested, from among a plurality of categories based on the gathering result, for example. In addition, the preference extraction unit 191 extracts a predetermined number or greater of keywords as keywords which representing the features of the items, in which the user is interested, from among a plurality of keywords based on the gathering result, for example.

As described above, the preference extracting unit 191 extracts categories of the items and keywords representing the items, in which the user is interested, as user preference (that is, as information representing user preference). In addition, the categories and the keywords extracted by the preference extracting unit 191 as the information representing user preference as described above will also be referred to as preference information in the following description. Then, the preference extracting unit 191 sends the preference information to the control unit 180.

When the preference information is give from the preference extraction unit 191, the control unit 180 sends the preference information to the hard disk drive 189. In so doing, the control unit 180 stores the preference information on the hard disk drive 189 and associates and registers the preference information with the previously specified (that is, specified for registering the display history IH) user information.

### 1-6. Procedure of Image Data Producing Processing for Electronic Book

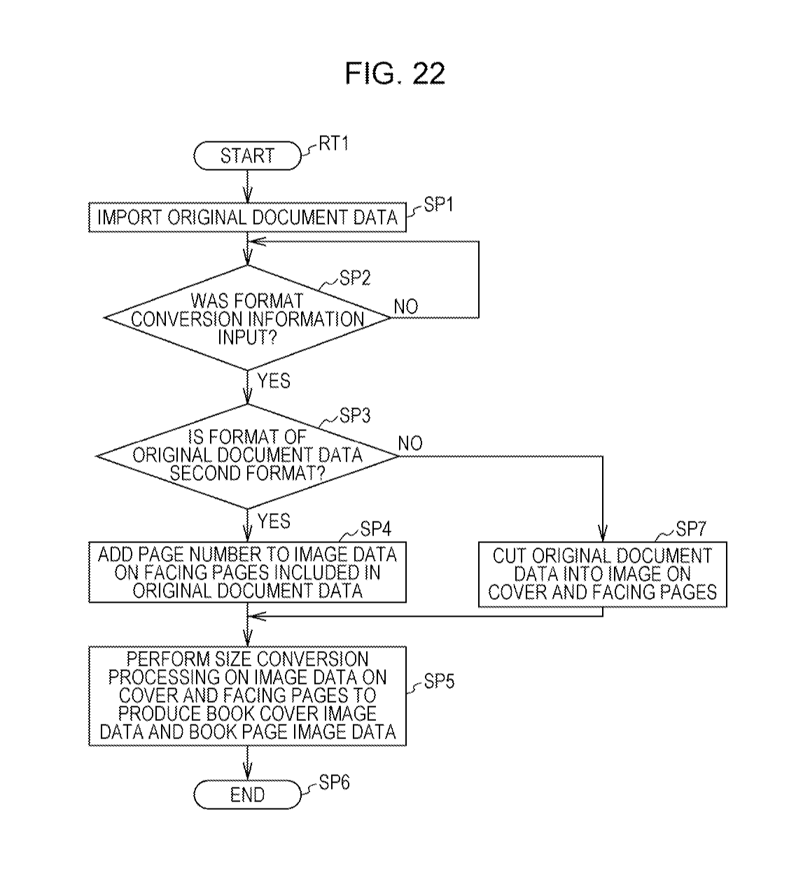

Next, description will be made of a procedure RT1 of image data producing processing for an electronic book, in which the control unit 30 of the electronic book producing apparatus 21 produces book cover image data and the book page image data in the electronic book producing process executed based on the electronic book producing program, with the use of FIG. 22.

The control unit 30 of the electronic book producing apparatus 21 starts the procedure RT1 of image data producing processing for an electronic book shown in FIG. 22 based on the electronic book producing program when the start of the electronic book producing processing is instructed by an operator via the operation unit 36, for example.

When the procedure RT1 of image data producing processing for an electronic book is started, the control unit 30 imports original document data in the first or second format from the outside in Step SP1 and moves on to the next Step SP2.

In Step SP2, the control unit 30 prompts the operator to input the format conversion information via the display unit 40, for example, and waits for the input of the format conversion information by the operator via the operation unit 36. When the format conversion information is input, the control unit 30 then moves on to the next Step SP3.

In Step SP3, the control unit 30 determines whether or not the format of the original document data imported from the outside at this time is the second format. If a positive result is obtained in this Step SP3, this means that the original document data in the second format, which has been produced by scanning a publication, is imported from the outside at this time. If such a positive result is obtained in Step SP3, the control unit 30 moves on to the next Step SP4.

In Step SP4, the control unit 30 adds page numbers to the image data for one or a plurality of facing pages included in the original document data and moves on to the next Step SP5. In Step SP5, the control unit 30 respectively performs size conversion processing on the image data for the cover and the image data of one or a plurality of facing pages of the publication included in the original document data.

In so doing, the control unit 30 produces the book cover image data and the book page image data with image sizes of HDTV standard, moves on to the next Step SP6, and completes such a procedure RT1 of image data producing processing for an electronic book.

In addition, if a negative result is obtained in the aforementioned Step SP3, this means that the original document data in the first format, which has been produced for manufacturing a publication, is imported from the outside at this time. If such a negative result is obtained in Step SP3, the control unit 30 moves on to Step SP7.

In Step SP7, the control unit 30 cuts the original data into image data for the cover of the publication and image data for each facing page of the publication after decoding the original document and moves on to Step SP5.

Accordingly, the control unit 30 respectively performs the size conversion processing on the image data for the cover cut from the original data and the image data for one or a plurality of facing pages in Step SP5 in such a case. In so doing, the control unit 30 produces the book cover image data and the book page image data with the image sizes of HDTV standard, moves on to the next Step SP6, and completes such a procedure RT1 of image data producing processing for an electronic book.

### 1-7. Procedure of Electronic Book Data Producing Processing

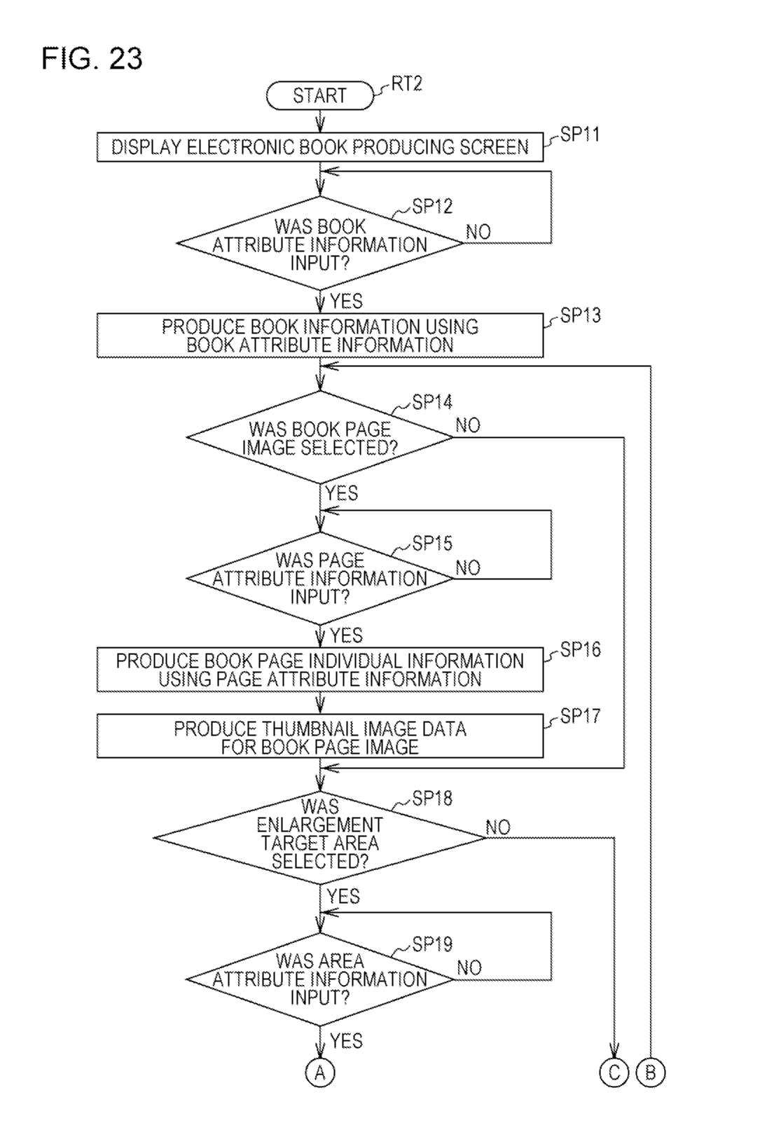

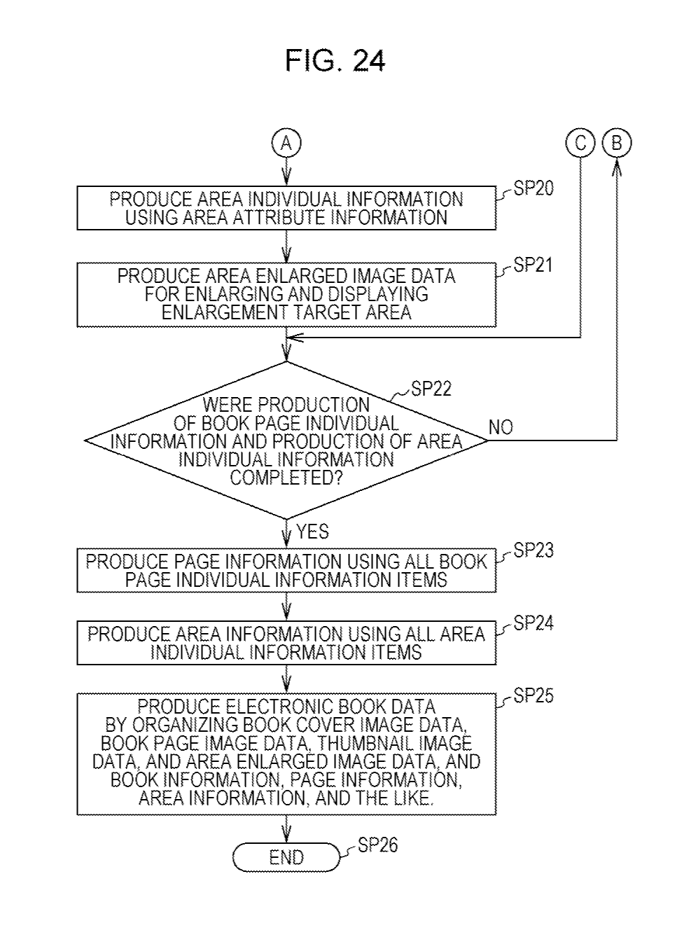

Next, description will be made of the procedure RT2 of electronic book data producing processing, in which the control unit 30 of the electronic book producing apparatus 21 produces electronic book data in the electronic book producing processing executed based on the electronic book producing program, with the use of FIGS. 23 and 24.

For example, when the procedure RT1 of image data producing processing for an electronic book is completed, the control unit 30 of the electronic book producing apparatus 21 starts the procedure RT2 of electronic book data producing processing shown in FIGS. 23 and 24 based on the electronic book producing program.

When the procedure RT2 of electronic book data producing processing is started, the control unit 30 displays the electronic book producing screen 42A on the display unit 40 based on the book display image data and the book page image data in Step SP11 and moves on to the next Step SP12.

In Step SP12, the control unit 30 waits for the input of the book attribute information on the book attribute input image 49 of the electronic book producing screen 42A by the operator via the operation unit 36. When the book attribute information is input on the book attribute input image 49, the control unit 30 then moves on to the next Step SP13.

In Step SP13, the control unit 30 organizes the book attribute information in the book attribute input image 49 with the total page number to produce book information 65 and moves on to the next Step SP14. In Step SP14, the control unit 30 determines whether or not the book page images 45 to 48 are selected on the image list display unit 43 on the electronic book producing screen 42A by the operator via the operation unit 36.

If a positive result is obtained in this Step SP14, this means that the book page images 45 to 48 have been selected for inputting the page attribute information by the operator. When such a positive result is obtained in Step S214, the control unit 30 updates the electronic book producing screen 42A displayed on the display unit 40 to the electronic book producing screen 42B including the page attribute input image 75 and moves on to the next Step SP15.

In Step SP15, the control unit 30 waits for the input of the page attribute information on the page attribute input image 75 in the electronic book producing screen 42B by the operator via the operation unit 36. When the page attribute information is input on the page attribute input image 75, the control unit 30 then moves on to the next Step SP16.

In Step SP16, the control unit 30 associates the page attribute information in the page attribute input image 75 with the page number of the book page image 47 selected at this time to produce the individual book page information and moves on to the next Step SP17.

In Step SP17, the control unit 30 performs downsize processing on the book page image data for the book page image 47 selected at this time and produces a thumbnail image data for the thumbnail image as an index of the book page image 47. In addition, the control unit 30 adds the page number of the original book page image 47 to the thumbnail image data and moves on to the next Step SP18.

In Step SP18, the control unit 30 determines whether or not the enlargement target area 92 has been chosen in the book page image 47, which has been enlarged and displayed on the electronic book producing screen 42A, by the operator via the operation unit 36. If a positive result is obtained in this Step SP18, this means that the enlargement target area 92 which can be enlarged and displayed has been chosen on the book page image 47 by the operator when the electronic book is displayed by the user.

If such a positive result is obtained in Step SP18, the control unit 30 issues area specifying information 101 of the chosen enlargement target area 92. Then, the control unit 30 updates the electronic book producing screen 42A displayed on the display unit 40 to the electronic book producing screen 42V including the area attribute input image 94 and moves on to the next Step SP19.

In Step SP19, the control unit 30 waits for the input of the area attribute information on the area attribute input image 94 in the electronic book producing screen 42C by the operator via the operation unit 36. If the area attribute information is input on the area attribute input image 94, the control unit 30 then moves on to the next Step SP20.

In Step SP20, the control unit 30 associates the area attribute information in the area attribute input image 94 with area position information association representing the position of the enlargement target area 92 chosen at this time. In addition, the control unit 30 also associates the area attribute information in the area attribute input image 94 with the page number of the book page image 47 including the enlargement target area 92 chosen at this time to produce the area individual information and moves on to the next Step SP21.

In Step SP21, the control unit 30 cuts a part of the enlargement target area 92 chosen at this time as area data from among the book page image data for the book page image 47. In addition, the control unit 30 adds the area specifying information 101 of the original enlargement target area 92 to produce the area enlargement image data after performing enlargement processing on the area data and then moves on to the next Step SP22.

In Step SP22, the control unit 30 determines whether or not the production of the book page information and the area individual information has been completed. If a negative result is obtained in Step SP22, this means that book page images 45 to 48 which have not been selected for the input of the page attribute information are present or that completion of choosing has not been instructed by the operator for choosing the enlargement target area 92. If such a negative result is obtained in Step SP22, the control unit 30 returns to Step SP14.

In addition, if a negative result is obtained in the aforementioned Step SP14, this means that the contents of the book page image 47 enlarged and displayed in the electronic book producing screen 42B is being checked by the operator, for example.

That is, such a negative result means that the book page images 45 to 48 have not been selected by the operator for input of the page attribute information and there is a possibility in that the enlargement target area 92 is chosen. If such a negative result is obtained in Step SP14, the control unit 30 moves on to Step SP19.

Furthermore, if a negative result is obtained in Step SP18, this means that there is a possibility in that new book page image 45 to 48 is selected by the operator, who has completed the input of the page attribute information, for input of the page attribute information, for example. If such a negative result is obtained in Step SP18, the control unit 30 moves on to Step SP22.

In so doing, the control unit 30 allows the operator to select the book page images 45 to 48 and input the page attribute information thereafter by repeatedly and cyclically executing the processing from Step SP14 to Step SP22 until a positive result is obtained in Step SP22. In addition, the control unit 30 allows the operator to choose an enlargement target area and input the area attribute information by repeatedly and cyclically executing the processing from Step SP14 to Step SP22.

Then, if a positive result is obtained in Step SP22, this means that the page attribute information has been input for all book page images 45 to 48 by the operator and the production of the book page individual information for all book page images 45 to 48 has been completed.

In addition, such a positive result means that completion of the choosing of the enlargement target area 92 is instructed by the operator and the production of the area individual information has been completed for all enlargement target areas chosen by the operator. If such a positive result is obtained in Step SP22, the control unit 30 moves on to the next Step SP23.

In Step SP23, the control unit 30 produces the page information 85 with the use of all individual book page information and moves on to the next Step SP24. In Step SP24, the control unit 30 produces the area information 100 with the use of all area individual information and moves on to the next Step SP25.

Then, in Step SP25, the control unit 30 moves on to the next Step SP26 after organizing the book image data, the book information 65, the page information 85, the area information 100, the coded audio data, and the coded associated data, which are produced at this time, to produce the electronic book data D2 and D4. In so doing, the control unit 30 completes such a procedure RT2 of electronic book data producing processing in Step SP26.

### 1-8. Procedure of Electronic Book Registration Processing

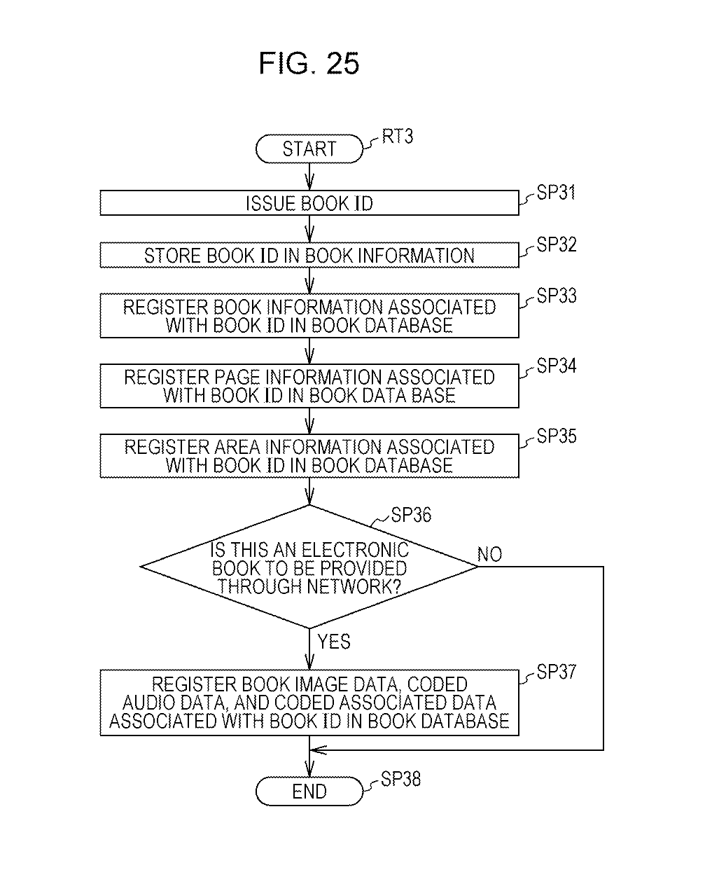

Next, description will be made of a procedure RT3 of electronic book registration processing, in which the control unit 180 of the history obtaining apparatus 22 registers the electronic book produced by the electronic book producing apparatus 21 based on a registration program stored in advance on the ROM 181, for example, with the use of FIG. 25.

When the electronic book data D2 and 54 transmitted from the electronic book producing apparatus 21 is received, the control unit 180 of the history obtaining apparatus 22 starts the procedure RT3 of electronic book registration processing shown in FIG. 25 based on the registration program. When the procedure RT3 of electronic book registration processing is started, the control unit 180 issues book specifying information 116 of the electronic book based on the electronic book data D2 and 54 received at this time in Step SP31 and moves on to the next Step SP32.

In Step SP32, the control unit 180 stores the book specifying information 116 on the book information 65 included in the electronic book data D2 and D4, transmits the book specifying information 116 to the electronic book producing apparatus 21 via the network 23, and moves on to the next Step SP33.

In Step SP33, the control unit 180 stores the book information 65 storing the book specifying information 116 and the book specifying information 116 on the hard disk drive 189, associates therebetween, registers them in the honk database, and then moves on to the next Step SP34.

In Step SP34, the control unit 180 stores the page information included in the electronic hook data D2 and D4 on the hard disk drive 189, associates and registers the page information 85 with the book specifying information 116 in the hook database, and then moves on to the next Step SP35.

In Step SP35, the control unit 180 stores the area information 100 included in the electronic book data D2 and D4 on the hard disk drive 189, associates and registers the area information 100 with the book specifying information 116, and then moves on to the next Step SP36.

In Step SP36, the control unit 180 determines whether or not the electronic book data D2 and D4 received at this time is electronic book data D2 and D4 which can be provided via the network 23. If a positive result is obtained in Step SP36, this means that the electronic book data D2 and D4 received at this time is electronic book data D2 and D4 whose providing with the use of the network 23 is permitted. If such a positive result is obtained in Step SP36, the control unit 180 moves on to the next Step SP37.

In Step SP37, the control unit 180 stores the book image data D4 included in the electronic book data D2 and D4 on the hard disk drive 189 and associates and registers the book image data D6 with the book specifying information 116 in the book database.

In addition, the control unit 180 stores the coded associated data D7 and the coded audio data D8 included in the electronic book data D2 and D4 on the hard disk drive 188, associates and registers the coded associated data D7 and the coded audio data D8 with the book specifying information 116 in the book database, and then moves on to the next Step SP38. In so doing, the control unit 180 completes the procedure RT3 of electronic book registration processing in Step SP38.

On the other hand, if a negative result is obtained in the aforementioned Step SP36, this means that the electronic book data D2 and D4 received at this time is electronic book data D2 and D4 whose providing with the use of the network 23 is not permitted. If such a negative result is obtained in Step SP36, the control unit 180 moves on to Step SP38 without executing the processing in Step SP37 and completes such a procedure RT3 of electronic book registration processing.

### 1-9. Procedure of Electronic Book Reproduction Processing

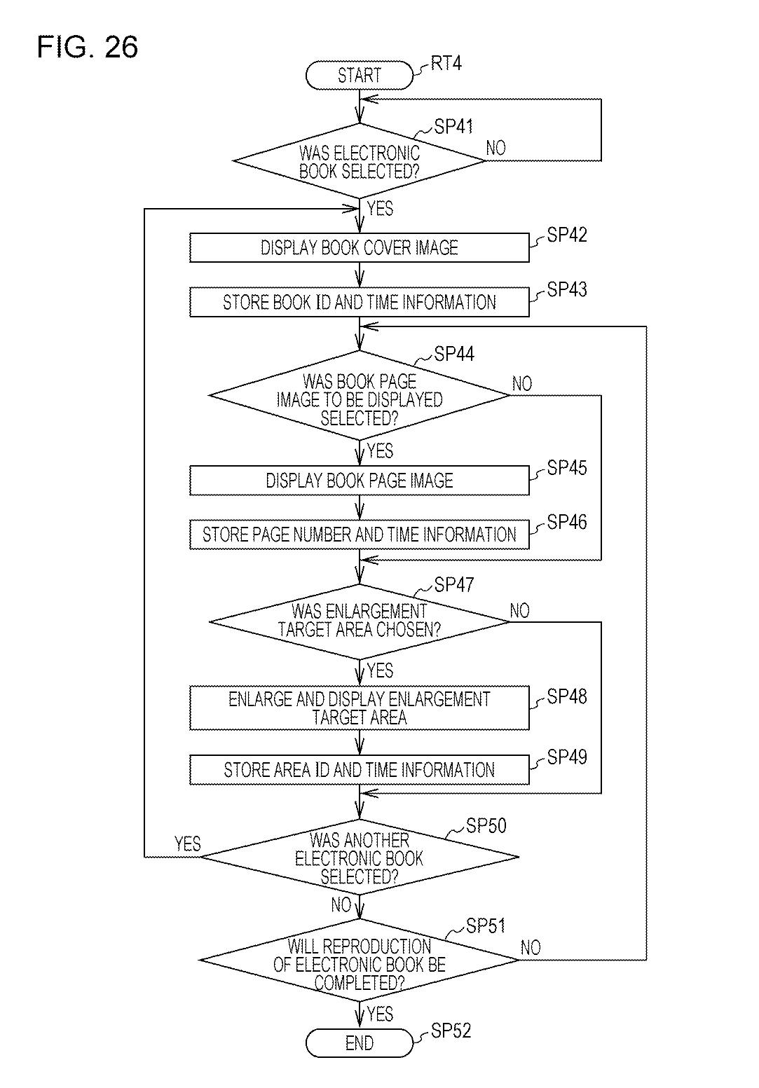

Next, description will be made of the procedure RT4 of electronic book reproduction processing, in which the control unit 130 of the electronic book reproducing apparatus 24 reproduces the electronic book data D2 and D4 based on the electronic book reproducing program P2, with the use of FIG. 26.

When the reproduction of the electronic book is instructed by the user, the control unit 130 of the electronic book reproducing apparatus 24 starts the procedure RT4 of the electronic book reproduction processing shown in FIG. 26 based on the electronic book reproducing program P2 read from the book providing disc 28 or the hard disk drive 152.

When the procedure RT4 of the electronic book reproduction processing is started, the control unit 130 displays the index screen on the display apparatus 25 in Step SP41 and waits for the user's selection of an electronic book to be reproduced. When the electronic book to be reproduced is selected on the index screen by the user, the control unit 130 then moves on to the next Step SP42.

In Step SP42, the control unit 130 reproduces the book cover image data included in the electronic book data D2 and D4 for the electronic book selected by the user, displays the book cover image based on the book cover image data on the display apparatus 25, and moves on to the next Step SP43.

In Step SP43, the control unit 130 associates and stores the book specifying information 116 of the electronic book selected by the user with the time information at the display start time point of the book cover display on the built-in storage unit 140 as the display history IH and moves on to the next Step SP44.

In Step SP44, the control unit 130 determines whether or not the displayed book page images 45 to 48 have been selected by the user. If a positive result is obtained in Step SP44, this means that the book page images 45 to 48 displayed on the display apparatus 25 have been selected by the instruction of sending or returning of the page or the selection of a thumbnail image by the user. If such a positive result is obtained in Step SP 44, the control unit 130 moves on to the next Step SP45.

In Step SP45, the control unit 130 reproduces the book page image data in accordance with the user operation (instruction or selection), displays the book page image based on the book page image data on the display apparatus 25, and moves on to the next Step SP46.

In Step SP46, the control unit 130 associates and stores the page number 86 of the displayed book page images 45 to 48 with the time information at the display start time point in the built-in storage unit 140, updates the display history IH, and then moves on to the next Step SP47.

In Step SP47, the control unit 130 determines whether or not the enlargement target area 92 has been designated in the book page images 45 to 48 being displayed by the user. If a positive result is obtained in Step SP47, this means that the enlargement target area 92 whose enlargement and display are desired has been designated in the book page images 45 to 48 being displayed by the user. If such a positive result is obtained in Step SP47, the control unit 130 moves on to the next Step SP48.

In Step SP4, the control unit 130 reproduces the area enlargement image data corresponding to the enlargement target area 92 designated by the user, enlarges and displays the enlargement target area 92 as the area enlargement image 150 on the display apparatus 25, and moves on to the next Step SP49.

In Step SP49, the control unit 130 associates and stores the area specifying information 101 of the enlarged and displayed enlargement target area 92 with the time information at the enlargement and display start point in the built-in storage unit 140, updates the display history IH, and the moves on to the next Step SP50.

In Step SP50, the control unit 130 determines whether or not another electronic book has been selected for reproduction by the user. If a negative result is obtained in Step SP50, this means that there is a possibility in that the user instructs to display the book page images 45 to 48 of the previously selected electronic book and to enlarge and display the enlargement target area 92. If such a negative result is obtained in Step SP50, the control unit 130 moves on to the next Step SP51.

In Step SP51, the control unit 130 determines whether or not the reproduction of the electronic book is completed. If a negative result is obtained in Step SP51, this means that the electronic book is being read by the user and completion of the reproduction of the electronic book has not been instructed yet. If such a negative result is obtained in Step SP51, the control unit 130 returns to Step SP44.

By the way, if a negative result is obtained in the aforementioned Step SP44, this means that the articles and the like in the book page images 45 to 40 being displayed at this time is being read or the enlargement target area 92 to be enlarged and displayed is being selected by the user. If such a negative result is obtained in Step SP44, the control unit 130 moves on to Step SP47 without executing the processing in Step SP45 and Step SP46.

In addition, if a negative result is obtained in the aforementioned Step SP47, this means that the book page images 45 to 40 being displayed at this time or the articles and the like in the enlargement target area 92 being enlarged and displayed are being read by the user. If such a negative result is obtained in Step SP47, the control unit 130 moves on to Step SP50 without executing the processing in Step SP48 and Step SP49.

Moreover, if a positive result is obtained in the aforementioned Step SP50, this means that the index screen has been displayed again in response to the user's instruction and an electronic book to be subsequently reproduced has been selected on the displayed index screen. If such a positive result is obtained in Step SP50, the control unit 130 returns to Step SP42.

In so doing, the control unit 130 repeatedly and cyclically executes the processing in Step SP42 to Step SP50 thereafter until a positive result is obtained in Step SP51. Accordingly, the control unit 130 can allow the user to read the articles in the book page images 45 to 40 and the enlargement target area 92 by sequentially displaying the book page images 45 to 48 of one or a plurality of electronic books or sequentially enlarging and displaying the enlargement target area 92.

Then, if a positive result is obtained in Step SP51, this means that completion of the reproduction of the electronic book has been instructed by the user. If such a positive result is obtained in Step SP51, the control unit 130 moves on to the next Step SP52 and completes the procedure RT4 of the electronic book reproduction processing.

### 1-10. Procedure of Display History Providing and Obtaining Processing

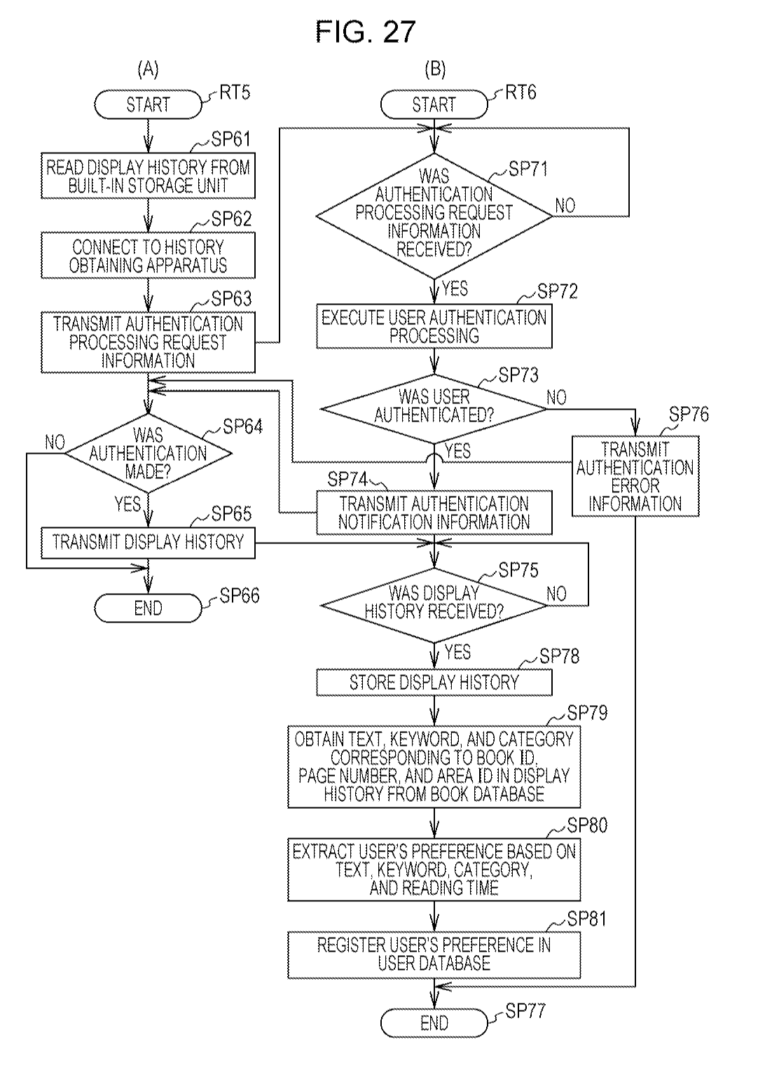

Next, description will be made of a procedure of history providing and obtaining processing, which is executed by the control unit 130 of the electronic book reproducing apparatus 24 and the control unit 180 of the history obtaining apparatus 22, with the use of FIG. 27. When completion of the reproduction of the electronic book is instructed by the user, the control unit 130 of the electronic book reproducing apparatus 24 starts the procedure RT5 of the display history providing processing shown in FIG. 27(A) based on the electronic book reproducing program P2 read from the book providing disc 28 or the hard disk drive 152.

That is, when completion of the reproduction of the electronic book is instructed by the user, the control unit 130 of the electronic book reproducing apparatus 24 starts the procedure RT5 of the display history providing processing as part of the aforementioned electronic book reproducing processing. When the procedure RT5 of the display history providing processing is started, the control unit 130 completes the production of the display history IH in the built-in storage unit 140 in Step SP61. Then, the control unit 130 completes the production, reads the display history IH from the built-in storage unit 140, and moves on to the next Step SP62.

In Step SP62, the control unit 130 accesses the history obtaining apparatus 22 via the network 23, communicates with the history obtaining apparatus 22, and moves on to the next Step SP63. Then, in Step SP63, the control unit 130 produces the authentication processing request information, transmits the authentication processing request information to the history obtaining apparatus 22 via the network 23, and moves on to the next Step SP64.

At this time, the control unit 180 of the history obtaining apparatus 22 starts the procedure RT6 of the display history obtaining processing shown in FIG. 27(B) based on the history obtaining program stored in advance on the ROM 181, for example, in response to the communication with the electronic book reproducing apparatus 24.

When the procedure RT6 of the display history obtaining processing is started, the control unit 180 waits for the transmission of the authentication processing request information from the electronic book reproducing apparatus 24 in Step SP71. Then, when the authentication processing request information transmitted from the electronic book reproducing program 24 is received, the control unit 180 moves on to the next Step SP72.

In Step SP72, the control unit 180 causes the authentication processing unit 190 to executes the user authentication processing based on the authentication processing request information and moves on to the next Step SP73. In Step SP73, the control unit 180 determines whether or not the user has been authenticated as a result of the user authentication processing. If a positive result is obtained in Step SP73, this means that the history obtaining apparatus 22 has been accessed by the electronic book reproducing apparatus 24 of a user, who has already completed the user registration, at this time. If such a positive result is obtained in Step SP73, the control unit 180 moves on to the next Step SP74. Accordingly, the control unit 180 transmits the authentication notification information to the electronic book reproducing apparatus 24 at this time in Step SP74 and moves on to the next Step SP75.

On the other hand, if a negative result is obtained in Step SP73, this means that the history obtaining apparatus 22 has been accessed by the electronic hook reproducing apparatus 24 of a user, who has not completed the user registration yet, at this time. If such a negative result is obtained in Step SP73, the control unit 180 transmits the authentication error information to the electronic book reproducing apparatus 24, then moves on to Step SP77, and completes such a procedure RT6 of the display history obtaining processing.

By the way, the control unit 130 of the electronic book reproducing apparatus 24 waits for the notification of the processing result of the user authentication processing from the history obtaining apparatus 22 (that is, the transmission of the authentication notification information or the authentication error information) in Step SP64.

Then, when the control unit 130 is notified of the processing result of the user authentication processing by the history obtaining apparatus 22, the control unit 130 determines whether or not the user has been authenticated. If a positive result is obtained in Step SP64, this means that the user who owns this apparatus has completed the user registration. If such a positive result is obtained in Step SP64, the control unit 130 moves on to the next Step SP65.

Accordingly, the control unit 130 produces the display history notification data to provide the display history transmits the display history notification data to the history obtaining apparatus 22, moves on to the next Step SP66, and completes such a procedure RT5 of the display history obtaining processing in Step SP65.

In addition, if a negative result is obtained in Step SP64, this means that the user who owns this apparatus has not completed the user registration yet. If such a negative result is obtained in Step SP64, the control unit 130 moves on to Step SP Step SP66 without executing the processing in Step SP65 and completes such a procedure RT5 of the display history providing processing.

By the way, when the control unit 180 of the history obtaining apparatus 22 transmits the authentication notification information to the electronic book reproducing apparatus 24 and moves on to Step SP75, the control unit 180 of the history obtaining apparatus 22 waits for the transmission of the display history notification data from the electronic book reproducing apparatus 24. Then, when the display history notification data transmitted from the electronic book reproducing apparatus 24 is received, the control unit 180 moves on to the next Step SP78.

In Step SP78, the control unit 180 extracts the display history IH from the display history notification data. Then, the control unit 180 stores the display history IH on the hard disk drive 180, associates and registers the display history IH with the user information of the user of the electronic book reproducing apparatus 24 in the user database, and moves on to the next Step SP79.

In Step SP79, the control unit 180 reads specific book attribute information, page attribute information, and area attribute information for preference extraction from the hard disk drive 189 based on the display history IH by the preference extraction unit 191 and moves on to the next Step SP80.

In Step SP80, the control unit 180 causes the preference extraction unit 191 to extract user preference based on specific book attribute information, page attribute information, and area attribute information for preference extraction and moves on to the next Step SP81.

In Step SP81, the control unit 180 stores the user preference extracted by the preference extraction unit 191 as the preference information on the hard disk drive 189 and associates and registers the user information of the user in the user database. Then, when the registration of the preference information has been completed, the control unit 180 moves on to Step SP77 and completes such a procedure RT6 of the display history obtaining processing.

### 1-11. Operations and Effects of Embodiments

In the above configuration, the electronic book producing apparatus 21 in the electronic book providing system 20 imports the original document data from the outside. In addition, the electronic book producing apparatus 21 produces the book cover image data and one or a plurality of book page image data items based on the original document data.

Moreover, the electronic book producing apparatus 21 produces the electronic book data for the electronic book including book cover image data and one or a plurality of book page image data in which one or a plurality of parts selected in the book page image are set as enlargement target areas which can be individually enlarged and displayed.

In addition, the electronic book reproducing apparatus 24 in the electronic book providing system 20 performs reproducing processing on the electronic book data produced by the electronic book producing apparatus 21 and displays the book cover image and the book page image on the display apparatus 25.

If an enlargement target area in the book page image displayed on the display apparatus 25 is designated by the user via the remote control 27, the electronic book reproducing apparatus 24 enlarges and displays the designated enlargement target area on the display apparatus 25 as an area enlargement image.

Furthermore, when the reproduction processing is performed on the electronic book data as describe above, the electronic book reproducing apparatus 24 produces a display history showing enlargement target area enlarged and displayed on the display apparatus 25. Then, when the reproduction of the electronic book is completed, the electronic book reproducing apparatus 24 transmits the display history to the history obtaining apparatus 22 via the network 23.

Furthermore, when the display history is transmitted from the electronic book reproducing apparatus 24 in accordance with the completion of the reproduction of the electronic book, the history obtaining apparatus 22 in the electronic book providing system 20 receives the display history and associates and stores the display history with the user information of the user of the electronic book reproducing apparatus 24.

Accordingly, the electronic book providing system 20 can specifically determine which part, that is, which enlargement target area has been actually read by the user in the book page image of the electronic book, based on the display history by the history obtaining apparatus 22.

According to the above configuration, configuration is made in the electronic book system 20 such that when the electronic book producing apparatus 21 produces electronic book data of an electronic book, which has one or a plurality of book page image data items based on original document data imported from the outside, in which one or a plurality of parts selected in a book page image based on the book page image data are set to enlargement target areas which can be individually enlarged and displayed, and the electronic book reproducing apparatus 24 performs reproduction processing on the electronic book data, displays the book images on the display apparatus 25, causes the display apparatus 25 to enlarge and display the designated enlargement target area when the enlargement target area in the book page image is designated by the user, produces the display history showing the enlargement target area enlarged and displayed on the display apparatus 25 when the reproduction processing is performed on the electronic book data as described above, and transmits the produced display history to the history obtaining apparatus 22, and the history obtaining apparatus 22 receives the display history and associates and stores the display history with the user information of the user of the electronic book reproducing apparatus 24. In so doing, the electronic book providing system 20 can specifically determine which part in the book page image of the electronic book has been actually read by the user based on the display history by the history obtaining apparatus 22. Accordingly, the electronic book providing system 20 can more effectively use the display history of the electronic book displayed by the electronic book reproducing apparatus 24 for advertising of the electronic book, manufacturing of a new electronic book, and extracting of user preference and the like.

In addition, the history obtaining apparatus 22 in the electronic book providing system 20 determines the enlargement target area enlarged and displayed by the electronic book reproducing apparatus 24 based on the display history provided from the electronic book reproducing apparatus 24. Then, the history obtaining apparatus 22 is configured to extract user preference based on a keyword and a category in accordance with the contents of the determined enlargement target area.

Accordingly, the electronic book providing system 20 can accurately extract user preference based on a part, which has been substantially surely checked (read) by the user, in the book page image. That is, the electronic book providing system 20 can precisely extract user preference while avoiding using even a part, which has not been actually checked (read) in the book page image including articles of various contents, for example, for the user preference extraction to the maximum extent.

Moreover, when the enlarged and displayed enlargement target area is determined based on the display history, the history obtaining apparatus 22 in the electronic book providing system 20 performs natural language processing on texts in the enlargement target area and detects keywords in accordance with the contents of the enlargement target area based on the processing result. Then, the history obtaining apparatus 22 is configured to extract user preference with the use of the detected keywords.

Accordingly, even when the keywords for the enlargement target area have not been input by the operator at the time of producing the electronic book data, the electronic book providing system 20 can accurately extract user preference.

Furthermore, when the reproduction processing is performed on the electronic book data, the electronic book reproducing apparatus 24 in the electronic book providing system 20 produces a display history representing the book page image displayed on the display apparatus 25 along with the enlargement target area enlarged and displayed on the display apparatus 25. Then, when the reproduction of the electronic book is completed, the electronic book reproducing apparatus 24 is configured to transmit the display history to the history obtaining apparatus 22 via the network 23.

In addition, the history obtaining apparatus 22 in the electronic book providing system 20 also determines the book page image displayed by the electronic book reproducing apparatus 24 along with the enlargement target area enlarged and displayed by the electronic book reproducing apparatus 24 based on the display history.

Then, the history obtaining apparatus 22 is configured to extract user preference based on the keywords and the category in accordance with the contents of the determined enlargement target area and the contents of the specified book page image. Accordingly, when the entire contents of the book page image has been checked by the user, the electronic book providing system 20 can extracts the user preference even with the use of the contents.

Furthermore, when the reproduction processing is performed on the electronic book data, the electronic book reproducing apparatus 24 in the electronic book providing system 20 shows the enlarged and displayed enlargement target area on the display apparatus 25 along with the time at the start time point of enlargement and display and produces the display history showing the book page image displayed on the display apparatus 25 along with the time at the display start time point. Then, when the reproduction of the electronic book is completed, the electronic book reproducing apparatus 24 is configured to transmit the display history to the history obtaining apparatus 22 via the network 23.

In addition, when the book page image displayed by the electronic book reproducing apparatus 24 is determined based on the display history, the history obtaining apparatus 22 in the electronic book providing system 20 determines whether or not the contents of the book page image has been actually checked, based on the time information included in the display history.

Then, the history obtaining apparatus 22 is configured to extract user preference based on the keywords and the category in accordance with the contents of the determined enlargement target area and the contents of the book page image, which is determined to have been actually checked. Accordingly, it is possible to avoid extracting the user preference with the use of the book page image, which is temporarily displayed by the electronic book reproducing apparatus 24 for page shifting or the like, whose contents have not been checked, according to the electronic book providing system 20.

### 2. MODIFIED EXAMPLES

### 2-1. Modified Example 1

In addition, in the aforementioned embodiment, the electronic book reproducing apparatus 24 produces the display history showing the electronic book selected for reproduction, the book page image displayed on the display apparatus 25, and the enlargement target area enlarged and displayed on the display apparatus 25 and transmits display history to the history obtaining apparatus 22. In addition, the description was made of a case in which the history obtaining apparatus 22 was configured to extract user preference with the use of the display history.

However, the present invention is not limited thereto, and the electronic book reproducing apparatus 24 produces the display history showing only the enlargement target area enlarged and displayed on the display apparatus 25 and transmits the display history to the history obtaining apparatus 22. In addition, the history obtaining apparatus 22 may be configured to extract user preference based only on the contents of the enlargement target area shown by the display history.

In addition, the present invention may be configured such that the electronic book reproducing apparatus 24 shows book page image displayed for a predetermined time period or longer from among the displayed book page images along with the enlarged and displayed enlargement target area, produces a display history which does not particularly include the time information, and transmits the display history to the history obtaining apparatus 22.

With such a configuration, it is not necessary to determine the book page image, whose contents have been actually checked, when the user preference is extracted by the history obtaining apparatus 22, and it is possible to simplify the preference extraction processing for extracting the preference and reduce the processing load of the processing, according to the present invention.

### 2-2 Modified Example 2

In the aforementioned embodiment, description was made of the case in which the electronic book producing apparatus 21 produced the electronic book data including the page information storing the in-page text and the area information storing the in-area text and the history obtaining apparatus 22 stored the electronic book data.

However, the present invention is not limited thereto, the electronic book producing apparatus 21 may produce the electronic book data including the page information which does not store the in-page text and the area information which does not store the in-area text, and the history obtaining apparatus 22 may store the electronic book data.

In addition, the present invention may be configured such that when the user preference is extracted by the history obtaining apparatus 22, the book page image displayed by the electronic book reproducing apparatus 24, the in-page text and the in-area text in the enlarged and displayed enlargement target area may be extracted from the book page image data and the area enlargement image data included in the electronic book data stored on the history obtaining apparatus 22 itself.

In addition, the present invention may be configured such that the in-page text and the in-area text are extracted from the book page image data, or such that the in-page text is extracted from the book page image data while the in-area text is extracted from the area enlargement image data.

Furthermore, the present invention may be configured such that when the user preference is extracted by the history obtaining apparatus 22, the in-page text and the in-area text in the book page image displayed by the electronic book reproducing apparatus 24 and in the enlarged and displayed enlargement target area are obtained from the electronic book producing apparatus 21 and the electronic book reproducing apparatus 24.

Furthermore, the present invention may be configured such that the electronic book reproducing apparatus 24 produces a display history including the in-page text and the in-area text in the displayed book page image and the enlarged and displayed enlargement target area and transmits the display history to the history obtaining apparatus 22.

Furthermore, keywords are extracted from the in-page text and the in-area text when the user preference is extracted by the history obtaining apparatus 22 as described above, according to the present invention. Therefore, the electronic book producing apparatus 21 may produce the electronic book data including page information which does not store keywords (and categories as well) and the area information which does not keywords (and categories as well) in the same manner, and the history obtaining apparatus 22 may store the electronic book data.

### 2-3 Modified Example 3

Furthermore, in the aforementioned embodiment, description was made of a case in which the history obtaining apparatus 22 was configured to execute the user authentication processing with the use of the user specifying information and the password. However, the present invention is not limited thereto, and the history obtaining apparatus 22 may execute the user authentication processing with the use of the disc specifying information DI of the book providing disc 28 when the electronic book data is reproduced by the electronic book reproducing apparatus 24 with the use of the book providing disc 28.

### 2-4 Modified Example 4

Furthermore, in the aforementioned embodiment, description was made of a case in which the electronic book providing system according to the present invention was applied to the electronic book providing systems 1 and 20 described above with FIGS. 1 to 27.

However, the present invention is not limited thereto and can be applied to other electronic book providing systems with various configurations such as an electronic book providing system or the like including a PDA (Personal Digital Assistance), a personal computer, a mobile phone, or a videogames machine, which include the same functions as those of the electronic book reproducing apparatuses 3 and 24, instead of the stationary type electronic book reproducing apparatuses 3 and 24.

### 2-5 Modified Example 5

Furthermore, in the aforementioned embodiment, the electronic book reproducing program according to the present invention is applied to the electronic book producing program to be provided to the electronic book reproducing apparatus 24 via the book providing disc 28 and the network 23 described above with FIGS. 1 to 27.

In addition, the description was made of a case in which the control unit 130 of the electronic book reproducing apparatus 24 executed the procedure RT4 of the electronic book reproducing processing described above with FIG. 26 based on the electronic book reproducing program and the procedure RT5 of the display history providing processing described above with FIG. 27.

However, the present invention is not limited thereto, and the electronic book reproducing apparatus 24 may install the electronic book reproducing program with a semiconductor memory magnetic disk storing the electronic book reproducing program. In addition, the control unit 130 may execute the procedure RT4 of the electronic book reproducing processing and the procedure RT5 of the display history providing processing based on the installed electronic book reproducing program.

### 2-6 Modified Example 6

Furthermore, in the aforementioned embodiment, the history obtaining program according to the present invention is applied to the history obtaining program stored in advance on the ROM 181 of the history obtaining apparatus 22 described above with FIGS. 1 to 27.

In addition, the description was made of a case in which the control unit 180 of the history obtaining apparatus 22 executed the procedure RT6 of the display history obtaining processing described above with FIG. 27 based on the history obtaining program. However, the present invention is not limited thereto, and the history obtaining apparatus 22 may install the history obtaining program by a computer-readable storage medium storing the history obtaining program. In addition, the control unit 180 may execute the procedure RT6 of the display history obtaining processing based on the installed history obtaining program.

In addition, the history obtaining apparatus 22 may install the history obtaining program from the outside with the use of a wired or wireless communication medium such as a local area network, the Internet, digital satellite broadcasting, or the like. In addition, the computer-readable storage medium to install the history obtaining program in the history obtaining apparatus 22 so as to be in an executable state may be realized by a package medium such as a CD-ROM (Compact Disc-Read Only Memory) or a DVD. Furthermore, such a computer-readable storage medium may be realized not only by a package medium but also by a semiconductor memory, a magnetic disk, or the like on which various programs are temporarily or permanently stored.

In addition, as a means for storing the history obtaining program on the computer-readable storage medium, a wired or wireless communication medium such as a local area network, the Internet, digital satellite broadcasting, or the like may be used. Furthermore, the history obtaining program may be stored on the computer-readable storage medium via various communication interfaces such as a router, a modem, and the like.

### 2-7 Modified Example 7

Furthermore, in the aforementioned embodiment, the electronic book producing program according to the present invention is applied to the electronic book producing program stored in advance on the ROM 31 of the electronic book producing apparatus 21 described above with FIGS. 1 to 27.

In addition, the description was made of a case in which the control unit 30 of the electronic book producing apparatus 21 executed the procedure RT1 of the image data producing processing for the electronic book described above with FIG. 22 based on the electronic book producing program and the electronic book data producing processing RT2 described above with FIGS. 23 and 24.

However, the present invention is not limited thereto, and the electronic book producing apparatus 21 may install the electronic book producing program with a computer-readable storage medium on which the electronic book producing program is stored. In addition, the control unit 30 may execute the procedure RT1 of the image data producing processing for the electronic book and the electronic book data producing processing RT2 based on the installed electronic book producing program.

In addition, the electronic book producing apparatus 21 may install the electronic book producing program from the outside with the use of a wired or wireless communication medium such as a local area network, the Internet, digital satellite broadcasting, or the like. In addition, the computer-readable storage medium to install the electronic book producing program in the electronic book producing apparatus 21 so as to be in an executable state may be realized by a package medium such as a flexible disk.

In addition, the computer-readable storage medium to install the electronic book producing program in the electronic book producing apparatus 21 so as to be in an executable state may be realized by a package medium such as a CD-ROM or a DVD. Furthermore, such a computer-readable storage medium may be realized not only by a package medium but also by a semiconductor memory, a magnetic disk, or the like on which various programs are temporarily or permanently stored.

In addition, as a means for storing the history obtaining program on the computer-readable storage medium, a wired or wireless communication medium such as a local area network, the Internet, digital satellite broadcasting, or the like may be used. Furthermore, the history obtaining program may be stored on the computer-readable storage medium via various communication interfaces such as a router, a modem, and the like.

### 2-8 Modified Example 8

Furthermore, in the aforementioned embodiment, the description was made of a case in which the reproducing unit 12 and the graphic engine 138 described above with FIGS. 1 to 27 were applied as the reproducing unit which displayed the book page image on the display unit by performing reproducing processing on the electronic book data, which includes one or a plurality of book page images, in which one or a plurality parts in the book page images were set to enlargement target area which could be individually enlarged and displayed.

However, the present invention is not limited thereto, and it is possible to widely apply reproducing units with other various configurations such as a reproducing circuit with a hardware circuit configuration, a microprocessor, DSP (Digital Signal Processor) or the like which displays the book page image on the display unit by performing reproducing processing on the electronic book data, which includes one or a plurality of book page images, in which one or a plurality parts in the book page images are set to enlargement target areas which can be individually enlarged and displayed.

### 2-4 Modified Example 9

Furthermore, in the aforementioned embodiment, the description was made of a case in which the display unit 13 and the display apparatus 25 constituted by a television receiver, which were described above with FIGS. 1 to 27, were applied as the display unit which displays the book page image. However, the present invention is not limited thereto, and it is possible to widely apply display units with other various configurations such as a liquid crystal display, an organic EL display, and the like.

### 2-10 Modified Example 10

Furthermore, in the above embodiment, the description was made of a case in which the operation unit 14 and the remote control 27 described above with FIGS. 1 to 27 were applied as the operation unit to be used for arbitrarily designating the enlargement target area in the book page image displayed on the display unit.

However, the present invention is not limited thereto, and it is possible to widely apply other various operation units such as a mouse, a joy stick, a pointing device such as a touch panel, a keyboard, and the like.

### 2-11 Modified Example 11

Furthermore, in the above embodiment, the description was made of a case in which the control unit 15 and the control unit 130 constituted by a CPU, which were described above with FIGS. 1 to 27, were applied to the control unit which controls the reproducing unit such that the designated enlargement target area was enlarged and displayed on the display unit when the enlargement target area in the book page image was designated via the operation unit. However, the present invention is not limited thereto, and control units with other various configurations such as a microprocessor, DSP, and the like can be widely applied.

### 2-12 Modified Example 12

Furthermore, in the above embodiment, the description was made of a case in which the transmission unit 16 and the network controller 137, which are described above with FIGS. 1 to 27, are applied to the transmission unit which transmits the display history of the electronic book showing the enlargement target areas enlarged and displayed on the display unit. However, the present invention is not limited thereto, and it is possible to widely apply various transmission units in accordance with a wireless or wired communication scheme.

### 2-13 Modified Example 13

Furthermore, in the above embodiment, the description was made of a case in which the receiving unit 17 and the network controller 188, which were described above with FIGS. 1 to 27, were applied to the receiving unit which receives the display history when the designated enlargement target area was enlarged and displayed on the display unit in response to the designation of the enlargement target area in the book page image displayed on the display unit by the electronic book reproducing apparatus which displayed a book page image on the display unit by performing reproducing processing on the electronic book data for the electronic book, which includes one or a plurality of book page images, in which one or a plurality of parts in the book page image were set to enlargement target areas which could be individually enlarged and displayed, and when the display history of the electronic book representing the enlarged and displayed enlargement target areas was then transmitted. It is possible to widely apply various receiving units in accordance with a wireless or a wired communication scheme.

### 2-14 Modified Example 14

Furthermore, in the above embodiment, the description was made of a case in which the storage unit 10 and the hard disk drive 189, which were described above with FIGS. 1 to 27, were applied to the storage unit which stores the display history received by the receiving unit. However, the present invention is not limited thereto, and it is possible to widely apply storage units with other various configurations such as a semiconductor memory, an optical disc, and the like.

### 2-15 Modified Example 15

Furthermore, in the above embodiment, the description was made of a case in which the preference extraction unit 191 described above with FIGS. 1 to 27 was applied to the preference extraction unit which extracts the user preference based on the enlargement target areas represented by the display history.

However, the present invention is not limited thereto, and it is possible to widely apply preference extraction units with other various configurations such as a reference extraction circuit with a hardware circuit configuration, a microprocessor, a DSP, and the like which extract user preference based on the enlargement target areas represented by the display history.

### 2-16 Modified Example 16

Furthermore, in the above embodiment, the description was made of a case in which the importing unit 10 and the external interface unit 37, which were described above with FIGS. 1 to 27, were applied to the importing unit which imports the original document data including images for one or a plurality of pages. However, the present invention is not limited thereto, and it is possible to widely apply various importing units in accordance with the communication scheme with the outside.

### 2-17 Modified Example 17

Furthermore, in the above embodiment, the description was made of a case in which the producing unit 11 and the control unit 30, which were described above with FIGS. 1 to 27, were applied to the producing unit which produces the electronic book data for the electronic book, which includes one or a plurality of book page images, in which one or a plurality of parts chosen in the book page image were set to enlargement target areas which could be individually enlarged and displayed, based on the original document data imported by the importing unit.

However, the present invention is not limited thereto, and it is possible to widely apply producing units with other various configurations such as a producing circuit with a hardware circuit configuration, a microprocessor, a DSP, and the like which produce electronic book data for the electronic book, which includes one or a plurality of book page images, in which one or a plurality of parts chosen in the book page image were set to enlargement target areas which could be individually enlarged and displayed, based on the original document data imported by the importing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### INDUSTRIAL APPLICABILITY

The present invention can be used for an electronic book providing system constituted by an electronic book reproducing apparatus such as a mobile terminal, a personal computer, a mobile phone, or the like, a history obtaining apparatus with a server configuration, and an electronic book producing apparatus such as a personal computer or the like.

### REFERENCE SIGNS LIST

1, 20 ELECTRONIC BOOK PROVIDING SYSTEM
2, 21 ELECTRONIC BOOK PRODUCING APPARATUS
3, 24 ELECTRONIC BOOK REPRODUCING APPARATUS
4, 22 HISTORY OBTAINING APPARATUS
10 IMPORTING UNIT
11 PRODUCING UNIT
12 REPRODUCING UNIT
13 DISPLAY UNIT
14 OPERATION UNIT
15, 30, 130 CONTROL UNIT
16 TRANSMISSION UNIT
17 RECEIVING UNIT
18 STORAGE UNIT
25 DISPLAY APPARATUS
27 REMOTE CONTROL
28 BOOK PROVIDING DISC
37 EXTERNAL INTERFACE UNIT
45 TO 48 BOOK PAGE IMAGE
65 BOOK INFORMATION
85 PAGE INFORMATION
92 ENLARGEMENT TARGET AREA
100 AREA INFORMATION
101 AREA SPECIFYING INFORMATION
138 GRAPHIC ENGINE
137, 188 NETWORK CONTROLLER
150 AREA ENLARGEMENT IMAGE
189 HARD DISK DRIVE
191 PREFERENCE EXTRACTION UNIT
D1, D3 ORIGINAL DOCUMENT DATA
D2, D4 ELECTRONIC BOOK DATA
IH DISPLAY HISTORY
P1 ELECTRONIC BOOK PRODUCING PROGRAM
P2 ELECTRONIC BOOK REPRODUCING PROGRAM
RT1 PROCEDURE OF IMAGE DATA PRODUCING PROCESSING FOR ELECTRONIC BOOK
RT2 PROCEDURE OF ELECTRONIC BOOK DATA PRODUCING PROCESSING
RT3 PROCEDURE OF ELECTRONIC BOOK REGISTRATION PROCESSING
RT4 PROCEDURE OF ELECTRONIC BOOK REPRODUCING PROCESSING
RT5 PROCEDURE OF DISPLAY HISTORY PROVIDING PROCESSING
RT6 PROCEDURE OF DISPLAY HISTORY OBTAINING PROCESSING

1. A device for reproducing an electronic book, the device comprising:
a control unit configured so as to:
determine a target area based on a selection of at least one selectable displayed portion of a page image of the electronic book, and,
selectively reproduce, within the target area, content associated with the selected displayed portion of the page image of the electronic book in a predetermined manner.

2. The device of claim 1, wherein the control unit is further configured to associate area position information with the selectable displayed portion of the page image of the electronic book, the area position information being used by the control unit to determine the content reproduced within the target area.

3. The device of claim 1, wherein the control unit is further configured to display the target area such that the displayed target area overlaps a portion of the page image of the electronic book.

4. The device of claim 3, wherein the control unit is further configured to display a surrounding frame image including the displayed target area, the surrounding frame image being displayed such that the surrounding frame image overlaps the selectable displayed portion of the page image of the electronic book.

5. The device of claim 1, wherein the determined target area is larger than the selectable displayed portion of the page image of the electronic book.

6. The device of claim 1, wherein the content associated with the selectable displayed portion of the page image of the electronic book comprises text content, image content, movie content, and/or audio content.

7. The device of claim 6, wherein the text content associated with the selectable displayed portion of the page image of the electronic book is displayed within the target area in an enlarged format.

8. The device of claim 1, wherein the control unit is further configured to provide an indication that a portion of the page image of the electronic book is not selectable by a user.

9. The device of claim 8, wherein the control unit is further configured to provide the indication that the portion of the page image of the electronic book is not selectable by displaying a synthesized message overlapping a displayed portion of the page image of the electronic book.

10. The device of claim 1, wherein the control unit is further configured to:
receive an indication to change the selection of the at least one selectable displayed portion of the page image of the electronic book to another displayed portion of the page image of the electronic book;
determine that the another displayed portion of the page image of the electronic book is not selectable, and,
provide an indication of such determination by displaying a synthesized message overlapping a displayed portion of the page image of the electronic book to a user.

11. The device of claim 1, wherein the control unit is further configured to:
receive an indication to change the selection of the at least one selectable displayed portion of the page image of the electronic book to another selectable displayed portion of the page image of the electronic book;
determine another target area based on the selection of the another selectable displayed portion of the page image of the electronic book, and,
selectively reproduce, within the another target area, content associated with the another selectable displayed portion of the page image of the electronic book in a predetermined manner.

12. The device of claim 1, wherein the page image of the electronic book includes a plurality of selectable displayed portions, and,
the control unit is further configured to selectively reproduce, within a respective target area determined for each selected displayed portion, content associated with the respective selected displayed portion of the page image of the electronic book in a predetermined manner.

13. The device of claim 1, wherein the plurality of selectable displayed portions are sequentially selectable.

14. The device of claim 1, wherein the control unit is further configured to:
provide history information regarding (i) the selection of each of the at least one selectable displayed portion of the page image of the electronic book by a user; and (ii) the selective reproduction, within the determined target area, of the content associated with the selected displayed portion of the page image of the electronic book to the user.

15. A device for producing an electronic book, the device comprising:
a control unit configured so as to:
create at least one page image for the electronic book including reproducible content;
create at least one selectable portion within the page image and associate a part of the reproducible content of the electronic book with the at least one selectable portion;
and,
associate data with one or more selectable portions of the page image, the data associated with the one or more selectable portions being reproducible upon selection of a respective selectable portion of the page image.

16. The device of claim 15, wherein the data associated with at least one selectable portion of the page image includes audio data, the audio data being reproducible upon selection of said selectable portion of the page image of the electronic book.

17. The device of claim 16, wherein the data associated with at least one selectable portion of the page image includes image data.

18. The device of claim 16, wherein the data associated with at least one selectable portion of the page image includes a combination of audio and image data.

19. The device of claim 16, wherein the audio data includes a narration of the reproducible content of the electronic book.

20. The device of claim 15, wherein the reproducible content of the electronic book includes textual or image content.

21. The device of claim 15, wherein the control unit is further configured to differentiate a display state of the part of the reproducible content of the electronic book associated with the at least one selectable portion from other parts of the reproducible content of the electronic book.

22. The device of claim 15, wherein the control unit is further configured to associate another part of the reproducible content of the electronic book with a non-selectable portion of the page image of the electronic book.

23. The device of claim 15, wherein the control unit is further configured to differentiate a display state of the at least one page image from other page images of the electronic book.

24. The device of claim 15, wherein the control unit is further configured to emphasize the part of the reproducible content of the electronic book associated with the at least one selectable portion from other parts of the reproducible content of the electronic book.

25. The device of claim 24, wherein the control unit is further configured to emphasize the part of the reproducible content of the electronic book associated with the at least one selectable portion by enlarging a textual content included in the part of the reproducible content of the electronic book associated with the at least one selectable portion.

26. A device for maintaining information regarding an electronic book including at least one page image having at least one selectable portion including a part of reproducible content of the electronic book, the device comprising:
a control unit configured so as to:
receive information regarding a selection, by a user, of each of the at least one selectable portion of each respective page image displayed to the user.

27. The device of claim 26, wherein the control unit is further configured to:
determine, based on the information regarding a selected respective portion of the respective page image displayed to the user, the part of the reproducible content of the electronic book included within the selected respective portion; and,
analyze the part of reproducible content of the electronic book included within the selected respective portion and one or more attributes associated with the reproducible content of the electronic book to extract a user preference from the selected respective portion of the page image displayed to the user.

28. The device of claim 27, wherein the control unit is further configured to extract the user preference using natural language processing on the part of the reproducible content of the electronic book included within the selected respective portion.

29. An electronic book system comprising:
an electronic book producing device configured to:
create at least one page image for an electronic book including reproducible content;
create at least one selectable portion within the page image and associate a part of the reproducible content of the electronic book with each respective selectable portion;
and,
associate data with each respective selectable portion of the page image, the data associated with each respective selectable portion being reproducible upon selection of the respective selectable portion of the page image;
an electronic book reproducing device configured to:
determine a target area based on a selection by a user of the at least one selectable portion of the page image displayed to the user, and,
selectively reproduce, within the target area and in a predetermined manner, the reproducible content and/or the data associated with the at least one selectable portion selected by the user; and
a history information device configured to:
receive information regarding the selection, by the user, of the at least one selectable portion selected by the user.

30. A method for reproducing an electronic book, the method comprising:
determining, using a processor, a target area based on a selection of at least one selectable displayed portion of a page image of the electronic hook, and,
selectively reproducing, within the target area, content associated with the selected displayed portion of the page image of the electronic book in a predetermined manner.

31. A non-transitory computer-readable medium on which computer executable instructions of a program for reproducing an electronic book are stored, the instructions, when executed by a control unit, causing the control unit to:
determine a target area based on a selection of at least one selectable displayed portion of a page image of the electronic hook, and,
selectively reproduce, within the target area, content associated with the selected displayed portion of the page image of the electronic book in a predetermined manner.

32. A method for producing an electronic book, the method comprising:
creating, using a processor, at least one page image for the electronic book including reproducible content;
creating at least one selectable portion within the page image and associating a part of the reproducible content of the electronic book with the at least one selectable portion; and,
associating data with one or more selectable portions of the page image, the data associated with the one or more selectable portions being reproducible upon selection of a respective selectable portion of the page image.

33. A non-transitory computer-readable medium on which computer executable instructions of a program for producing an electronic book are stored, the instructions, when executed by a control unit, causing the control unit to:
create at least one page image for the electronic book including reproducible content;
create at least one selectable portion within the page image and associate a part of the reproducible content of the electronic book with the at least one selectable portion; and,
associate data with one or more selectable portions of the page image, the data associated with the one or more selectable portions being reproducible upon selection of a respective selectable portion of the page image.

34. A method for maintaining information regarding an electronic book including at least one page image having at least one selectable portion including a part of reproducible content of the electronic book, the method comprising:
receiving, using a processor, information regarding a selection, by a user, of each of the at least one selectable portion of each respective page image displayed to the user.

35. A non-transitory computer-readable medium on which computer executable instructions of a program for maintaining information regarding an electronic book including at least one page image having at least one selectable portion including a part of reproducible content of the electronic book are stored, the instructions, when executed by a control unit, causing the control unit to:
receive information regarding a selection, by a user, of each of the at least one selectable portion of each respective page image displayed to the user.
